(19) United States
(12) Patent Application Publication
(10) Pub. No.: US 2026/0350126 A1
(43) Pub. Date: Nov. 5, 2026

(54) System and Method for Autonomous Credential Lifecycle Management Using Agentic Artificial Intelligence

(71) Applicant: RedBlock Security, Inc., San Ramon, CA (US)

(72) Inventors: Indus Khaitan, Dublin, CA (US); Rajvardhan Khaitan, Dublin, CA (US); Basem Rizk, Pleasant Hill, CA (US); Aviral Srivastava, Bengaluru (IN)

(73) Assignee: RedBlock Security, Inc., San Ramon, CA (US)

(21) Appl. No.: 19/667,306

(22) Filed: May 4, 2026

Related U.S. Application Data
(60) Provisional application No. 63/799,167, filed on May 2, 2025.
(60) Provisional application No. 63/799,176, filed on May 2, 2025.
(60) Provisional application No. 63/799,184, filed on May 2, 2025.
(60) Provisional application No. 63/799,188, filed on May 2, 2025.
(60) Provisional application No. 63/799,193, filed on May 2, 2025.
(60) Provisional application No. 63/799,199, filed on May 2, 2025.
(60) Provisional application No. 63/810,356, filed on May 22, 2025.
(60) Provisional application No. 63/837,276, filed on Jul. 2, 2025.
(60) Provisional application No. 63/872,640, filed on Aug. 29, 2025.
(60) Provisional application No. 63/872,656, filed on Aug. 29, 2025.
(60) Provisional application No. 63/872,665, filed on Aug. 29, 2025.
(60) Provisional application No. 63/878,629, filed on Sep. 9, 2025.
(60) Provisional application No. 63/880,059, filed on Sep. 11, 2025.
(60) Provisional application No. 63/881,837, filed on Sep. 15, 2025.
(60) Provisional application No. 63/887,721, filed on Sep. 25, 2025.

(51) Int. Cl. G06F 21/31; G06F 21/45; G06F 21/62

(52) U.S. Cl. CPC G06F 21/31; G06F 21/45; G06F 21/6254

(57) ABSTRACT

Systems, methods, and non-transitory computer-readable media are disclosed for autonomous lifecycle management of application programming interface (API) credentials across a plurality of applications. An artificial intelligence agent system accesses a user interface of an application responsive to a trigger from an agent command system, applies a large language model to rendered graphical user interface content to identify API credential containers, classify credential-displaying regions, and derive API credential metadata attributes, and stores the metadata attributes and credentials in a centralized credential vault. A dependency mapping component identifies consumer applications associated with the credentials. The artificial intelligence agent system generates a new API credential at a producer application, including by graphical user interface interaction and transient display capture, propagates the new API credential to consumer applications, verifies integration, and revokes a prior API credential. A dashboard interface aggregates credential metadata, propagation status, verification status, and audit information.

### PRIORITY DATA

This application claims the benefit of U.S. Provisional Patent Application No. 63/799,167, filed on May 2, 2025, titled “SYSTEM AND METHOD FOR AGGREGATING API KEYS FROM APPLICATIONS USING ARTIFICIAL INTELLIGENCE” (Atty. Docket No. RDBL1000USP01); U.S. Provisional Patent Application No. 63/799,176, filed on May 2, 2025, titled “SYSTEM AND METHOD FOR UPDATING AND PROPAGATING API KEYS USING ARTIFICIAL INTELLIGENCE” (Atty. Docket No. RDBL1001USP01); U.S. Provisional Patent Application No. 63/799,184, filed on May 2, 2025, titled “SYSTEM FOR REPORTING AND ACTIONING OF USER ROLES IN IDENTITY GOVERNANCE CONTEXT USING ARTIFICIAL INTELLIGENCE” (Atty. Docket No. RDBL1002USP01); U.S. Provisional Patent Application No. 63/799,188, filed on May 2, 2025, titled “SYSTEM FOR DETECTION AND REMEDIATION OF SECURITY CONFIGURATION DRIFTS IN WEB APPLICATIONS USING INTERFACE-CENTRIC AI AGENTS” (Atty. Docket No. RDBL1003USP01); U.S. Provisional Patent Application No. 63/799,193, filed on May 2, 2025, titled “SYSTEM AND METHOD FOR CAPTURING AND AUDITING WEB-BASED AI AGENT INTERACTIONS” (Atty. Docket No. RDBL1004USP01); U.S. Provisional Patent Application No. 63/799,199, filed on May 2, 2025, titled “SYSTEM AND METHOD FOR AUTOMATED CREDENTIAL GENERATION AND PROPAGATION BASED ON ARTIFICIAL INTELLIGENCE AGENTS” (Atty. Docket No. RDBL1005USP01); U.S. Provisional Patent Application No. 63/810,356, filed on May 22, 2025, titled “System and Method for Deterministic Validation of Automation Workflows Guided by Large Language Models” (Atty. Docket No. RDBL1006USP01); U.S. Provisional Patent Application No. 63/837,276, filed on Jul. 2, 2025, titled “SYSTEM AND METHOD FOR AUTOMATED EXPLORATION OF APPLICATION SOFTWARE” (Atty. Docket No. RDBL1007USP01); U.S. Provisional Patent Application No. 63/880,059, filed on Sep. 11, 2025, titled “SYSTEM AND METHOD FOR AUTOMATED EXPLORATION OF APPLICATION SOFTWARE” (Atty. Docket No. RDBL1007USP02); U.S. Provisional Patent Application No. 63/872,640, filed on Aug. 29, 2025, titled “SYSTEM AND METHOD FOR INTEGRATING NON-API APPLICATIONS WITH IDENTITY PLATFORMS BASED ON ARTIFICIAL INTELLIGENCE” (Atty. Docket No. RDBL1008USP01); U.S. Provisional Patent Application No. 63/878,629, filed on Sep. 9, 2025, titled “SYSTEM AND METHOD FOR INTEGRATING NON-API APPLICATIONS WITH IDENTITY PLATFORMS BASED ON ARTIFICIAL INTELLIGENCE” (Atty. Docket No. RDBL1008USP02); U.S. Provisional Patent Application No. 63/887,721, filed on Sep. 25, 2025, titled “HIERARCHICAL STRUCTURING OF GRAPHICAL USER INTERFACE ELEMENTS IN APPLICATION SOFTWARE PAGES” (Atty. Docket No. RDBL1009USP01); U.S. Provisional Patent Application No. 63/872,656, filed on Aug. 29, 2025, titled “SYSTEM AND METHOD FOR IDENTITY-CENTRIC ACTIVITY LOG CAPTURE FROM APPLICATIONS LACKING PROGRAMMATIC INTERFACES” (Atty. Docket No. RDBL1010USP01); U.S. Provisional Patent Application No. 63/872,665, filed on Aug. 29, 2025, titled “AGENTIC ARTIFICIAL INTELLIGENCE FOR AUTOMATED CONNECTOR CONFIGURATION AND APPLICATION ONBOARDING IN IDENTITY PLATFORMS” (Atty. Docket No. RDBL1011USP01); and U.S. Provisional Patent Application No. 63/881,837, filed on Sep. 15, 2025, titled “TASK-SPECIFIC HIGH-LEVEL LANGUAGE FRAMEWORK FOR STRUCTURED INTERACTION WITH LARGE LANGUAGE MODELS” (Atty. Docket No. RDBL1012USP01). All of the foregoing provisional applications are hereby incorporated by reference for all purposes.

### TECHNICAL FIELD

The technology disclosed relates to artificial intelligence type computers and digital data processing systems and corresponding data processing methods and products for emulation of intelligence (i.e., knowledge based systems, reasoning systems, and knowledge acquisition systems); and including systems for reasoning with uncertainty (e.g., fuzzy logic systems), adaptive systems, machine learning systems, and artificial neural networks. Specifically, the technology relates to systems and methods for autonomous lifecycle management of application programming interface credentials across enterprise applications.

### BACKGROUND OF THE INVENTION

Modern enterprises operate across hundreds of software applications spanning cloud-native platforms, legacy on-premises systems, and disconnected enterprise tools. Each employee holds access entitlements that must be modified or revoked as the employee transitions between roles, completes projects, or departs the organization. Identity and access management (IAM) platforms automate provisioning and deprovisioning for applications integrated through programmatic interfaces, including application programming interfaces (APIs), directory services, and federated identity protocols. However, a significant portion of enterprise applications, including legacy accounting systems, proprietary compliance dashboards, partner-hosted financial platforms, field service applications, and disconnected document archives, do not expose programmatic interfaces and remain accessible for entitlement management through a user interface. The IAM platform is unable to communicate programmatically with these applications, and user access entitlements in these applications fall outside the automated governance boundary. The result is a coverage gap that produces orphan accounts after employee departure, retention of role-inappropriate privileges after role transitions, and recurring compliance violations under regulatory frameworks such as the Sarbanes-Oxley Act (SOX), the Health Insurance Portability and Accountability Act (HIPAA), and the General Data Protection Regulation (GDPR).

Identity governance and administration (IGA) platforms attempt to address the coverage gap through periodic access reviews on recurring schedules, such as every thirty, sixty, or ninety calendar days, but these reviews are passive and retrospective. The IGA platform generates reports, while the actual modification of access privileges, including revoking access or downgrading the role of a user, requires manual intervention by an administrator who navigates the user interface of each application individually. Robotic process automation (RPA) technologies have been applied as an alternative to manual remediation, but conventional RPA bots operate on static, pre-programmed user interface scripts tightly coupled to a specific layout, label set, and navigation structure. When the application vendor repositions user interface elements, modifies labels, or restructures navigation menus, the RPA script fails and requires manual reconfiguration by a developer. Conventional RPA bots also have limited capacity to interpret the semantic meaning of user interface elements and do not reliably distinguish between a button labeled “Revoke Access” and a button labeled “Modify Role” based on textual content alone. Accordingly, a need exists for a system that automatically discovers, evaluates, and remediates user access entitlements across both programmatically integrated and disconnected enterprise applications, that adapts to changes in user interface layouts and labels without reconfiguration, and that produces tamper-evident audit records of every entitlement modification across the full enterprise application estate.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates a system architecture of an application management platform for deploying an agentic artificial intelligence (AI) based system for enterprise application management, according to certain embodiments.

FIG. 1B illustrates an exemplary system architecture of an AI agent system deployed within a network environment including a plurality of enterprise users and a set of applications, according to certain embodiments.

FIG. 1C illustrates an alternative embodiment of the application management platform showing distributed deployment of the AI agent system across enterprise infrastructure connected through a plurality of networks, according to certain embodiments.

FIG. 2A is an architectural diagram illustrating an evolution of enterprise infrastructure models from network centric to application and data centric paradigms, according to certain embodiments.

FIG. 2B is a block diagram of an AI agent based identity orchestration and credential automation system for enterprise environments, according to certain embodiments.

FIG. 2C is an architectural diagram illustrating integration of AI agent based identity governance across connected applications and disconnected applications within a hybrid enterprise infrastructure, according to certain embodiments.

FIG. 2D illustrates a connectivity framework between enterprise users, an identity control system, and a plurality of connected applications integrated with the AI agent system in an embodiment comprising programmatically connected applications, according to certain embodiments.

FIG. 2E is a system workflow diagram showing an AI agent driven remediation process initiated by contextual security signals and executed across enterprise applications, according to certain embodiments.

FIG. 2F is a conceptual diagram depicting AI agent behavioral learning for autonomous execution of identity lifecycle tasks across a large set of business applications, according to certain embodiments.

FIG. 3A illustrates an exemplary internal architecture of an agentic AI platform including a perception module, a planning module, an execution module, and supporting identity governance modules deployed within an enterprise network infrastructure, according to certain embodiments.

FIG. 3B illustrates a system architecture of a graphical user interface (GUI) based agentic AI credential automation system configured to interface with producer applications and consumer applications, according to certain embodiments.

FIG. 4 is a block diagram of a credential lifecycle system configured to perform autonomous discovery, aggregation, rotation, propagation, verification, and revocation of API credentials across producer and consumer applications, according to certain embodiments.

FIG. 5 is a flowchart illustrating a credential lifecycle method performed by the credential lifecycle system, according to certain embodiments.

FIG. 6 illustrates a discovery and non-compliance evaluation pipeline in which a multi-modal large language model derives API credential metadata attributes from rendered content of a producer application graphical user interface, according to certain embodiments.

FIG. 7 illustrates a generation, propagation, and verification pipeline of a new API credential across a set of consumer applications, according to certain embodiments.

FIG. 8 illustrates a four-state ephemeral capture sequence for capturing a new API credential from a transient display and re-identifying the new API credential through a visual fingerprint match, according to certain embodiments.

FIG. 9 illustrates a four-state stateful rollback sequence for reversion of a credential rotation transaction at a producer application through actuation of a revocation control of a producer application graphical user interface, according to certain embodiments.

FIG. 10 illustrates a synthetic API generation pipeline for constructing a synthesized programmatic interface from a learned visual workflow observed at a producer application graphical user interface, according to certain embodiments.

FIG. 11 illustrates a multi-factor authentication handling pipeline comprising a time-based one-time password computation pathway and a live session brokering pathway, according to certain embodiments.

FIG. 12 illustrates a rotation transaction initiation pipeline comprising an internal closed-loop trigger pathway and an external rotation policy engine pathway, according to certain embodiments.

FIG. 13 illustrates a three-component artificial intelligence agent system architecture comprising a computer vision component, a multi-modal large language model, and an interface automation component, according to certain embodiments.

FIG. 14 illustrates a dependency mapping component configured to maintain a mapping that associates each API credential with a set of consumer applications, according to certain embodiments.

FIG. 15 illustrates a trigger-source-to-dashboard pipeline depicting a plurality of trigger sources feeding an agent command system and a dashboard interface aggregating credential lifecycle state and a sequence of tamper-evident audit records, according to certain embodiments.

FIG. 16 illustrates producer application scenarios and a closed discover-to-rotate-to-revoke lifecycle of the credential lifecycle system, according to certain embodiments.

FIG. 17 is a schematic representation of an encoder-decoder architecture.

FIG. 18 shows an overview of an attention mechanism added onto an RNN encoder-decoder architecture.

FIG. 19 is a schematic representation of the calculation of self-attention showing one attention head.

FIG. 20 is a depiction of several attention heads in a Transformer block.

FIG. 21 is an illustration that shows how one can use multiple workers to compute the multi-head attention in parallel, as the respective heads compute their outputs independently of one another.

FIG. 22 is a portrayal of one encoder layer of a Transformer network.

FIG. 23 shows a schematic overview of a Transformer model.

FIG. 24 is a depiction of a Vision Transformer (ViT).

FIG. 25 illustrates a processing flow of the Vision Transformer (ViT).

FIG. 26 shows example software code that implements a Transformer block.

FIG. 27 illustrates an example configuration of a computing device that can be used to implement the systems and techniques described herein.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

### Overview:

The implementations described herein introduce systems and methods for autonomous discovery, rotation, and propagation of application credentials across heterogeneous enterprise applications using agentic artificial intelligence (AI). In some implementations, a credential lifecycle management system performs the full credential lifecycle by directly interacting with the graphical user interface (GUI) of a producer application. The system employs an artificial intelligence agent system that comprises a computer vision component, a multi-modal large language model (MLLM), and an interface automation component. These three components together perceive rendered credential management surfaces, identify credential containers and credential management controls, and execute user interface interactions on behalf of an administrator.

The disclosed approach treats GUI based credential management as a core operational primitive of the credential lifecycle infrastructure. The approach extends credential lifecycle coverage across producer applications regardless of whether each producer application exposes a programmatic credential management interface. The system maintains a centralized credential vault that stores encrypted credential records, visual fingerprints, time based one time password (TOTP) seeds, and tamper evident audit records. The system also maintains a dependency mapping component that associates each application programming interface (API) credential with a corresponding set of consumer applications. Together, these components support compliance verification, regulatory examination, and continuous credential lifecycle management at enterprise scale across producer applications and consumer applications that conventional credential management tools cannot reach.

### Indicia of Novelty, Inventiveness, Non-Obviousness, and Subject-Matter Eligibility

Modern enterprise environments rely on application credentials to authorize machine level interactions across software as a service (SaaS) platforms, internally deployed applications, and third party managed portals. Application credentials include API keys, client secrets, access tokens, authorization tokens, and integration secrets. A typical large enterprise issues thousands of these credentials across hundreds of producer applications. Each issued credential establishes an authenticated channel between a producer application and one or more consumer applications. Information technology and security teams bear responsibility for maintaining accurate inventories of issued credentials, enforcing rotation policies, propagating new credentials to dependent consumer applications, and revoking credentials that are no longer required. The teams cannot perform these duties at scale through manual procedures, because the volume of credentials grows beyond practical human capacity.

A substantial fraction of producer applications restrict credential management to GUI based interactions and do not expose programmatic credential management interfaces. These producer applications display issued credentials in obfuscated form, presenting the leading and trailing characters of a credential while masking the intervening characters. The producer applications also present credential metadata such as access scope, expiration timestamp, issuing user, and usage activity inconsistently across different vendors. As a consequence, conventional credential management tools cannot operate at these GUI producer applications. Identity governance and administration platforms presuppose that each producer application exposes a programmatic interface and accordingly cannot extend coverage to GUI producer applications. Privileged access management platforms manage shared administrative credentials but do not inventory or rotate the application level API credentials issued by producer applications to consumer applications. Secrets management platforms store credentials securely after provisioning but do not perform autonomous discovery against producer applications that the secrets management platform did not provision.

The deficiencies of conventional credential management tools have caused widely publicized industry breaches. In one such breach, the residual credentials of a previously offboarded employee remained active across one or more cloud environments after the employee's departure. Unauthorized actors discovered the residual credentials on underground communication channels and used the credentials to access internal enterprise systems. The breach proceeded undetected because no automated revocation process removed the residual credentials and no centralized credential tracking mechanism identified them as orphaned. Similar incidents recur across industries and demonstrate the same root cause. Residual credentials persist at producer applications that no centralized mechanism tracks and revokes. Organizations subject to regulatory frameworks including the Sarbanes Oxley Act (SOX), the General Data Protection Regulation (GDPR), the Health Insurance Portability and Accountability Act (HIPAA), and the Payment Card Industry Data Security Standard (PCI DSS) face compliance violations and regulator imposed penalties when they cannot demonstrate effective credential lifecycle management.

Robotic process automation (RPA) and scripted scraping techniques represent prior attempts to automate credential management at GUI producer applications. These techniques use coordinate based or selector based automation tools to navigate producer application user interfaces and extract credential information. The techniques are brittle. The techniques depend on application specific selectors that break whenever a producer application modifies its user interface layout, visual styling, or navigation paths. The techniques lack semantic understanding of interface content. The techniques therefore cannot disambiguate among credential containers and unrelated user interface elements. The techniques cannot distinguish among labels indicating client secret, API key, authorization token, or integration secret in producer applications that use vendor specific terminology. The techniques require ongoing maintenance to track changes in producer application user interfaces, and the maintenance cost grows linearly with the number of producer applications covered. The techniques also cannot operate across producer applications that present authentication challenges. The techniques have no algorithmic pathway to clear multi factor authentication challenges, and no human coordination pathway to clear captcha challenges, biometric verification prompts, or step up authentication challenges encountered during credential management workflows.

The technology disclosed introduces an artificial intelligence agent system that performs credential lifecycle operations at the producer application user interface using semantic perception rather than coordinate based or selector based automation. The artificial intelligence agent system comprises a computer vision component, an MLLM, and an interface automation component. The computer vision component captures images of the rendered surface of the producer application user interface. The computer vision component detects bounding boxes of interface elements and classifies each detected element by element type. The MLLM operates as a single instance that serves multiple functional outputs across the credential lifecycle. The MLLM identifies credential displaying regions during discovery and identifies credential generation interface elements during rotation. The MLLM also infers a plurality of API credential metadata attributes from contextual elements rendered proximate to a partially masked credential. The contextual elements include labels, tooltips, access scopes, and timestamps. The interface automation component executes user interface interactions including pointer events, keyboard events, form field population, and copy paste operations to actuate the credential management controls of the producer application user interface.

The technology disclosed enables a closed credential lifecycle that begins at discovery and proceeds through rotation, propagation, verification, and revocation as a unified sequence. During discovery, the artificial intelligence agent system extracts the plurality of API credential metadata attributes from the producer application user interface. The system stores the extracted attributes in encrypted credential records of a centralized credential vault. During rotation, the system actuates the credential generation interface element of the producer application. The producer application then renders a new API credential at a transient display in humanly-readable form for a limited time. After the transient display closes, the producer application presents the new API credential thereafter in obfuscated form. The system captures the new API credential from the transient display while the transient display is still rendered. The system stores the new API credential in encrypted form in the encrypted credential records and stores the obfuscated representation of the new API credential as a visual fingerprint in the centralized credential vault. The visual fingerprint serves as a binding between the encrypted credential value and the masked appearance of the credential at the producer application user interface.

During propagation, the artificial intelligence agent system queries a dependency mapping component to identify a set of consumer applications associated with the rotated API credential. The dependency mapping component is a maintained data structure that associates each API credential identifier with a corresponding set of consumer application identifiers. The dependency mapping component determines the set of consumer applications based on the plurality of API credential metadata attributes extracted during discovery. The system then propagates the new API credential to each consumer application of the set of consumer applications. The propagation occurs through an API call to a consumer application that exposes a programmatic credential update interface, or through simulated graphical user interface interaction at a consumer application that does not expose a programmatic credential update interface.

During verification, the system performs an integration check at each consumer application of the set of consumer applications. The integration check confirms that the consumer application authenticates to the producer application using the new API credential. After all consumer applications of the set of consumer applications successfully verify, the system actuates the revocation control of the producer application user interface to revoke the prior API credential. If at least one consumer application of the set of consumer applications fails to verify, the system performs a rollback. During rollback, the system identifies the new API credential at the producer application user interface using the visual fingerprint. The system then performs user interface interactions to revoke the new API credential at the producer application. The system confirms by visual inspection of the producer application user interface that the prior API credential remains active.

The artificial intelligence agent system handles authentication challenges encountered during credential lifecycle operations through two complementary mechanisms. When the producer application presents a multi factor authentication challenge, the artificial intelligence agent system reads a TOTP seed from the centralized credential vault. The system computes a current TOTP in agent runtime memory and inputs the computed TOTP into the multi factor authentication input element of the producer application user interface. The computation operates in agent runtime memory and does not display the computed TOTP on a screen for human reading. When the producer application presents a challenge that requires human intervention, the artificial intelligence agent system invokes a session broker. The session broker preserves the session state, the navigation context, and the credential context in a state preservation buffer. The session broker hands off a live session to a human administrator. The human administrator clears the challenge in the live session. Upon receiving a clearance signal from the session broker, the artificial intelligence agent system resumes the autonomous workflow at the precise step at which the autonomous workflow was paused.

The artificial intelligence agent system also synthesizes a callable programmatic interface from a learned visual workflow. The artificial intelligence agent system observes the user interface interactions performed at the producer application across a complete credential lifecycle operation. The artificial intelligence agent system aggregates the observed interactions as a learned visual workflow. A workflow synthesizer extracts parameterizable operations from the learned visual workflow and emits method signatures corresponding to credential lifecycle operations such as credential generation, credential revocation, and credential listing. The synthesized programmatic interface is callable by an agent command system to invoke a credential lifecycle operation on the producer application even when the producer application does not expose a native programmatic credential management interface. Each invocation of the synthesized programmatic interface triggers replay of the learned visual workflow against the producer application user interface, with the computer vision component adapting to runtime variation in user interface state.

The technology disclosed implements a closed loop trigger pathway that initiates rotation transactions without intervening intervention by an external scheduler, a separate policy engine, or a human administrator queue. The MLLM analyzes contextual text and metadata associated with API credential containers during discovery. When the analysis detects a non compliance condition for an API credential, the artificial intelligence agent system initiates a rotation transaction directly. The rotation transaction proceeds through the credential generation, capture, propagation, verification, and revocation sequence. The closed loop trigger pathway operates alongside an external rotation policy engine pathway that evaluates external risk signals, credential age, usage activity, and elapsed time since last rotation. Both trigger pathways converge at a single rotation transaction initiation performed by the artificial intelligence agent system.

This architecture provides concrete technical benefits that address the interface coverage, accuracy, and compliance failures of prior art credential management tools. First, the technology extends credential lifecycle coverage to producer applications that expose a graphical user interface. Conventional credential management tools cannot reach these producer applications because the conventional tools require programmatic interfaces that the producer applications do not expose. The artificial intelligence agent system reaches these producer applications by perceiving and interacting with the GUI directly. Second, the technology eliminates the brittleness of selector based and coordinate based automation. The computer vision component identifies interface elements by visual semantics rather than by fixed coordinates or document object model selectors. The artificial intelligence agent system tolerates element repositioning, visual styling changes, and addition of intermediate user interface elements. Third, the technology provides semantic understanding of credential terminology across heterogeneous producer applications. The MLLM disambiguates among labels indicating client secret, API key, authorization token, or integration secret. The MLLM identifies which labeled field corresponds to the target API credential, which labeled fields are vendor specific aliases of the same underlying credential, and which labeled fields refer to unrelated credentials. Fourth, the technology produces a tamper evident audit trail of credential lifecycle operations. The centralized credential vault stores tamper evident audit records that include an operation identifier, an application identifier, a timestamp, an agent identifier, an API credential identifier, and a result status. Each tamper evident audit record includes a cryptographic hash of the prior tamper evident audit record. The audit records form a chained sequence in which any modification to a prior record invalidates the cryptographic hash of all subsequent records. Compliance format export adapters transform the chained audit records into regulator required formats for SOX, HIPAA, PCI DSS, and GDPR examination.

The technology disclosed sits between the trigger sources that originate credential lifecycle operations and the producer applications and consumer applications at which the operations execute. An agent command system receives triggers from a plurality of source types. The plurality of source types includes a human resources platform, an identity governance and administration platform, an identity and access management platform, an enterprise ticketing platform, a command line utility, a compliance audit trigger source, and a webhook callback. The agent command system normalizes the received triggers and forwards the normalized triggers to a trigger transduction component. The trigger transduction component converts the normalized triggers into executable instructions for the artificial intelligence agent system. The artificial intelligence agent system performs the credential lifecycle operations using the computer vision component, the MLLM, and the interface automation component. The artificial intelligence agent system surfaces operation status through a dashboard interface. The dashboard interface aggregates, for each consumer application of the set of consumer applications, the API credential metadata attributes, a propagation status indicator, and a verification status indicator.

The technology disclosed also covers the audit side behavior that consumes the credential lifecycle operations as evidence. The centralized credential vault emits the chained tamper evident audit records to the compliance format export adapters in response to a regulator examination request, an internal audit request, or a forensic investigation request. The compliance format export adapters transform the chained tamper evident audit records into the format required by the requesting framework. The compliance format export adapters preserve the cryptographic hash chain in the transformed output. The regulator required output retains tamper evidence properties. The chained hash structure provides cryptographic evidence of the sequence and integrity of the audit records, making credential lifecycle operations machine verifiable for regulatory examination. By preserving tamper evidence through format transformation, the technology prevents a class of failures wherein credential management activities lack auditable evidence of execution. Auditors cannot accept credential management evidence that lacks tamper evidence properties. Compromised components cannot silently alter the audit trail without invalidating the cryptographic hash chain.

Finally, the technology disclosed encompasses implementations in which the artificial intelligence agent system forms the operational core that enables the system's coverage extension over prior art. In these arrangements, the artificial intelligence agent system mediates each credential lifecycle operation at the producer application user interface. The artificial intelligence agent system controls the operational pathway according to the presence or absence of a programmatic credential management interface at the producer application. The artificial intelligence agent system receives executable instructions from the trigger transduction component and evaluates the producer application to determine the appropriate operational pathway. The artificial intelligence agent system invokes the synthesized programmatic interface when the producer application does not expose a native programmatic credential management interface. The artificial intelligence agent system invokes the producer application's native programmatic credential management interface when the native programmatic credential management interface is available and authorized for the operation. The artificial intelligence agent system invokes direct user interface interactions through the computer vision component, the MLLM, and the interface automation component when neither programmatic pathway is available or appropriate. This pathway selection achieves universal coverage across heterogeneous producer applications, in direct contrast to conventional credential management tools whose coverage depends on the producer application exposing a programmatic interface that the conventional tool can call. The resulting coverage extension produces operational benefits that grow with increasing producer application heterogeneity. As producer application diversity grows, conventional tools encounter more producer applications that fall outside their reach and accordingly degrade in coverage. The artificial intelligence agent system encounters more producer applications and accordingly extends its coverage by learning the visual workflow of each new producer application. The technology distinguishes itself from prior art credential management tools that depend on producer application standardization. The artificial intelligence agent system autonomously navigates producer application heterogeneity through visual perception and semantic understanding.

### System Architecture

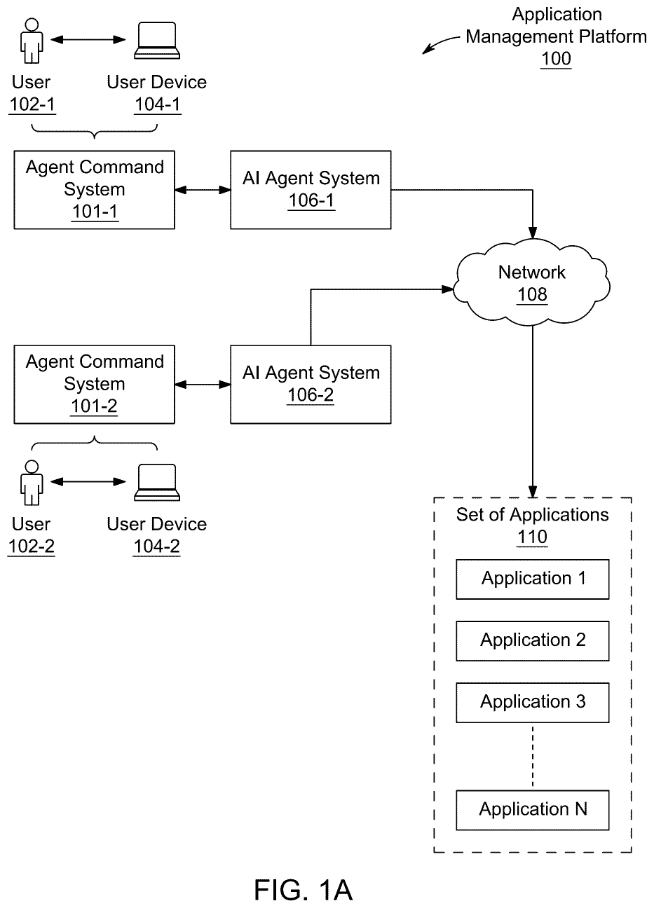

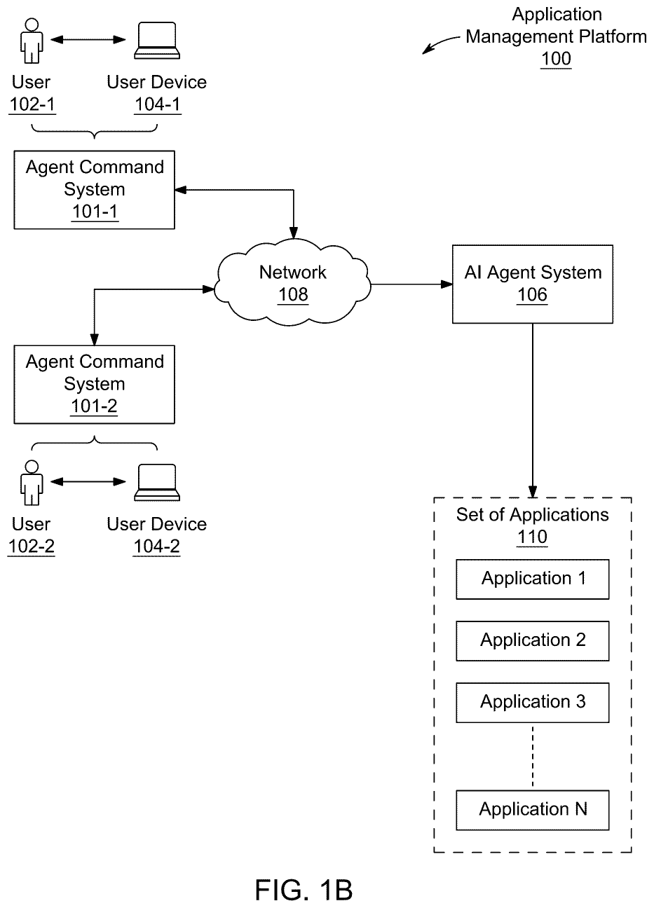

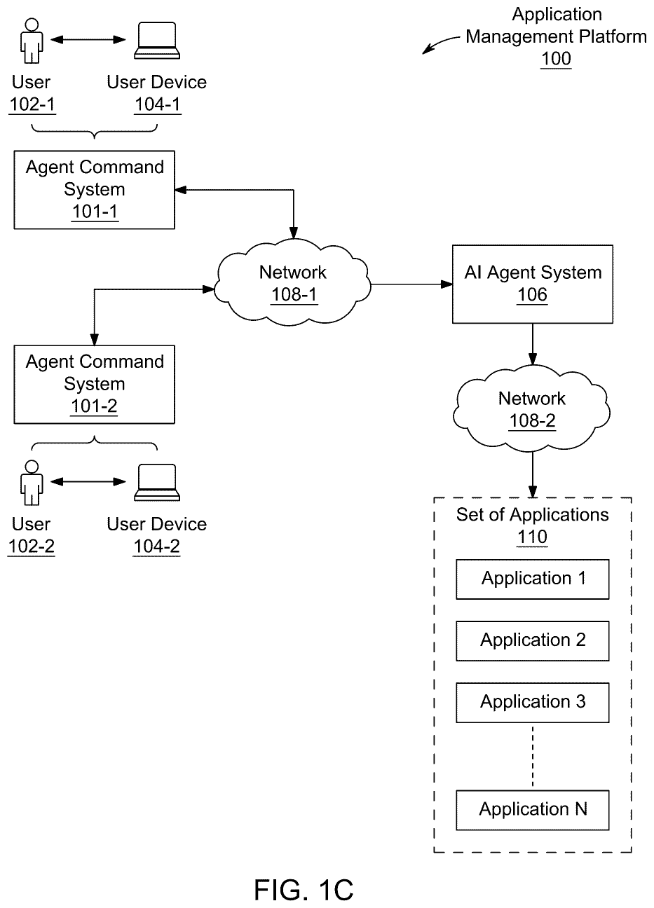

FIG. 1A illustrates an exemplary network diagram depicting an overall system architecture for deploying the application management platform 100, according to various embodiments. FIG. 1A depicts interaction among a plurality of enterprise users, a plurality of user devices, a plurality of agent command systems, a plurality of AI agent systems, and a set of applications over a communication network.

The application management platform 100 includes a plurality of users 102-1 and 102-2, each operating a respective user device 104-1 and 104-2. The user devices 104-1 and 104-2, collectively referred to as user devices 104, may be any computing devices capable of initiating or supporting interaction with components of the application management platform 100. The user devices 104 may include desktop computers, laptops, tablets, smartphones, or other network-enabled terminals. The user devices 104-1 and 104-2 are communicatively linked to other components of the application management platform 100 via a network 108. The network 108 may include any combination of communication technologies, including wired connections, wireless protocols, cellular networks, local area networks (LANs), wide area networks (WANs), metropolitan area networks (MANs), the Internet, or any suitable data transmission medium.

The agent command systems 101-1 and 101-2, collectively referred to as agent command systems 101 and as illustrated in FIG. 1A, refer to command-initiating modules that trigger task execution requests within the AI agent systems 106. The agent command systems 101 operate as entry points into an AI agent execution layer and may originate from a variety of operational contexts within the enterprise environment. Functionally, each agent command system 101 is configured to broker identity and access management instructions, including credential creation, access revocation, entitlement modification, or credential verification, by transmitting structured or unstructured commands to a corresponding AI agent system 106.

In one exemplary embodiment, an agent command system 101 may be realized as an enterprise human resources platform, such as Workday or SuccessFactors, which automatically triggers a new-user provisioning task upon successful onboarding of an employee. Alternatively, an agent command system 101 may be a cloud identity orchestration platform or identity governance solution, such as Okta Workflows or SailPoint, which detects a status change and delegates an appropriate downstream action to an agentic automation layer.

In another scenario, an agent command system 101 may comprise an enterprise-grade ticketing or service desk tool, such as ServiceNow or Jira, where an administrator raises a request for access removal or a credential reset. Once the ticket receives approval, the agent command system 101 generates a task trigger, which an AI agent system 106 receives for execution across relevant applications.

Additionally, an agent command system 101 may be embodied as a Python script or a lightweight command-line utility maintained by enterprise information technology teams. The agent command system 101 may invoke credential management tasks based on custom logic, policy thresholds, or compliance audit findings. For example, a script may be scheduled to review stale accounts, or trigger revocation flows for temporary users whose access is due to expire.

The scope of the agent command systems 101 also extends to externally hosted platforms. For example, a partner organization operating an integration gateway may initiate access modification workflows through representational state transfer (RESTful) callbacks or secure webhooks when a role matrix of a joint project is updated. Similarly, identity-centric middleware, such as Active Directory Federation Services (AD FS) or Azure Conditional Access policies, may initiate dynamic policy enforcement actions through integration with the application management platform 100.

Furthermore, websites that serve as operational hubs for user provisioning, including custom-built contractor registration portals or partner self-service applications, may function as instances of the agent command systems 101. These web portals collect user metadata, roles, and authorization preferences and transmit the metadata, the roles, and the authorization preferences as task directives to the agentic execution layer for automated credential provisioning.

The AI agent systems 106-1 and 106-2, collectively referred to as AI agent systems 106, serve as intermediary execution and orchestration layers between the agent command systems 101 and the set of applications 110. In the embodiment of FIG. 1A, the plurality of AI agent systems 106 may be deployed to manage tasks across various application domains, organizational units, or enterprise environments. Each AI agent system 106 receives task instructions or event triggers from a corresponding agent command system 101 and performs operations with respect to one or more applications in the set of applications 110.

A set of applications 110 is denoted as application 1, application 2, application 3, and continuing through application N. The applications within the set of applications 110 represent tools, platforms, and services utilized by enterprises in operational workflows. Illustrative examples include customer relationship management platforms such as Salesforce, regulatory filing portals such as Securities and Exchange Commission (SEC) submission websites, internal field service management systems, and partner-managed applications hosted on third-party infrastructure. Within the set of applications 110, some applications may be sanctioned enterprise applications that have been vetted and formally approved for use within the enterprise environment. However, not all sanctioned applications are programmatically integrated with enterprise identity systems. For example, Salesforce may be both sanctioned and programmatically connected through secure application programming interfaces (APIs), whereas other sanctioned tools, including a field service application hosted in a partner cloud, may lack programmatic integrations entirely and may be accessible through graphical user interfaces.

In cases of applications lacking programmatic integration, an AI agent system 106 is positioned to bridge the integration gap by executing graphical user interface (GUI)-based workflows. The AI agent system 106 functions across both API-enabled and GUI-only applications without requiring custom connectors for every application, thereby supporting a wide spectrum of use cases. The applications denoted by reference numeral 110, including application 1 through application N, represent the diversity in application connectivity and accessibility.

The application management platform 100 provides an operational control plane for deployment, configuration, and update management of the AI agent systems 106 across the enterprise environment. The application management platform 100 may further serve as an interface through which deployment packages, including deployment application template (DAT) files containing task templates and user interface locators, are delivered and version controlled. Version-controlled deployment ensures that application-specific logic can be updated without requiring modification to enterprise systems or target applications.

Operationally, when a task is initiated, including onboarding a new employee or revoking access for a departing contractor, the AI agent system 106 identifies relevant applications, determines whether the relevant applications are sanctioned or unsanctioned, and further determines whether programmatic access is available. Where APIs exist, the AI agent system 106 may utilize the APIs. Where no APIs are exposed, the AI agent system 106 performs interface-based automation by identifying credential fields, invoking generation elements, interacting with application controls, and confirming task completion through visual confirmation or response logging.

FIG. 1B illustrates an exemplary architecture of the AI agent system 106 deployed in a network environment. As depicted in FIG. 1B, a plurality of users 102-1 through 102-N operate respective user devices 104-1 through 104-N, the user devices being communicatively connected to the AI agent system 106 via the network 108. In the embodiment of FIG. 1B, a single AI agent system 106 serves the plurality of users 102-1 through 102-N and coordinates task execution across the set of applications 110.

The users 102 represent individuals or entities that require interaction with the AI agent system 106 for accessing enterprise functionalities or initiating enterprise workflows. The users 102 may include enterprise employees, external customers, partners, vendors, and contractors. Within an enterprise, the users 102 may take the form of managers, analysts, administrative staff, or compliance officers. For example, a marketing manager may request insights into sales performance metrics, while a data analyst may query historical usage patterns to train predictive models. Each interaction is facilitated through the user devices 104, which may include desktop computers, laptops, mobile phones, or tablets configured to transmit queries or task instructions to the AI agent system 106.

The AI agent system 106 functions as an intelligent middleware layer, interfacing with user instructions or task directives and performing corresponding task executions within the enterprise infrastructure. Upon receiving requests from the user devices 104-1 through 104-N or task directives from the agent command systems 101, the AI agent system 106 interprets an objective of the request or directive, references one or more semantic models, and orchestrates an execution strategy. The execution may involve data extraction from enterprise databases, task automation across enterprise applications, generation of alerts and recommendations, or credential and entitlement management operations.

An underlying semantic model employed by the AI agent system 106 maps concepts, relationships, and terminologies specific to the enterprise and an operational domain of the enterprise. The semantic model may incorporate language-specific and language-independent elements and may maintain a knowledge graph that encapsulates industry-specific vocabularies, inter-entity relationships, and organizational hierarchies. The semantic model allows the AI agent system 106 to provide meaningful and contextually accurate responses, even when user inputs are ambiguous, multilingual, or incomplete. For example, the AI agent system 106 may infer that a query about “partner logins” likely pertains to privileged account access in partner-facing systems and may respond accordingly.

The AI agent system 106 is capable of initiating omni-channel communication, providing task updates, delivering alerts, recommending actions, and handling real-time queries via chat, voice, or system notification interfaces. The AI agent system 106 may also proactively interact with the users 102 to suggest workflow improvements or to flag policy violations. For example, if a departing employee retains access to sensitive systems, the AI agent system 106 may initiate a revocation task and notify a security team.

The architecture is adaptable to various industry verticals including manufacturing, financial services, healthcare, oil and gas, and telecommunications. The AI agent system 106 is designed to accommodate industry-specific models, allowing the AI agent system 106 to process domain-relevant queries and execute tasks with high specificity and compliance.

The network 108 facilitates data transfer between the user devices 104-1 through 104-N and the AI agent system 106. In some embodiments, multiple interconnected networks 108 may be present between the user devices 104-1 through 104-N and the AI agent system 106. The network 108 may be a private network, a public network, or a hybrid network. The network 108 may be a local area network (LAN) or a wide area network (WAN).

The network 108 may be connected via wired or wireless links. Wired links may include digital subscriber line (DSL), coaxial cable lines, Ethernet, fiber optic links, or other links used for network infrastructure. Wireless links may include cellular, BLUETOOTH, Wi-Fi, Worldwide Interoperability for Microwave Access (WiMAX), infrared channels, satellite bands, or other wireless networking technologies. Wireless links may also include any cellular network standards used to communicate among mobile devices, including standards that qualify as 1G, 2G, 3G, 4G, 5G, or Long Term Evolution (LTE). Network standards may qualify as one or more generations of mobile telecommunication standards by fulfilling a specification or standards including specifications maintained by the International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include Advanced Mobile Phone System (AMPS), Global System for Mobile Communications (GSM), General Packet Radio Service (GPRS), Universal Mobile Telecommunications System (UMTS), High Speed Packet Access (HSPA), LTE, LTE Advanced, Mobile WiMAX, and WiMAX Advanced. Cellular network standards may use various channel access methods, including frequency division multiple access (FDMA), time division multiple access (TDMA), code division multiple access (CDMA), or space division multiple access (SDMA). In some embodiments, different types of data may be transmitted via different links and standards. In other embodiments, the same types of data may be transmitted via different links and standards.

The network 108 may be any type and form of network. The geographical scope of the network 108 may vary widely. The network 108 can be a body area network (BAN), a personal area network (PAN), a LAN including an Intranet, a metropolitan area network (MAN), or a WAN including the Internet. The topology of the network 108 may be of any form and may include point-to-point, serial, bus, star, ring, mesh, or tree topologies. The network 108 may be an overlay network that is virtual and sits on top of one or more layers of other networks. The network 108 may be of any network topology capable of supporting the operations described herein. The network 108 may utilize different techniques and layers or stacks of protocols, including the Ethernet protocol, the Internet protocol suite including Transmission Control Protocol over Internet Protocol (TCP/IP) and User Datagram Protocol over Internet Protocol (UDP/IP), the Asynchronous Transfer Mode (ATM) technique, the Synchronous Optical Networking (SONET) protocol, or the Synchronous Digital Hierarchy (SDH) protocol. The TCP/IP Internet protocol suite may include an application layer, a transport layer, an Internet layer including IPV6, or a link layer. The network 108 may be a type of broadcast network, telecommunications network, data communication network, or computer network.

In some implementations, one or more of the users 102-1 through 102-N may access the AI agent system 106 using one or more of the user devices 104-1 through 104-N. The AI agent system 106 may include one or more user interfaces, including browsers and textual or graphical user interfaces, through which the users 102-1 through 102-N may access the AI agent system 106.

The user devices 104-1 through 104-N and the AI agent system 106 may exist on a shared or segmented network. In some embodiments, the users 102 may access the AI agent system 106 remotely via virtual private networks (VPNs) or federated identity mechanisms, while in other embodiments, the users 102 may be co-located within an enterprise premise. The AI agent system 106 may access one or more databases communicatively coupled to the user devices 104-1 through 104-N through the network 108.

The database may be persistent storage that is capable of storing data. The persistent storage may be a local storage unit or a remote storage unit. The persistent storage may be a magnetic storage unit, an optical storage unit, a solid-state storage unit, an electronic storage unit including main memory, or a similar storage unit. The persistent storage may also be a monolithic single device or a distributed set of devices. Each component may include hardware including processing devices, including processors, central processing units (CPUs), and graphics processing units (GPUs), memory including random access memory (RAM), storage devices including a hard disk drive (HDD) and a solid-state drive (SSD), and other hardware devices including a sound card and a video card. The computing system may comprise any suitable type of computing device or machine that has a programmable processor including server computers, desktop computers, laptop computers, tablet computers, smartphones, and set-top boxes. In some examples, the computing system may comprise a single machine or may include multiple interconnected machines including multiple servers configured in a cluster. The computing system may be implemented by a common entity or organization or may be implemented by different entities or organizations.

FIG. 1C illustrates an alternative embodiment of the application management platform 100 depicting a distributed deployment environment of the AI agent system 106 in connection with an enterprise infrastructure. The architecture reflects system elements distributed across a plurality of communication networks 108-1 and 108-2 and demonstrates interactions between enterprise users, agent command systems, and applications.

As depicted in FIG. 1C, the enterprise users 102-1 and 102-2 operate corresponding user devices 104-1 and 104-2, respectively. The user devices 104-1 and 104-2 may include any computing device capable of establishing a network connection and interfacing with enterprise systems, including desktop computers, laptops, mobile phones, or tablet devices. Each user device may interact with a corresponding agent command system 101-1 or 101-2. The agent command systems 101-1 and 101-2 may be communicatively coupled to the AI agent system 106 through a first network 108-1, and the AI agent system 106 may be communicatively coupled to the set of applications 110 through a second network 108-2.

The AI agent system 106 interfaces with the agent command systems 101 and the set of applications 110 across the plurality of networks 108-1 and 108-2 and acts as an intermediary that facilitates intelligent, automated task execution based on enterprise identity controls. The AI agent system 106 may be communicatively coupled with the application management platform 100 that oversees and orchestrates deployment, access provisioning, and lifecycle management of AI-agent-based automation. The applications form a collective set of applications 110 of enterprise-deployed software systems, comprising commonly used platforms including Salesforce, customer relationship management systems, regulatory filing portals, or internally hosted operational tools. The set of applications 110 varies in accordance with each enterprise. The set of applications 110 is a customized set tailored to address the specific requirements of each enterprise.

The architecture of FIG. 1C emphasizes the role of distributed user interactions wherein different users, command-originating systems, and applications may be connected over different network interfaces. Unlike monolithic enterprise systems, the arrangement of FIG. 1C represents the practical reality of hybrid information technology environments where not all applications are uniformly connected or orchestrated under a single identity governance mechanism.

The AI agent system 106 mediates communication and operational requests between command-originating enterprise systems and the managed application ecosystem. The AI agent system 106 may incorporate logic for parsing user instructions or task directives, orchestrating task flows, validating access policies, updating credential states, and sending execution notifications. The AI agent system 106 enables agentic automation even in cases where application integration is incomplete or where manual processes are still used, by employing techniques including interface automation, synthetic API generation, or remote workflow triggers.

By situating the AI agent system 106 between disparate agent command systems and applications, the architecture shown in FIG. 1C supports a flexible, secure, and intelligent mechanism for managing complex enterprise workflows while maintaining identity and access policies enforced across multiple application types and endpoints.

### Exemplary System Architecture

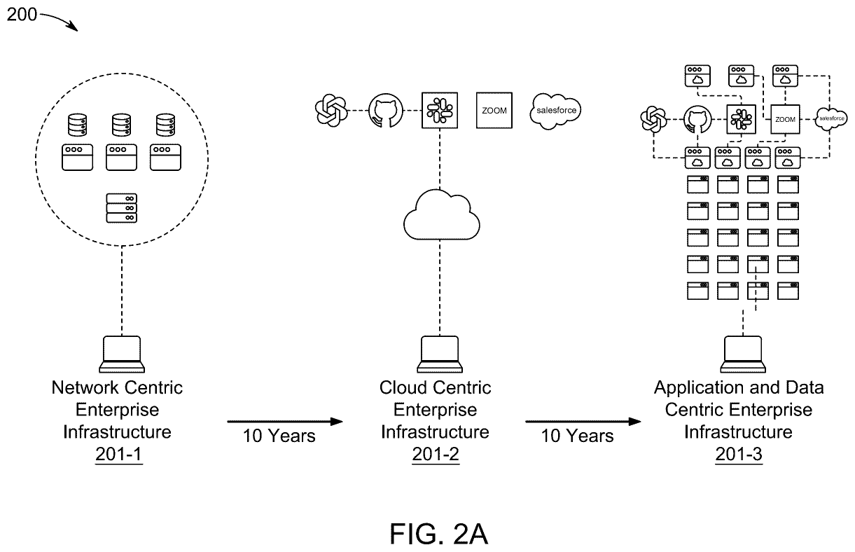

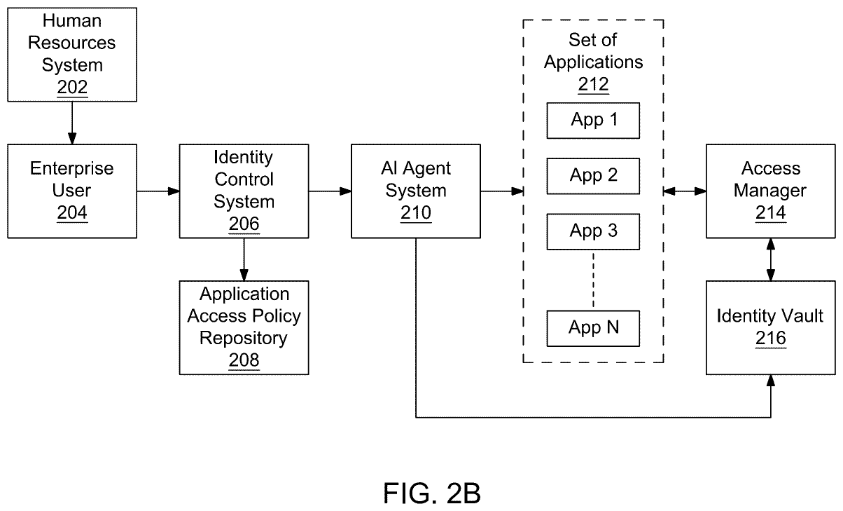

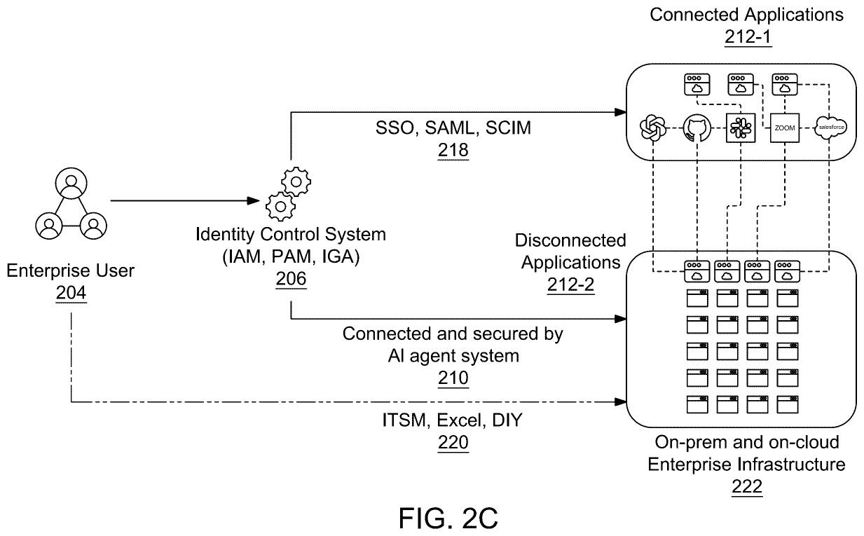

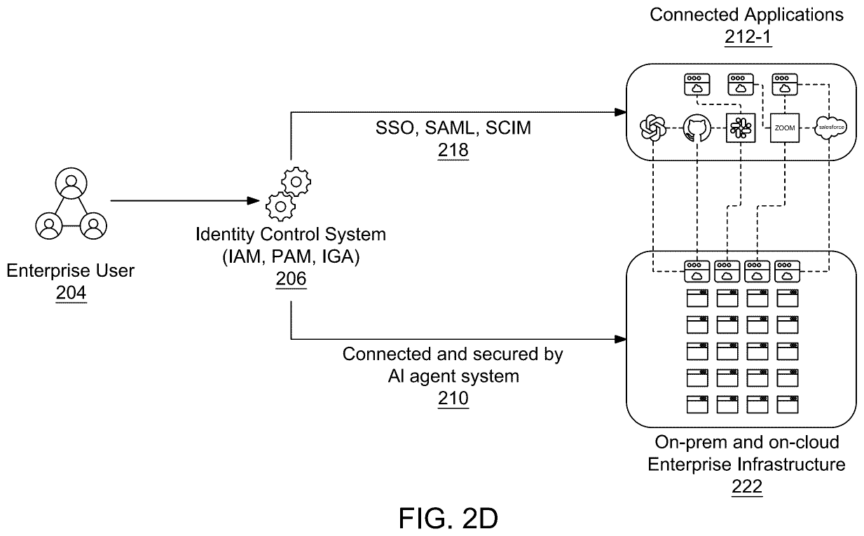

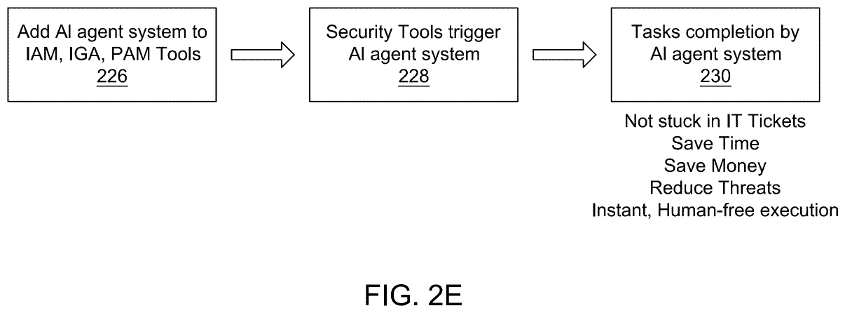

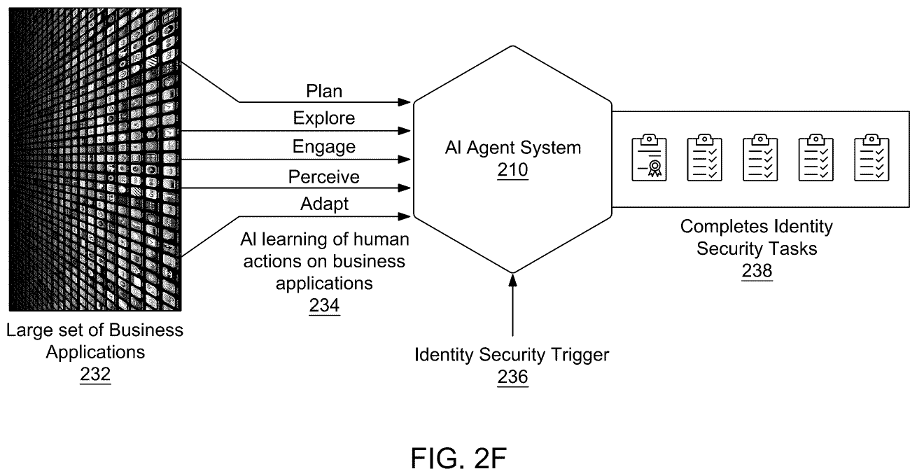

FIG. 2A illustrates an architectural diagram of an exemplary system 200 depicting the evolution of enterprise infrastructure models from network-centric paradigms to application- and data-centric paradigms, in accordance with certain embodiments of the present disclosure. The architectural diagram depicts three successive stages of enterprise infrastructure evolution spanning approximately two decades. A first stage depicts a network-centric enterprise infrastructure 201-1, in which enterprise applications and services are organized around physical network boundaries, on-premises data centers, and perimeter-based security models. A second stage depicts a cloud-centric enterprise infrastructure 201-2, in which enterprise applications and services migrate to cloud-hosted environments, introducing distributed access patterns and multi-tenant service delivery. A third stage depicts an application- and data-centric enterprise infrastructure 201-3, in which the enterprise security and identity perimeter shifts from a network layer to application and data layers, and individual applications and data stores become primary units of access control, policy enforcement, and identity governance. Each transition between successive stages spans approximately ten years. The evolution from the network-centric enterprise infrastructure 201-1 to the application- and data-centric enterprise infrastructure 201-3 creates a heterogeneous application landscape in which enterprise organizations simultaneously operate legacy on-premises applications, cloud-native services, and third-party platforms with varying degrees of integration, connectivity, and programmatic accessibility. The heterogeneity of the application- and data-centric enterprise infrastructure 201-3 forms the operational context in which the AI agent system described herein operates.

FIG. 2B illustrates an exemplary system 200 of an AI agent-based enterprise identity orchestration and credential automation platform, in accordance with certain embodiments of the present disclosure. The system 200 is implemented within a secure enterprise network environment and comprises a plurality of functional modules and system components, including a human resources system 202, an enterprise user 204, an identity control system 206, an application access policy repository 208, an AI agent system 210, a set of applications 212 comprising application 1 through application N, an access manager 214, and an identity vault 216.

The human resources system 202 is a centralized enterprise repository that maintains user-specific attributes and employment metadata, including designation, department, employment status, access eligibility criteria, and historical access records. For example, upon onboarding a new employee into a marketing department, the human resources system 202 stores the relevant role, project assignment, and department-specific flags that inform downstream access decisions. When an employee transitions from one department to another or exits the organization, the human resources system 202 updates the employment status accordingly.

The enterprise user 204 may be an internal administrative system, service entity, or administrative user operating within the enterprise infrastructure that fetches the employee details from the human resources system 202. The employee details include identity attributes, department-based entitlements, project-specific roles, and policy flags that define a scope of application access for the employee. For example, the enterprise user 204 may detect that an employee assigned to a financial audit project is eligible for limited access to an enterprise financial ledger application while being denied access to engineering development platforms.

The identity control system 206 serves as a decision engine that interprets enterprise-defined access control policies and determines an eligible set of applications each employee is permitted to access. The identity control system 206 may utilize static policy rules, dynamic access condition evaluation, or role-based access control logic to determine entitlements. For example, a data analyst joining a compliance team may be granted view-only access to compliance dashboards, whereas a senior compliance officer may be granted editing and submission privileges. Based on the determined scope of access, the identity control system 206 triggers either a credential creation task upon employee onboarding or a revocation task upon employee exit or access expiration.

The application access policy repository 208 is a dedicated storage layer or configuration store that maintains policy documents, compliance checklists, access templates, and entitlement definitions. The application access policy repository 208 may include per-application authentication modes, credential types, and compliance requirements. For example, a customer relationship management system may require multi-factor authentication using time-based tokens, while a regulatory submission platform may require access through a secure virtual private network (VPN). The identity control system 206 consults the application access policy repository 208 when making determinations regarding access provisioning or deprovisioning.

The AI agent system 210 functions as an intelligent execution layer that translates an intent derived from the identity control system 206 into a series of task executions across multiple heterogeneous applications. The AI agent system 210 orchestrates a credential creation, modification, or removal process and communicates with both connected and disconnected applications. For example, a customer relationship management platform may be a sanctioned and programmatically accessible application supporting standard authentication protocols, while a third-party treasury interface hosted on a partner cloud infrastructure may require interface automation using robotic process automation (RPA) or semantic uniform resource locator (URL)-based mapping. The AI agent system 210 handles both categories with equal agility, providing consistent and audit-friendly execution.

The set of applications 212, comprising application 1 through application N, represents a portfolio of enterprise tools and applications that employees may need to access. The set of applications 212 includes customer relationship management platforms, regulatory submission platforms, internal operational tools hosted on private cloud, and third-party partner interfaces. Some applications within the set of applications 212 are classified as sanctioned and support direct programmatic access, while other applications may be unlisted, disconnected, or legacy systems that do not expose modern application programming interfaces. For example, a sanctioned system may allow secure identity federation, while an unsanctioned procurement portal may require screen-based automation or manual form parsing.

The access manager 214 supervises overall task execution and maintains auditability. The access manager 214 verifies that credential lifecycle management activities, including provisioning, updates, and revocations, are completed successfully, logged appropriately, and aligned with enterprise compliance expectations. For example, in scenarios where a deprovisioning task fails due to an unreachable application, the access manager 214 may escalate an issue to an administrator and trigger a retry loop. The access manager 214 may also enforce temporal access constraints, including expiring credentials issued for short-term contractors, and may maintain versioned audit logs to support forensic analysis and compliance reporting.

The identity vault 216 functions as a secure storage module for credentials issued to enterprise users. The identity vault 216 may store usernames, passwords, application programming interface tokens, multi-factor secrets, and biometric templates. For example, when an employee is granted access to a cloud database, generated credentials are securely stored in the identity vault 216 in compliance with encryption-at-rest policies, audit logging, access expiration, and role-based retrieval constraints. The identity vault 216 may support zero-trust integrations with endpoint agents to facilitate secure credential injection at runtime.

The components of the system 200 operate in coordination to provide seamless, policy-compliant, and secure identity orchestration within complex enterprise environments. The AI-driven architecture of the system 200 provisions user access in accordance with verified human resources data and policy data, and executes tasks including application programming interface key refresh and user deactivation proactively, even for applications not directly connected to enterprise identity systems.

FIG. 2C illustrates an architectural diagram depicting integration of AI agent-based identity governance across connected applications and disconnected applications within a hybrid enterprise infrastructure, in accordance with certain embodiments of the present disclosure. FIG. 2C depicts the enterprise user 204 coupled to the identity control system 206 implementing identity and access management (IAM), privileged access management (PAM), and identity governance and administration (IGA) functions. The identity control system 206 is communicatively coupled to the AI agent system 210, which is communicatively coupled to both a set of connected applications 212-1 and a set of disconnected applications 212-2 within an on-premises and on-cloud enterprise infrastructure 222. The connected applications 212-1 are integrated with the identity control system 206 via standardized protocols including single sign-on (SSO), security assertion markup language (SAML), and system for cross-domain identity management (SCIM) 218. The disconnected applications 212-2 are applications that lack native protocol integration and are managed using alternative methods, including information technology service management (ITSM) tickets, spreadsheet-based tracking, or custom-built tools 220. The AI agent system 210 bridges a gap between the connected applications 212-1 and the disconnected applications 212-2 by providing automated identity governance capabilities across both categories of applications irrespective of availability of a programmatic interface.

FIG. 2D illustrates an exemplary connectivity framework between enterprise users, the identity control system, and a plurality of applications integrated with the AI agent system, in accordance with certain embodiments of the present disclosure. FIG. 2D depicts the enterprise user 204 coupled to the identity control system 206 implementing IAM, PAM, and IGA functions. The identity control system 206 is communicatively coupled to the AI agent system 210, which is communicatively coupled to the connected applications 212-1 deployed on the on-premises and on-cloud enterprise infrastructure 222 via SSO, SAML, and SCIM 218. FIG. 2D illustrates an alternative embodiment in which an enterprise application landscape comprises primarily connected applications 212-1, and the AI agent system 210 operates alongside standardized identity federation and provisioning protocols.

FIG. 2E is a system workflow diagram showing an AI agent-driven remediation process initiated by contextual security signals and executed across enterprise applications, in accordance with certain embodiments of the present disclosure. FIG. 2E depicts three sequential stages. At a first stage 226, the AI agent system 210 is added to IAM, IGA, and PAM tools, integrating agentic automation capabilities into existing identity governance infrastructure. At a second stage 228, security tools trigger the AI agent system 210 in response to identity lifecycle events, policy violations, or security incidents. At a third stage 230, the AI agent system 210 completes identity security tasks across an enterprise application estate, achieving instant, human-free execution, time savings, cost reduction, and threat mitigation.

FIG. 2F is a conceptual diagram depicting AI agent behavioral learning for autonomous execution of identity lifecycle tasks in enterprise applications, in accordance with certain embodiments of the present disclosure. FIG. 2F depicts the AI agent system 210 that learns from human actions on business applications 234 within a large set of business applications 232. The AI agent system 210 acquires behavioral patterns through a sequence of learning stages comprising plan, explore, engage, perceive, and adapt. Upon receiving an identity security trigger 236, the AI agent system 210 completes identity security tasks 238 across the large set of business applications 232 by applying learned behavioral patterns to autonomously navigate, interpret, and interact with enterprise application interfaces.

### Internal Functional Modules

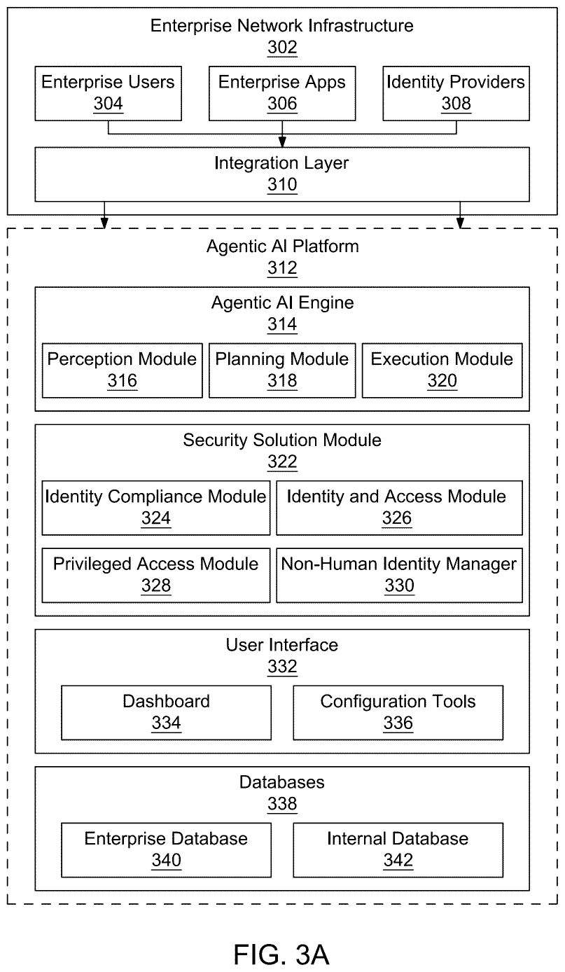

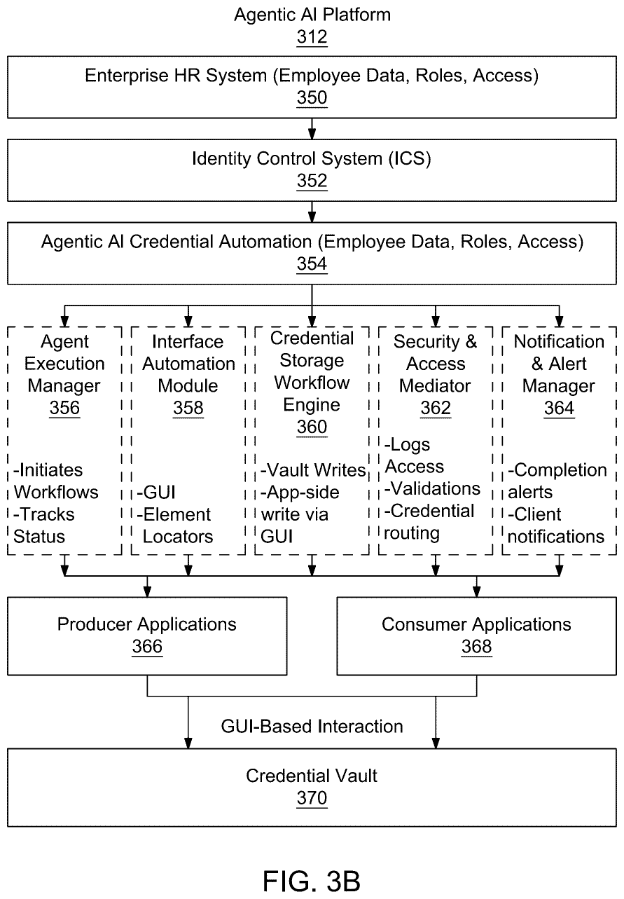

FIG. 3A illustrates an exemplary system architecture depicting internal functional modules of the agentic AI platform, in accordance with certain embodiments of the present disclosure. The architecture is deployed within an enterprise network infrastructure 302 and is communicatively coupled to enterprise users 304, enterprise applications 306, and identity providers 308 via an integration layer 310.

The architecture comprises an agentic AI platform 312 containing an agentic AI engine 314. The agentic AI engine 314 comprises a perception module 316, a planning module 318, and an execution module 320. The perception module 316 is configured to detect and interpret user interface elements rendered on graphical interfaces of enterprise applications using computer vision and image recognition techniques. The planning module 318 is configured to decompose identity governance intents into structured execution plans by interpreting user instructions, evaluating policy constraints, and determining a sequence of actions to be performed across target enterprise applications. The execution module 320 is configured to carry out actions determined by the planning module 318 by generating and executing simulated user interactions with the enterprise application interfaces, including mouse-click simulation, keyboard-input simulation, and form-field population.

The agentic AI platform 312 further comprises a security solution module 322, an identity compliance module 324, an identity and access module 326, a privileged access module 328, and a non-human identity manager 330. The security solution module 322 provides security validation and enforcement across platform workflows. The identity compliance module 324 monitors and enforces compliance with regulatory and organizational access control policies. The identity and access module 326 manages user identity lifecycle operations including provisioning, deprovisioning, and entitlement review. The privileged access module 328 manages elevated access privileges and privileged session controls. The non-human identity manager 330 manages credentials and access privileges associated with service accounts, machine identities, and automated processes.

The architecture comprises a user interface 332 including a dashboard 334 and configuration tools 336 accessible to enterprise administrators and compliance personnel. The architecture is communicatively coupled to databases 338 including an enterprise database 340 and an internal database 342 that store identity records, access policies, credential metadata, and audit logs.

### Agentic AI Credential Automation System

FIG. 3B illustrates the agentic AI platform 312, described with reference to FIG. 3A, configured as an agentic AI credential automation system for performing graphical user interface (GUI)-based orchestration for enterprise identity workflows, in accordance with certain embodiments of the present disclosure. FIG. 3B depicts a credential automation subsystem within the agentic AI platform 312, bridging enterprise policy engines with application endpoints through an intelligent middleware capable of credential generation, injection, and lifecycle management.

The agentic AI platform 312, as depicted in FIG. 3B, comprises an enterprise human resources (HR) system 350 that functions as an authoritative data source for user identity attributes, including employee data, roles, and access entitlements. The enterprise HR system 350 maintains updated metadata about each employee and acts as an originator of identity provisioning or deprovisioning events.

An identity control system (ICS) 352 receives the user identity attributes from the enterprise HR system 350 and evaluates organizational access policies. The identity control system 352 determines application access, triggers credential creation or removal, and stores policy metadata. For example, upon offboarding, the identity control system 352 triggers workflows to remove application-level access, which are then delegated to the credential automation subsystem.

An agentic AI credential automation module 354 functions as a middleware execution engine configured to translate access decisions into executable actions. The agentic AI credential automation module 354 receives the employee data, the roles, and the access entitlements from the identity control system 352 and serves as a core protocol abstraction layer capable of interacting with a heterogeneous application ecosystem. The agentic AI credential automation module 354 orchestrates credential issuance, revocation, and updates across both connected and disconnected systems.

The agentic AI credential automation module 354 comprises an agent execution manager 356, an interface automation module 358, a credential storage workflow engine 360, a security and access mediator 362, and a notification and alert manager 364. The agent execution manager 356 initiates workflows and tracks execution status by decomposing incoming identity intents into atomic sub-tasks and routing the sub-tasks to appropriate modules. For example, upon receiving an instruction to generate a new application programming interface key, the agent execution manager 356 may trigger the credential storage workflow engine 360 and a credential generation workflow in parallel.

The interface automation module 358 facilitates GUI-level automation for applications that lack standard application programming interface connectivity. The interface automation module 358 includes logic for identifying GUI elements including input fields, buttons, dropdowns, and dynamic frames using element locators. The interface automation module 358 enables the agentic AI platform 312 to perform programmatic interactions with external systems in a human-like manner.

The credential storage workflow engine 360 manages secure handling and routing of credentials. The credential storage workflow engine 360 supports vault write operations to a centralized credential vault 370 and application-side write operations via GUI interfaces. For example, a newly created application programming interface key for a field service application may be stored in the credential vault 370 while also being simultaneously injected into an application user management portal.

The security and access mediator 362 logs access events, performs policy validations, and manages credential routing during workflow execution. The security and access mediator 362 monitors transactional success or failure and is configured to enforce conditional logic including time-based access expiry and escalation rules.

The notification and alert manager 364 handles completion alerts and client notifications across the agentic AI platform 312. Upon successful completion of credential-related operations, the notification and alert manager 364 sends alerts to appropriate stakeholders including system administrators, compliance officers, or application owners.

Producer applications 366 represent internal enterprise systems configured to generate credentials, including credential generators, application programming interface key generators, and internal administrative user interfaces. Consumer applications 368 are target systems that rely on generated credentials for user access, including regulatory submission applications, customer relationship management platforms, field operations tools, and treasury systems. The agentic AI credential automation module 354 interacts with both the producer applications 366 and the consumer applications 368 via GUI-based interaction.

The credential vault 370 serves as a centralized storage repository for enterprise credentials. The credential vault 370 is updated via the credential storage workflow engine 360 and supports credential rotations and time-to-live (TTL) enforcement. The credential vault 370 stores credentials including passwords, application programming interface keys, and authentication tokens in an encrypted format, and maintains credentials that are valid and within expiration boundaries.

The agentic AI platform 312, as depicted in FIG. 3B, facilitates a GUI-driven, application-agnostic, and audit-enforced identity orchestration mechanism that reduces dependency on application-specific application programming interfaces. The agentic AI platform 312 is updatable through deployment application template (DAT) files, allowing new applications to be integrated without system reengineering.

### Credential Lifecycle System

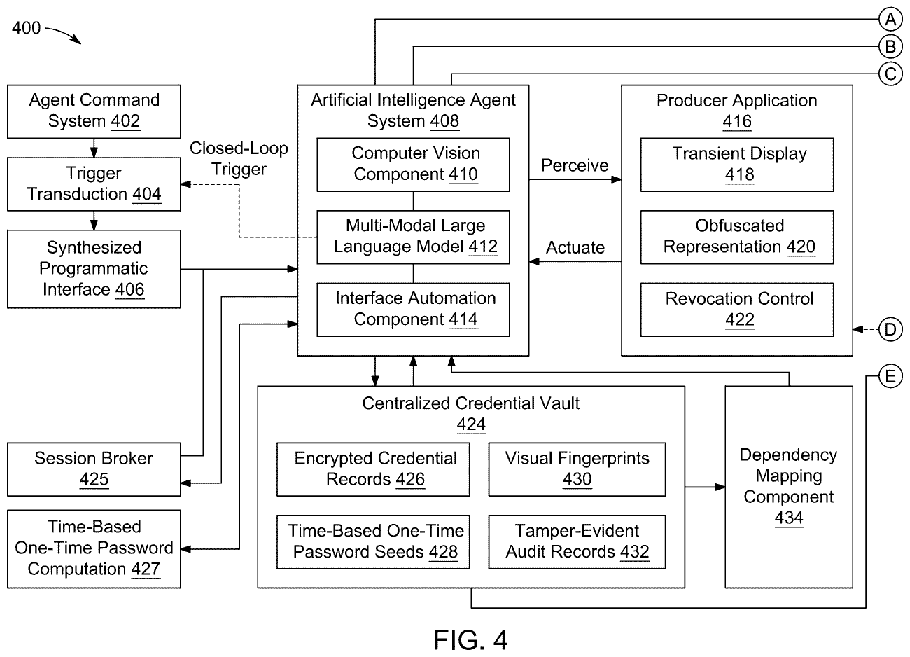

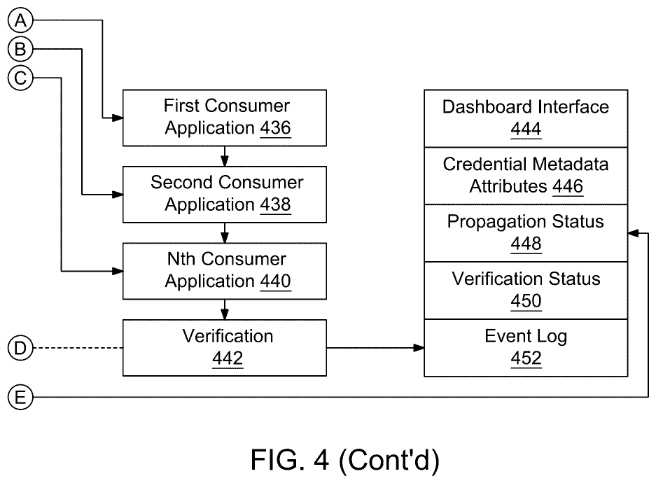

FIG. 4 illustrates a credential lifecycle system 400. The credential lifecycle system, also referred to as the system 400, is configured to perform autonomous discovery, aggregation, rotation, and propagation of application programming interface (API) credentials across a plurality of enterprise applications. The system 400 implements an agentic artificial intelligence architecture wherein a multi-modal large language model and a computer vision component cooperate to interact with rendered graphical user interfaces of enterprise applications, derive a plurality of API credential metadata attributes from content rendered on the graphical user interfaces, generate new API credentials at producer applications through simulated graphical user interface interactions, propagate the new API credentials to dependent consumer applications, and aggregate the metadata attributes and propagation status in a dashboard interface for governance and audit purposes. An API credential refers to a machine-readable secret that authorizes a calling computing process to invoke functionality of an enterprise application, including, by way of example and not limitation, an API key, a client secret, an integration secret, a service account token, an access token, a refresh token, or a signing key. A producer application refers to an enterprise application at which an API credential is generated, listed, regenerated, or revoked through a graphical user interface of the enterprise application. A consumer application refers to an enterprise application that authenticates to or otherwise consumes services of a producer application using an API credential issued by the producer application. The system 400 is implemented in heterogeneous enterprise environments, including environments comprising producer applications that expose a native programmatic credential management interface and environments comprising producer applications that expose a graphical user interface for credential management.

The system 400 comprises an agent command system 402 operably coupled to a trigger transduction 404 and to a synthesized programmatic interface 406. The agent command system 402 is configured to receive trigger events from one or more trigger sources and to communicate the trigger events to downstream components of the system 400 for execution. The trigger sources may include, by way of example and not limitation, a human resources platform that emits an event upon onboarding, role reassignment, or offboarding of an enterprise user, an identity governance and administration platform that emits an event upon a periodic access certification cycle, an identity and access management platform that emits an event upon a privileged session change, an enterprise ticketing platform that emits an event upon submission of a credential request ticket, a command-line utility through which an administrator manually invokes a credential operation, a compliance audit trigger source that emits an event upon discovery of a non-compliant credential during an audit cycle, and a webhook callback through which a third-party system emits an event programmatically. The agent command system 402 routes the trigger event either to the trigger transduction 404, where the trigger event is transformed into a machine-actionable instruction for the artificial intelligence agent system, or to the synthesized programmatic interface 406, where the trigger event invokes a programmatic method exposed by the system 400.

The trigger transduction 404 is configured to translate a trigger event received from the agent command system 402 into an execution instruction characterizing a target producer application, a credential operation type, and one or more operational parameters. The credential operation type may include, by way of example and not limitation, a discovery operation, a generation operation, a propagation operation, a verification operation, a rotation operation, or a revocation operation. The trigger transduction 404 is further configured to receive a closed-loop trigger from the artificial intelligence agent system 408. The closed-loop trigger is generated upon detection of a non-compliance condition by the multi-modal large language model 412, and routes the detected non-compliance condition through the trigger transduction 404 to initiate a rotation transaction without intervention by an external scheduler, an external policy engine, or a human administrator queue.

The synthesized programmatic interface 406 is configured to expose, to the agent command system 402, a programmatic credential management surface for a producer application that does not natively expose a programmatic credential management interface. The synthesized programmatic interface 406 is generated by observing a sequence of graphical user interface interactions performed at the producer application and synthesizing therefrom one or more callable programmatic methods, including a method for generating a new API credential, a method for revoking an API credential, and a method for listing API credentials. Upon invocation of a callable programmatic method by the agent command system 402, the synthesized programmatic interface 406 replays the corresponding sequence of graphical user interface interactions through the artificial intelligence agent system 408 against the producer application and returns a return value to the agent command system 402.

The system 400 further comprises an artificial intelligence agent system 408 operably coupled to the trigger transduction 404, the synthesized programmatic interface 406, a producer application 416, and a centralized credential vault 424. The artificial intelligence agent system 408 is configured to interact with the graphical user interface of the producer application 416 through perception of rendered visual content and execution of simulated graphical user interface interactions. The artificial intelligence agent system 408 comprises a computer vision component 410, a multi-modal large language model 412, and an interface automation component 414.

The computer vision component 410 is configured to capture an image of content rendered in the graphical user interface of the producer application 416 and to detect, within the captured image, one or more interface elements that constitute candidate credential-displaying regions or candidate credential-generation interface elements. The computer vision component 410 is implemented through one or more of an image capture operation, a bounding-box detection operation, a document object model parsing operation, and an element classification operation. The image capture operation acquires a pixel-level representation of the rendered graphical user interface. The bounding-box detection operation localizes interface elements within the pixel-level representation by computing coordinates of rectangular regions enclosing the interface elements. The document object model parsing operation extracts a hierarchical representation of structured interface elements from a document object model associated with the rendered graphical user interface, when such a representation is exposed by the producer application 416. The element classification operation assigns each detected interface element to one of a plurality of element categories, including, by way of example and not limitation, a credential-displaying element category, a credential-generation interface element category, a revocation control element category, a multi-factor authentication input element category, and a navigational element category.

The multi-modal large language model 412 is configured to receive the captured image and the detected interface elements from the computer vision component 410 and to derive therefrom a plurality of API credential metadata attributes specific to an API credential displayed in the graphical user interface of the producer application 416. The multi-modal large language model 412 is operable to classify a region of the graphical user interface as a credential-displaying region by jointly evaluating visual features of the captured image and textual features of content rendered within and adjacent to the region, and to disambiguate semantically similar credential-related terms rendered in the graphical user interface, including, by way of example and not limitation, the terms API key, client secret, integration secret, and authorization token, by mapping each rendered term to one or more aliases of a target credential class. The plurality of API credential metadata attributes may include a credential identifier, an issuing user, a creation timestamp, a scope, an issuer status, a last-used timestamp, an access type, and a status. The multi-modal large language model 412 is further configured to evaluate the plurality of API credential metadata attributes against one or more non-compliance criteria, including, by way of example and not limitation, an age threshold exceeded condition, a scope breadth excessive condition, an issuer deactivated condition, and a low usage activity condition, and upon detection of a non-compliance condition, to emit the closed-loop trigger to the trigger transduction 404. The multi-modal large language model 412 may be implemented through a transformer-based architecture, a vision transformer architecture, an encoder-decoder architecture, or any combination thereof, and may be operated as a single unified multi-modal model or as a coordinated set of vision-specific and text-specific sub-models.

The interface automation component 414 is configured to execute simulated graphical user interface interactions against the graphical user interface of the producer application 416 in accordance with instructions received from the multi-modal large language model 412. The simulated graphical user interface interactions are implemented through one or more of a mouse event simulation, a keyboard event simulation, a form-field population, and a copy-paste primitive. The interface automation component 414 is operable to actuate a generate new credential element of the graphical user interface of the producer application 416, to actuate a revocation control of the graphical user interface of the producer application 416, to enter computed authentication codes into a multi-factor authentication input element of the graphical user interface of the producer application 416, and to navigate among views of the graphical user interface of the producer application 416 to reach a credential-displaying region.

The system 400 further comprises the producer application 416. The producer application 416 is configured to render, on a graphical user interface thereof, a credential listing comprising one or more API credentials previously issued by the producer application 416, a transient display 418 comprising a newly generated API credential rendered for a one-time, ephemeral interval following actuation of a generate new credential element, an obfuscated representation 420 comprising a masked rendering of a previously issued API credential in which a substring of the credential value is replaced with one or more masking characters, and a revocation control 422 by which a previously issued API credential may be revoked through the graphical user interface of the producer application 416. The producer application 416 may be implemented as a software-as-a-service application, an on-premise enterprise application, a cloud-hosted application, a legacy enterprise application, or any other application that renders credential management surfaces through a graphical user interface. The producer application 416 may, in some implementations, additionally expose a programmatic credential management interface, in which case the system 400 is operable to interact with the producer application 416 through the programmatic credential management interface as an alternative to or in combination with the simulated graphical user interface interactions executed by the interface automation component 414.

The transient display 418 is implemented as a portion of the graphical user interface of the producer application 416 that renders a complete value of a newly generated API credential for an ephemeral interval following actuation of the generate new credential element of the producer application 416. The ephemeral interval may range from a few seconds to several minutes, after which the transient display 418 ceases to render the complete value of the newly generated API credential and the producer application 416 thereafter renders the obfuscated representation 420 of the newly generated API credential within the credential listing. The artificial intelligence agent system 408 is configured to capture the complete value of the newly generated API credential from the transient display 418 during the ephemeral interval and to store the complete value in the encrypted credential records 426 of the centralized credential vault 424.

The obfuscated representation 420 is implemented as a masked rendering of a previously issued API credential in which a substring of the credential value is replaced with one or more masking characters, and serves as a visual identifier through which the artificial intelligence agent system 408 re-identifies a previously stored API credential during a subsequent interaction with the graphical user interface of the producer application 416. By way of non-limiting example, an obfuscated representation may take the form sk_live_xyz9***abcd, wherein the leading and trailing characters are rendered in plain form and the intermediate characters are replaced with the masking character.

The revocation control 422 is implemented as an interactive element of the graphical user interface of the producer application 416 by which a previously issued API credential may be revoked. The revocation control 422 may be rendered as a button, a link, a contextual menu item, or an analogous interface element. The interface automation component 414 is configured to actuate the revocation control 422 through a simulated graphical user interface interaction in accordance with a revocation determination computed by the multi-modal large language model 412.

The system 400 further comprises the centralized credential vault 424 operably coupled to the artificial intelligence agent system 408 and to a dependency mapping component 434. The centralized credential vault 424 is configured to store, in association with each API credential, encrypted credential records 426, time-based one-time password seeds 428, visual fingerprints 430, and tamper-evident audit records 432. The encrypted credential records 426 store complete values of API credentials in encrypted form, the encryption being performed using a symmetric or asymmetric cryptographic algorithm and a key managed by a key management infrastructure of the system 400. The time-based one-time password seeds 428 store shared secrets used to compute time-based one-time passwords for satisfying multi-factor authentication challenges presented by the producer application 416. The visual fingerprints 430 store obfuscated representations 420 of API credentials together with one or more visual features extracted from rendered appearances of the credentials within the graphical user interface of the producer application 416, and serve as re-identification artifacts through which the artificial intelligence agent system 408 locates API credentials within the credential listing of the producer application 416 during subsequent interactions. The tamper-evident audit records 432 store chronological logs of credential operations performed by the system 400, in which entries of the logs are bound to preceding entries through cryptographic hash chains that detect modification or removal of prior entries. The centralized credential vault 424 may be implemented as a single logical store deployed on-premise, in a cloud computing environment, or in a distributed storage architecture spanning multiple networked storage servers.

The system 400 further comprises a session broker 425 operably coupled to the artificial intelligence agent system 408 and to the centralized credential vault 424. The session broker 425 is configured to maintain a state buffer characterizing a current session of the artificial intelligence agent system 408 with the producer application 416, and upon encountering a graphical user interface interaction that the artificial intelligence agent system 408 is unable to fulfill autonomously, to hand off the current session to a human administrator while preserving the state buffer such that the human administrator continues the current session from the state at which the handoff occurred. Upon completion of the graphical user interface interaction by the human administrator, the session broker 425 returns control of the current session to the artificial intelligence agent system 408 together with any state changes resulting from the handoff. The state buffer may include, by way of example and not limitation, a sequence of completed steps, a current rendered view of the graphical user interface of the producer application 416, a set of values entered into form fields of the graphical user interface, and a session token associated with the current session.

The system 400 further comprises a time-based one-time password computation 427 operably coupled to the artificial intelligence agent system 408 and to the centralized credential vault 424. The time-based one-time password computation 427 is configured to read a time-based one-time password seed from the time-based one-time password seeds 428 of the centralized credential vault 424, to compute a time-based one-time password from the time-based one-time password seed and a current time value in accordance with a time-based one-time password algorithm, and to provide the computed time-based one-time password to the interface automation component 414 for entry into a multi-factor authentication input element of the graphical user interface of the producer application 416. The time-based one-time password may be computed in accordance with the algorithm specified in Internet Engineering Task Force Request for Comments 6238 or any successor or analogous algorithm. The time-based one-time password computation 427 is performed in volatile memory of the system 400 such that the computed time-based one-time password is not persisted to non-volatile storage following entry into the multi-factor authentication input element.

The system 400 further comprises the dependency mapping component 434 operably coupled to the centralized credential vault 424. The dependency mapping component 434 is configured to maintain a mapping that associates each API credential with a set of consumer applications that authenticate to or otherwise consume services of the producer application 416 using the API credential. The mapping is constructed from one or more of static inputs comprising configuration manifests, deployment registries, and developer-declared bindings, dynamic inputs comprising runtime trace observations of credential usage, administrative inputs comprising explicit administrator declarations, and discovery inputs comprising the plurality of API credential metadata attributes derived by the multi-modal large language model 412. The dependency mapping component 434 is operable to receive a query input comprising a credential identifier and to return therefrom a set of consumer applications associated with the credential identifier, and is further operable to update the mapping in response to a rotation event, a propagation event, or a revocation event communicated by the artificial intelligence agent system 408.

The system 400 further comprises a plurality of consumer applications, including a first consumer application 436, a second consumer application 438, and an Nth consumer application 440. Each consumer application of the plurality of consumer applications is operable to authenticate to or otherwise consume services of the producer application 416 using an API credential issued by the producer application 416. Upon generation of a new API credential at the producer application 416, the artificial intelligence agent system 408 propagates the new API credential to each consumer application of the plurality of consumer applications associated with the producer application 416 by the dependency mapping component 434. Propagation of the new API credential to a given consumer application is performed through one of a programmatic application programming interface call directed to the given consumer application or a simulated graphical user interface interaction performed by the artificial intelligence agent system 408 against a graphical user interface of the given consumer application.

The system 400 further comprises a verification 442 operably coupled to the plurality of consumer applications. The verification 442 is configured to confirm successful integration of the new API credential at each consumer application of the plurality of consumer applications, and to emit a verification status indicating whether the new API credential is successfully integrated at the consumer application. The verification 442 may be performed by issuing a test request to the consumer application using the new API credential and inspecting a response of the consumer application, by inspecting a rendered state of a graphical user interface of the consumer application through the computer vision component 410, or by reading a status indicator of the consumer application through a programmatic application programming interface exposed by the consumer application. Upon receipt of a verification status indicating successful integration of the new API credential at each consumer application of the plurality of consumer applications, the artificial intelligence agent system 408 actuates the revocation control 422 of the producer application 416 to revoke a prior API credential previously issued by the producer application 416, thereby completing a rotation transaction.

The system 400 further comprises a dashboard interface 444 operably coupled to the artificial intelligence agent system 408, the centralized credential vault 424, the dependency mapping component 434, and the verification 442. The dashboard interface 444 is configured to aggregate, in a single view accessible to an enterprise governance user, a plurality of credential metadata attributes 446 derived by the multi-modal large language model 412, a propagation status 448 characterizing a state of propagation of a new API credential to each consumer application of the plurality of consumer applications, a verification status 450 characterizing an outcome of the verification 442 for each consumer application, and an event log 452 comprising a chronological sequence of credential operations performed by the system 400. The propagation status 448 may take values including, by way of example and not limitation, completed, in-progress, failed, and pending. The verification status 450 may take values including, by way of example and not limitation, verified, not-verified, and verification-failed. The event log 452 may comprise a plurality of records, each record comprising an operation identifier, an application identifier, a timestamp, an agent identifier, an API credential identifier, and a result status, and may be filtered by one or more compliance frameworks, including the Sarbanes-Oxley Act, the Health Insurance Portability and Accountability Act, the Payment Card Industry Data Security Standard, and the General Data Protection Regulation.

The system 400 is operable to perform an end-to-end credential lifecycle transaction comprising a discovery phase, a generation phase, a propagation phase, a verification phase, a revocation phase, and an aggregation phase. In the discovery phase, the artificial intelligence agent system 408 receives a trigger event through the agent command system 402 and the trigger transduction 404, applies the multi-modal large language model 412 to content rendered in the graphical user interface of the producer application 416, derives the plurality of API credential metadata attributes from the rendered content, and stores the plurality of API credential metadata attributes and at least one API credential in the centralized credential vault 424. In the generation phase, the artificial intelligence agent system 408 actuates the generate new credential element of the graphical user interface of the producer application 416 through the interface automation component 414, captures a complete value of a newly generated API credential from the transient display 418 during the ephemeral interval, and stores the complete value in the encrypted credential records 426 of the centralized credential vault 424 together with a corresponding visual fingerprint of the visual fingerprints 430. In the propagation phase, the dependency mapping component 434 identifies a set of consumer applications associated with the API credential, and the artificial intelligence agent system 408 propagates the newly generated API credential to each consumer application of the set of consumer applications through one of a programmatic application programming interface call or a simulated graphical user interface interaction. In the verification phase, the verification 442 confirms successful integration of the newly generated API credential at each consumer application of the set of consumer applications. In the revocation phase, the artificial intelligence agent system 408 actuates the revocation control 422 of the producer application 416 to revoke a prior API credential previously issued by the producer application 416. In the aggregation phase, the dashboard interface 444 aggregates the plurality of credential metadata attributes 446, the propagation status 448, the verification status 450, and the event log 452.

In one or more implementations, the system 400 is further operable to perform a stateful rollback transaction in response to a verification status 450 indicating unsuccessful integration of the newly generated API credential at one or more consumer applications of the set of consumer applications. In the stateful rollback transaction, the artificial intelligence agent system 408 retrieves a prior API credential from the encrypted credential records 426 of the centralized credential vault 424, propagates the prior API credential to each consumer application of the set of consumer applications previously updated with the newly generated API credential, and actuates the revocation control 422 of the producer application 416 to revoke the newly generated API credential, thereby restoring the system 400 to the state preceding the rotation transaction.

### Credential Lifecycle Method

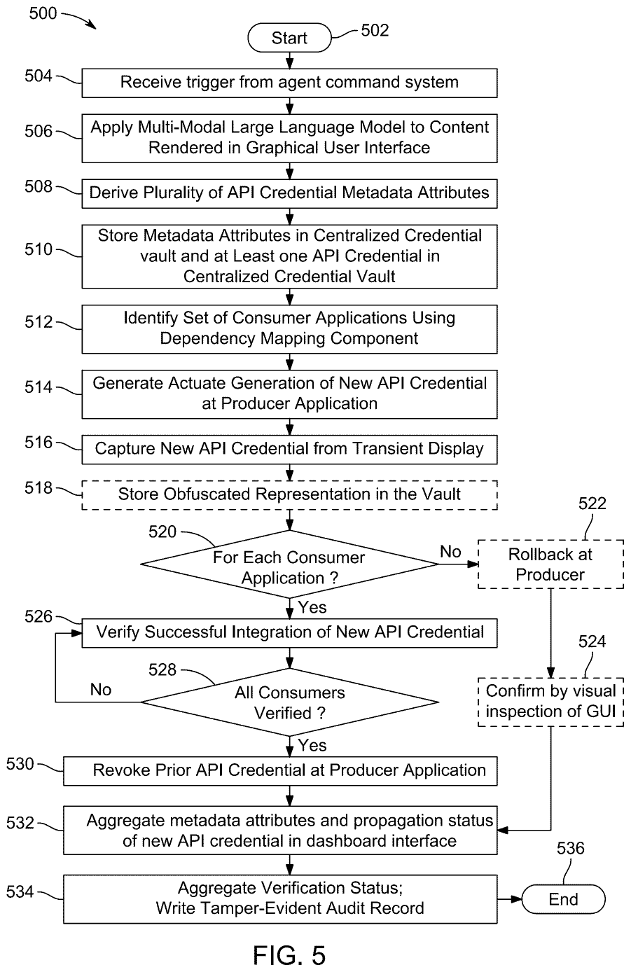

FIG. 5 illustrates a credential lifecycle method 500. The credential lifecycle method, also referred to as the method 500, is implemented by the system 400 of FIG. 4 and is configured to perform autonomous discovery, generation, propagation, verification, revocation, aggregation, and audit of an application programming interface credential associated with a producer application 416 and a plurality of consumer applications 436, 438, 440. The method 500 commences at a start state 502 and terminates at an end state 536.

The method 500 commences at step 504, at which the artificial intelligence agent system 408 receives a trigger from the agent command system 402. The trigger characterizes a target producer application, a credential operation type, and one or more operational parameters, and is communicated to the artificial intelligence agent system 408 through the trigger transduction 404. The trigger may originate from any of the trigger sources operably coupled to the agent command system 402, including a human resources platform, an identity governance and administration platform, an identity and access management platform, an enterprise ticketing platform, a command-line utility, a compliance audit trigger source, or a webhook callback. In one or more implementations, the trigger is generated internally by the multi-modal large language model 412 as a closed-loop trigger upon detection of a non-compliance condition during a prior execution of the method 500, and is routed through the trigger transduction 404 in the same manner as a trigger originating from an external trigger source.

At step 506, the multi-modal large language model 412 is applied to content rendered in the graphical user interface of the producer application 416. The computer vision component 410 captures an image of the rendered content and supplies the captured image, together with detected interface elements, to the multi-modal large language model 412. The rendered content may include a credential listing, a credential-displaying region, a generate new credential element, a revocation control, metadata fields, status indicators, or other graphical user interface content associated with credential lifecycle management.

At step 508, the multi-modal large language model 412 derives a plurality of API credential metadata attributes from the rendered content. The plurality of API credential metadata attributes is specific to an API credential displayed within the graphical user interface of the producer application 416 and may include a credential identifier, an issuing user, a creation timestamp, a scope, an issuer status, a last-used timestamp, an access type, and a status. The multi-modal large language model 412 derives the plurality of API credential metadata attributes by evaluating textual information rendered in the graphical user interface in combination with visual context supplied by the computer vision component 410.

At step 510, the artificial intelligence agent system 408 stores the plurality of API credential metadata attributes and at least one API credential in the centralized credential vault 424. The plurality of API credential metadata attributes is stored in association with the API credential to which the metadata attributes pertain, and the API credential is stored as an encrypted credential record 426. In one or more implementations, the at least one API credential stored at step 510 is an existing API credential previously issued by the producer application 416 and discovered through the multi-modal large language model 412 at step 506. The newly generated API credential captured at step 516 is stored in the centralized credential vault 424 as described below.

At step 512, the dependency mapping component 434 identifies a set of consumer applications associated with the API credential. The dependency mapping component 434 receives, as a query input, a credential identifier extracted from the plurality of API credential metadata attributes, and returns a set of consumer applications previously bound to the credential identifier through one or more of static inputs, dynamic inputs, administrative inputs, and discovery inputs. The set of consumer applications may include the first consumer application 436, the second consumer application 438, the Nth consumer application 440, or any other consumer application that authenticates to or otherwise consumes services of the producer application 416 using the API credential.

At step 514, a new API credential is generated at the producer application 416. The interface automation component 414 actuates a generate new credential element of the graphical user interface of the producer application 416 through a simulated graphical user interface interaction, and the producer application 416 generates the new API credential in response. In one or more implementations in which the producer application 416 exposes a programmatic credential management interface, the new API credential is generated through invocation of the programmatic credential management interface as an alternative to actuation of the generate new credential element.

At step 516, the artificial intelligence agent system 408 captures the new API credential from the transient display 418 of the producer application 416. The capture is performed during the ephemeral interval during which the transient display 418 renders a complete value of the new API credential. The computer vision component 410 captures an image of the transient display 418, the multi-modal large language model 412 extracts the complete value of the new API credential from the captured image, and the artificial intelligence agent system 408 stores the complete value in the centralized credential vault 424 as an encrypted credential record 426.

At step 518, the artificial intelligence agent system 408 stores an obfuscated representation 420 of the new API credential in the centralized credential vault 424. In one or more implementations, the obfuscated representation 420 is stored together with associated visual features as part of a visual fingerprint 430. The visual fingerprint 430 is associated with the encrypted credential record 426 of the new API credential and serves as a re-identification artifact through which the new API credential is subsequently located within the credential listing of the producer application 416.

At decision step 520, the method 500 determines whether a consumer application of the set of consumer applications identified at step 512 is to be processed for propagation and verification of the new API credential. When a consumer application is selected for processing, the artificial intelligence agent system 408 propagates the new API credential to the selected consumer application through one of a programmatic application programming interface call directed to the selected consumer application or a simulated graphical user interface interaction performed against a graphical user interface of the selected consumer application. In one or more implementations, propagation to multiple consumer applications of the set of consumer applications is performed concurrently rather than serially, where operational dependencies permit such concurrent propagation. When propagation cannot be performed for one or more consumer applications, or when the method 500 determines that the rotation transaction cannot proceed for the identified set of consumer applications, the method 500 proceeds to step 522 to initiate rollback at the producer application 416.

At step 526, the verification 442 confirms successful integration of the new API credential at the consumer application then under processing. The verification 442 is performed by issuing a test request to the consumer application using the new API credential and inspecting a response of the consumer application, by inspecting a rendered state of a graphical user interface of the consumer application through the computer vision component 410, or by reading a status indicator of the consumer application through a programmatic application programming interface exposed by the consumer application. The verification 442 emits a verification status 450 indicating whether the new API credential is successfully integrated at the consumer application.

At decision step 528, the method 500 evaluates whether the new API credential has been successfully integrated at every consumer application of the set of consumer applications. Where the verification status 450 indicates successful integration at every consumer application, the method 500 proceeds to step 530. Where the verification status 450 indicates that at least one consumer application remains unverified, the method 500 may return to the per-consumer processing and verification operations of steps 520 and 526. Where the verification status 450 indicates unsuccessful integration at one or more consumer applications and further verification or propagation is not successful, the method 500 may proceed to step 522 to initiate a stateful rollback transaction.

At step 522, the artificial intelligence agent system 408 initiates a rollback at the producer application 416 in response to a verification status 450 indicating unsuccessful integration of the new API credential at one or more consumer applications. The artificial intelligence agent system 408 retrieves a prior API credential from the encrypted credential records 426 of the centralized credential vault 424, propagates the prior API credential to each consumer application of the set of consumer applications previously updated with the new API credential, and actuates the revocation control 422 of the producer application 416 to revoke the new API credential.

At step 524, the artificial intelligence agent system 408 confirms the rollback by visual inspection of the credential listing rendered in the graphical user interface of the producer application 416 through the computer vision component 410. In confirming the rollback, the artificial intelligence agent system 408 may re-identify the prior API credential within the credential listing through a match against a visual fingerprint 430 previously stored in the centralized credential vault 424 for the prior API credential, and may confirm revocation or absence of the newly generated API credential using the visual fingerprint 430 associated with the newly generated API credential. In this manner, the artificial intelligence agent system 408 confirms that the producer application 416 has been returned to a credential state corresponding to the state preceding the attempted rotation transaction.

At step 530, the artificial intelligence agent system 408 actuates the revocation control 422 of the producer application 416 to revoke a prior API credential previously issued by the producer application 416. Revocation is performed through a simulated graphical user interface interaction executed by the interface automation component 414, in accordance with a revocation determination computed by the multi-modal large language model 412 upon receipt of a verification status 450 indicating successful integration of the new API credential at every consumer application of the set of consumer applications. In one or more implementations in which the producer application 416 exposes a programmatic credential management interface, revocation of the prior API credential is performed through invocation of the programmatic credential management interface.

At step 532, the dashboard interface 444 aggregates the plurality of credential metadata attributes 446 of the new API credential and a propagation status 448 characterizing the state of propagation of the new API credential to each consumer application of the set of consumer applications. The propagation status 448 is rendered in association with the API credential identifier and the consumer application identifier such that an enterprise governance user is enabled to evaluate, for each consumer application, whether propagation of the new API credential is completed, in-progress, failed, or pending.

At step 534, the dashboard interface 444 aggregates a verification status 450 of the new API credential at each consumer application of the set of consumer applications, and the artificial intelligence agent system 408 writes a tamper-evident audit record 432 to the centralized credential vault 424. The tamper-evident audit record 432 comprises a chronological log of credential operations performed during the method 500, in which each entry of the log is bound to a preceding entry through a cryptographic hash chain that detects modification or removal of any prior entry. Each entry of the log may comprise an operation identifier, an application identifier, a timestamp, an agent identifier, an API credential identifier, and a result status, and may be formatted in accordance with one or more of the Sarbanes-Oxley Act, the Health Insurance Portability and Accountability Act, the Payment Card Industry Data Security Standard, and the General Data Protection Regulation.

The method 500 terminates at end state 536. Upon termination following successful completion of the rotation transaction, the centralized credential vault 424 stores an encrypted credential record 426 of the new API credential, a visual fingerprint 430 of the new API credential, and a tamper-evident audit record 432 of the operations performed during the method 500. The dashboard interface 444 aggregates the plurality of credential metadata attributes 446, the propagation status 448, the verification status 450, and the event log 452 of the new API credential. The prior API credential previously issued by the producer application 416 is revoked at the producer application 416 and is no longer valid for authenticating requests to the producer application 416.

In one or more implementations, the operations of the method 500 are performed in an order other than the order in which the operations are presented herein, where data dependencies permit such alternative ordering. By way of example and not limitation, in some implementations, the dependency mapping component 434 identifies the set of consumer applications associated with the API credential at step 512 prior to or concurrently with derivation of the plurality of API credential metadata attributes at step 508, where the credential identifier is available to the dependency mapping component 434 from a prior execution of the method 500. In some implementations, the propagation of the new API credential to the set of consumer applications and the verification of the new API credential at the set of consumer applications are performed concurrently across multiple consumer applications. In some implementations, the writing of the tamper-evident audit record 432 at step 534 is performed continuously throughout the method 500 rather than as a terminal step.

### Discovery and Non-Compliance Evaluation Pipeline

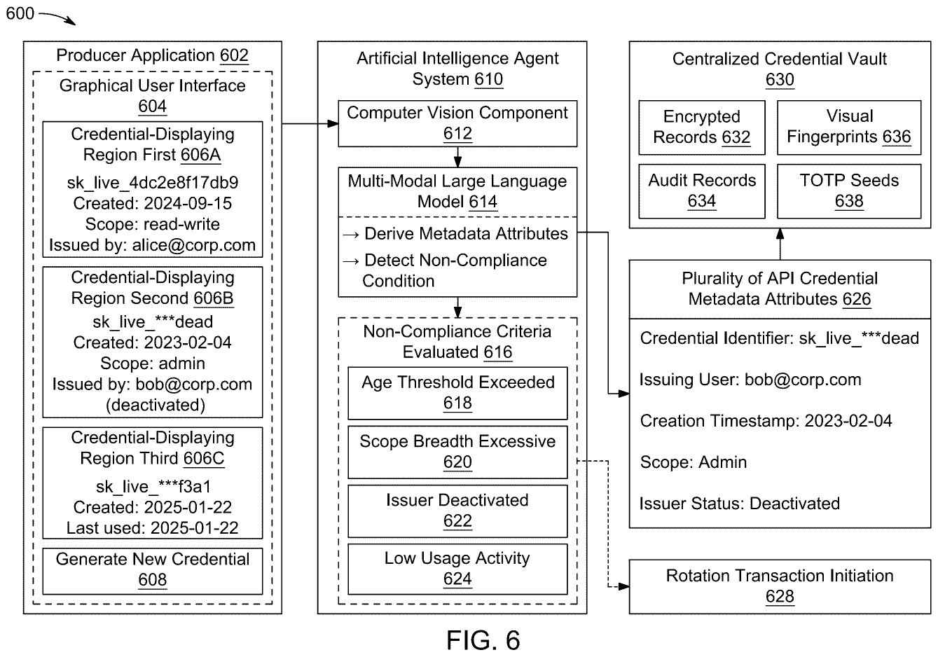

FIG. 6 illustrates a discovery and non-compliance evaluation pipeline 600 of the credential lifecycle system 400 of FIG. 4. The pipeline 600 is performed by the artificial intelligence agent system 610 with respect to a producer application 602 and constitutes the discovery phase of the credential lifecycle method 500 of FIG. 5. The pipeline 600 is configured to derive, from content rendered in a graphical user interface 604 of the producer application 602, a plurality of API credential metadata attributes 626 specific to one or more API credentials previously issued by the producer application 602, to evaluate the plurality of API credential metadata attributes 626 against non-compliance criteria evaluated 616, and, upon detection of a non-compliance condition, to initiate a rotation transaction 628 through a closed-loop trigger pathway.

The producer application 602 renders, on the graphical user interface 604, a credential listing comprising a plurality of credential-displaying regions, including a first credential-displaying region 606A, a second credential-displaying region 606B, and a third credential-displaying region 606C. Each credential-displaying region of the plurality of credential-displaying regions corresponds to an API credential previously issued by the producer application 602 and renders a credential value, a credential identifier, or an obfuscated representation of the API credential together with one or more rendered metadata fields associated with the API credential. By way of example and not limitation, the first credential-displaying region 606A renders an API credential value or identifier represented as sk_live_4dc2e8f17db9, a creation timestamp of 2024 Sep. 15, a scope of read-write, and an issuing user of alice@corp.com. The second credential-displaying region 606B renders an obfuscated representation of an API credential identified as sk_live_dead**, a creation timestamp of 2023 Feb. 4, a scope of admin, and an issuing user of bob@corp.com, with the issuing user or issuer status indicated as deactivated. The third credential-displaying region 606C renders an obfuscated representation of an API credential identified as sk_live_f3a1**, a creation timestamp of 2025 Jan. 22, and a last-used timestamp of 2025 Jan. 22. The graphical user interface 604 further renders a generate new credential element 608 through which a new API credential may be generated upon actuation.

The artificial intelligence agent system 610 is operably coupled to the producer application 602 and to a centralized credential vault 630. The artificial intelligence agent system 610 processes the content rendered in the graphical user interface 604 through a computer vision component 612 and a multi-modal large language model 614. The computer vision component 612 captures an image of the rendered content and detects, within the captured image, the first credential-displaying region 606A, the second credential-displaying region 606B, the third credential-displaying region 606C, and the generate new credential element 608. The multi-modal large language model 614 receives the captured image and the detected interface elements from the computer vision component 612 and derives therefrom the plurality of API credential metadata attributes 626. In the discovery and non-compliance evaluation pipeline 600, the artificial intelligence agent system 610 emphasizes perception and metadata evaluation, and actuation of the generate new credential element 608 may be performed during a subsequent rotation or generation phase.

The plurality of API credential metadata attributes 626 derived by the multi-modal large language model 614 comprises, for each API credential corresponding to a credential-displaying region of the plurality of credential-displaying regions 606A, 606B, 606C, one or more of a credential identifier, an issuing user, a creation timestamp, a scope, an issuer status, a last-used timestamp, an access type, and a status. By way of example and not limitation, the plurality of API credential metadata attributes 626 derived for the second credential-displaying region 606B comprises a credential identifier of sk_live_*dead**, an issuing user of bob@corp.com, a creation timestamp of 2023 Feb. 4, a scope of admin, and an issuer status of deactivated. The plurality of API credential metadata attributes 626 may further comprise a last-used timestamp, an access type, and a status, where the corresponding fields are rendered within a credential-displaying region or are inferable by the multi-modal large language model 614 from contextual content rendered adjacent to the credential-displaying region.

The multi-modal large language model 614 evaluates the plurality of API credential metadata attributes 626 against the non-compliance criteria evaluated 616. The non-compliance criteria evaluated 616 comprise an age threshold exceeded condition 618, a scope breadth excessive condition 620, an issuer deactivated condition 622, and a low usage activity condition 624. The age threshold exceeded condition 618 is evaluated by computing a difference between a current time value and the creation timestamp of the API credential and comparing the difference against an age threshold associated with the producer application 602 or with a credential category to which the API credential belongs. The scope breadth excessive condition 620 is evaluated by comparing the scope of the API credential against a scope policy associated with the producer application 602 or with the issuing user, and detecting whether the scope of the API credential exceeds a permitted scope under the scope policy. The issuer deactivated condition 622 is evaluated by determining whether the issuer status of the API credential is rendered as deactivated within the graphical user interface 604 or is otherwise inferable as deactivated from contextual content rendered adjacent to the credential-displaying region. The low usage activity condition 624 is evaluated by computing a difference between a current time value and the last-used timestamp of the API credential and comparing the difference against a usage activity threshold associated with the producer application 602 or with the credential category to which the API credential belongs.

Upon detection of a non-compliance condition for an API credential corresponding to one of the credential-displaying regions 606A, 606B, 606C, the artificial intelligence agent system 610 initiates the rotation transaction 628 in respect of the API credential. The rotation transaction 628 is initiated through a closed-loop trigger pathway in which the non-compliance condition computed from the plurality of API credential metadata attributes 626 by the multi-modal large language model 614 is routed to the trigger transduction 404 of FIG. 4 to commence a subsequent execution of the credential lifecycle method 500. In one or more implementations, the rotation transaction 628 is initiated without requiring an external scheduler, an external policy engine, or a human administrator queue. By way of example and not limitation, the rotation transaction 628 is initiated for the API credential corresponding to the second credential-displaying region 606B upon detection of the issuer deactivated condition 622, based on the issuer status indicating that bob@corp.com is deactivated.

The centralized credential vault 630 is operably coupled to the artificial intelligence agent system 610 and stores, in association with each API credential corresponding to a credential-displaying region of the plurality of credential-displaying regions 606A, 606B, 606C, the plurality of API credential metadata attributes 626 derived by the multi-modal large language model 614, encrypted records 632, audit records 634, visual fingerprints 636, and time-based one-time password seeds 638. The encrypted records 632 store complete or protected credential values in encrypted form. The audit records 634 store records of credential discovery, evaluation, non-compliance detection, and rotation initiation operations performed by the pipeline 600. The visual fingerprints 636 store obfuscated credential representations and associated visual features used by the artificial intelligence agent system 610 to re-identify API credentials within the graphical user interface 604 during subsequent interactions. The time-based one-time password seeds 638 store shared secrets usable for generating authentication codes when a credential lifecycle operation requires satisfaction of a multi-factor authentication challenge.

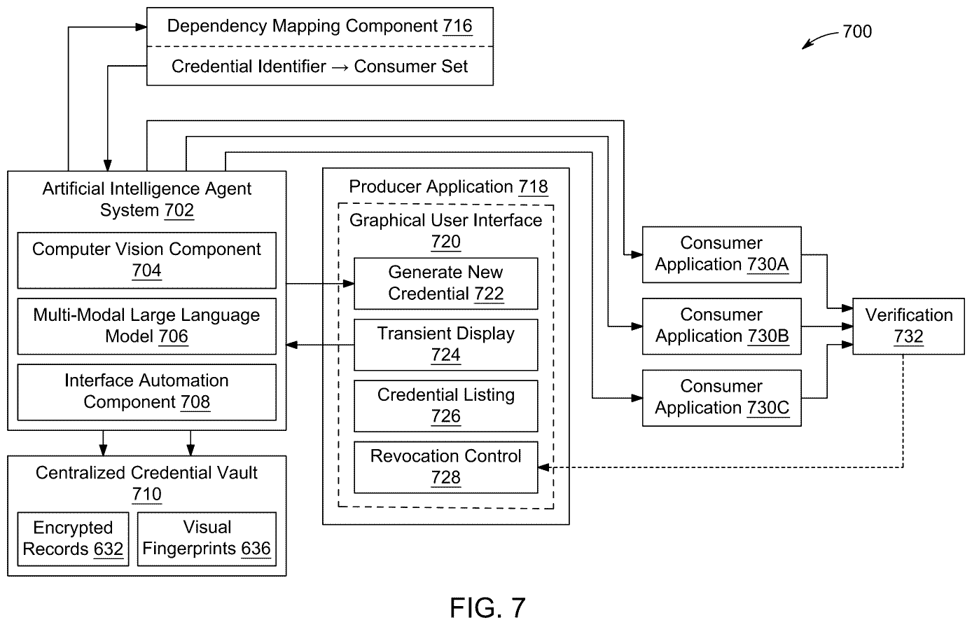

The plurality of API credential metadata attributes 626 stored in association with an API credential is accessible to the artificial intelligence agent system 610 during a subsequent execution of the credential lifecycle method 500 for evaluation of further non-compliance conditions, for re-identification of the API credential within the credential listing of the producer application 602, or for initiation of a rotation transaction involving the API credential. The output of the discovery and non-compliance evaluation pipeline 600 may be consumed by a generation phase of the credential lifecycle method 500, in which the artificial intelligence agent system 610 actuates the generate new credential element 608 of the producer application 602 to commence generation of a new API credential. The generation phase is described in further detail with reference to FIG. 7.

### Generation, Propagation, and Verification Pipeline

FIG. 7 illustrates a generation, propagation, and verification pipeline 700 of the credential lifecycle system 400 of FIG. 4. The pipeline 700 is performed by an artificial intelligence agent system 702 with respect to a producer application 718 and a plurality of consumer applications, including a first consumer application 730A, a second consumer application 730B, and a third consumer application 730C. The pipeline 700 constitutes the generation phase, the propagation phase, and the verification phase of the credential lifecycle method 500 of FIG. 5. The pipeline 700 is configured to generate a new API credential at the producer application 718 through actuation of a graphical user interface 720 of the producer application 718, to capture the new API credential from a transient display 724 rendered in the graphical user interface 720, to store the new API credential in a centralized credential vault 710, to identify a set of consumer applications associated with a credential identifier through a dependency mapping component 716, to propagate the new API credential to each consumer application of the set of consumer applications, and to verify successful integration of the new API credential at each consumer application through a verification 732.

The artificial intelligence agent system 702 is operably coupled to the producer application 718, the centralized credential vault 710, the dependency mapping component 716, and the plurality of consumer applications 730A, 730B, 730C. The artificial intelligence agent system 702 comprises a computer vision component 704, a multi-modal large language model 706, and an interface automation component 708. The computer vision component 704 is configured to perceive rendered content of the graphical user interface 720. The multi-modal large language model 706 is configured to interpret the rendered content, identify credential-generation and credential-displaying interface elements, and generate instructions for credential lifecycle operations. The interface automation component 708 is configured to execute simulated graphical user interface interactions in accordance with instructions generated by the multi-modal large language model 706. In one or more implementations, the multi-modal large language model 706 is the same model instance as, or a corresponding model instance configured consistently with, the multi-modal large language model applied during the discovery phase described with reference to FIG. 6, such that credential-displaying region classification, metadata derivation, credential-generation element identification, and credential capture are performed using a consistent multi-modal interpretation framework.

The producer application 718 renders, on the graphical user interface 720, a generate new credential element 722, the transient display 724, a credential listing 726, and a revocation control 728. The generate new credential element 722 is an interactive element of the graphical user interface 720 by which a new API credential is generated at the producer application 718 upon actuation. The transient display 724 is a portion of the graphical user interface 720 that renders a complete value of the new API credential for an ephemeral interval following actuation of the generate new credential element 722, after which the transient display 724 ceases to render the complete value of the new API credential. The credential listing 726 renders one or more obfuscated representations of API credentials previously issued by the producer application 718 and may be updated following generation of the new API credential to render an obfuscated representation of the new API credential. The revocation control 728 is an interactive element of the graphical user interface 720 by which an API credential previously issued by the producer application 718 may be revoked upon actuation.

The artificial intelligence agent system 702 generates the new API credential at the producer application 718 by actuating the generate new credential element 722 through the interface automation component 708. The computer vision component 704 captures rendered content of the graphical user interface 720, and the multi-modal large language model 706 identifies, from the rendered content, an interface element corresponding to the generate new credential element 722. The multi-modal large language model 706 then generates an actuation instruction for the interface automation component 708. In response to the actuation instruction, the interface automation component 708 actuates the generate new credential element 722, and the producer application 718 generates the new API credential and renders a complete value of the new API credential within the transient display 724 for the ephemeral interval.

The artificial intelligence agent system 702 captures the new API credential from the transient display 724 during the ephemeral interval. The computer vision component 704 captures an image or other visual representation of the transient display 724, and the multi-modal large language model 706 extracts the complete value of the new API credential from the captured visual representation. The artificial intelligence agent system 702 stores the complete value of the new API credential in the centralized credential vault 710 as one of the encrypted records 632. The artificial intelligence agent system 702 also stores an obfuscated representation of the new API credential, together with associated visual features of the credential as rendered in the graphical user interface 720, as one of the visual fingerprints 636 in association with the corresponding encrypted record 632. The visual fingerprints 636 enable subsequent re-identification of the new API credential within the credential listing 726 of the producer application 718 during a propagation verification operation, rollback operation, or revocation operation.

The dependency mapping component 716 maintains a mapping between credential identifiers and corresponding sets of consumer applications. The dependency mapping component 716 is configured to receive a credential identifier associated with an API credential being rotated or replaced, and to return a consumer set corresponding to the credential identifier. In one or more implementations, the credential identifier used to query the dependency mapping component 716 corresponds to a prior API credential previously issued by the producer application 718, a credential class associated with the producer application 718, or metadata derived during the discovery phase of the credential lifecycle method 500. The dependency mapping component 716 returns the set of consumer applications associated with the credential identifier, including the first consumer application 730A, the second consumer application 730B, and the third consumer application 730C. After propagation of the new API credential, the dependency mapping component 716 may update the mapping to associate the new API credential with the same consumer set.

The artificial intelligence agent system 702 propagates the new API credential to each consumer application of the set of consumer applications 730A, 730B, 730C. Propagation to a given consumer application is performed through one of a programmatic application programming interface call directed to the given consumer application or a simulated graphical user interface interaction performed by the artificial intelligence agent system 702 against a graphical user interface of the given consumer application. Where the given consumer application exposes a programmatic credential ingestion interface, propagation is performed through invocation of the programmatic credential ingestion interface with the new API credential as a parameter. Where the given consumer application does not expose a programmatic credential ingestion interface, propagation is performed through actuation, by the interface automation component 708, of one or more interface elements of the graphical user interface of the given consumer application, including, by way of example and not limitation, a settings navigation element, a credential configuration field, and a save or apply control. In one or more implementations, the artificial intelligence agent system 702 determines whether to use a programmatic application programming interface call or a simulated graphical user interface interaction based on configuration information maintained by the dependency mapping component 716, rendered content of the graphical user interface of the given consumer application, or both.

The verification 732 confirms successful integration of the new API credential at each consumer application of the set of consumer applications 730A, 730B, 730C. The verification 732 is performed for each consumer application by issuing a test request to the consumer application using the new API credential and inspecting a response of the consumer application, by inspecting a rendered state of a graphical user interface of the consumer application through the computer vision component 704, or by reading a status indicator of the consumer application through a programmatic application programming interface exposed by the consumer application. The verification 732 generates a verification result for each consumer application, the verification result indicating whether the new API credential has been successfully integrated at the corresponding consumer application.

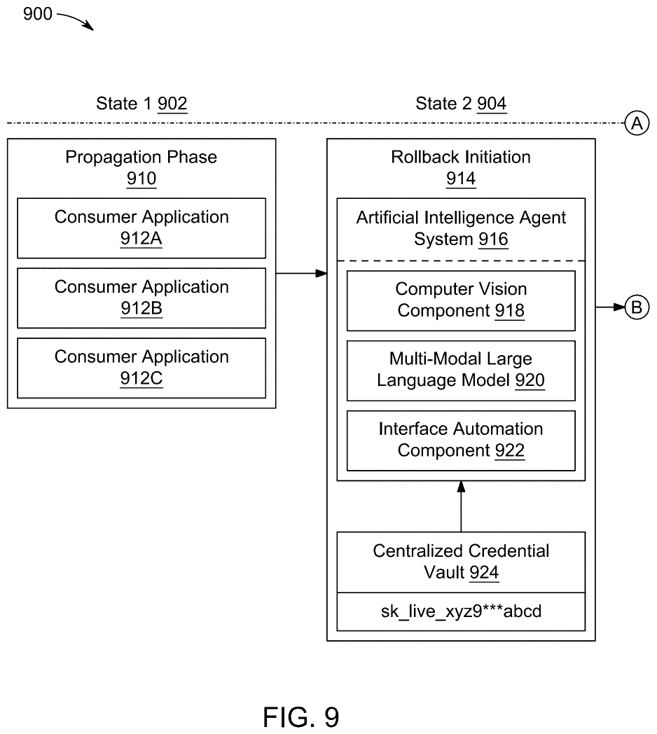

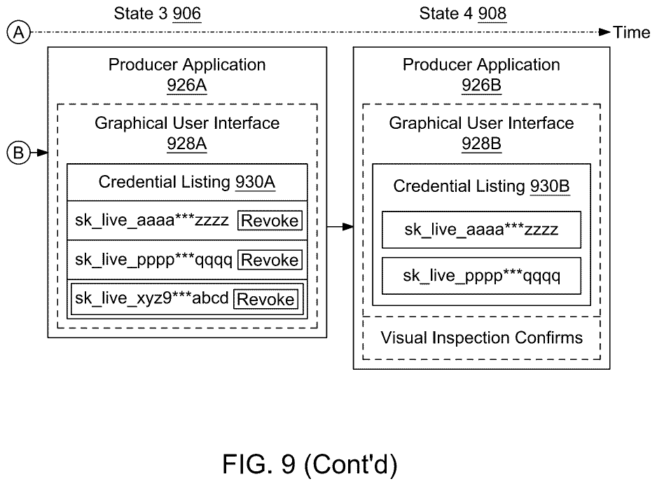

Upon receipt of verification results indicating successful integration of the new API credential at every consumer application of the set of consumer applications 730A, 730B, 730C, the artificial intelligence agent system 702 actuates the revocation control 728 of the producer application 718 to revoke a prior API credential previously issued by the producer application 718, thereby completing the rotation transaction. In one or more implementations, the artificial intelligence agent system 702 re-identifies the prior API credential within the credential listing 726 using one or more of the visual fingerprints 636 before actuating the revocation control 728. Upon receipt of a verification result indicating unsuccessful integration of the new API credential at one or more consumer applications of the set of consumer applications 730A, 730B, 730C, the artificial intelligence agent system 702 initiates a stateful rollback transaction. During the stateful rollback transaction, the artificial intelligence agent system 702 retrieves the prior API credential from the encrypted records 632 of the centralized credential vault 710, propagates the prior API credential back to each consumer application previously updated with the new API credential, and actuates the revocation control 728 of the producer application 718 to revoke the new API credential. The stateful rollback transaction is described in further operative detail with reference to FIG. 9.

### Four-State Ephemeral Capture Sequence

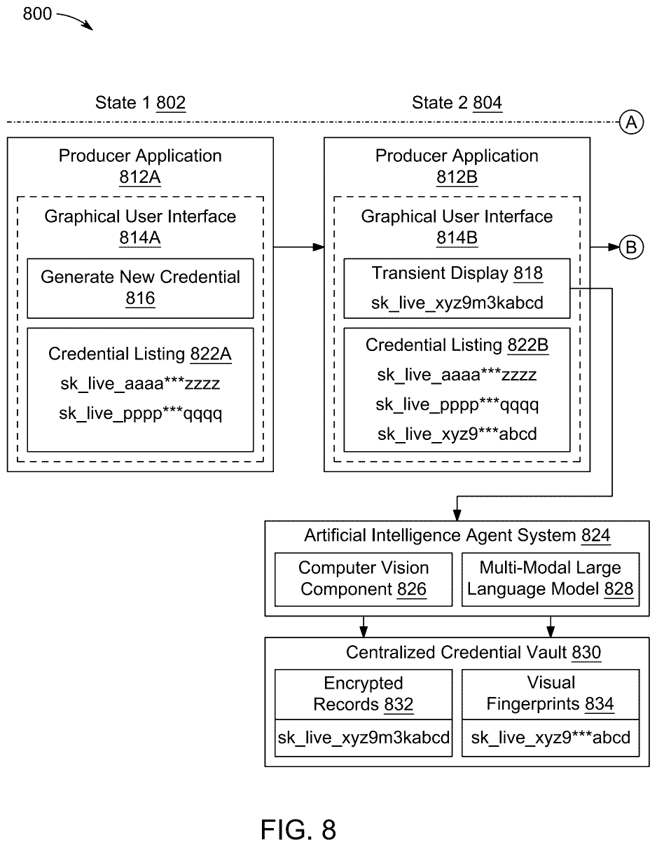

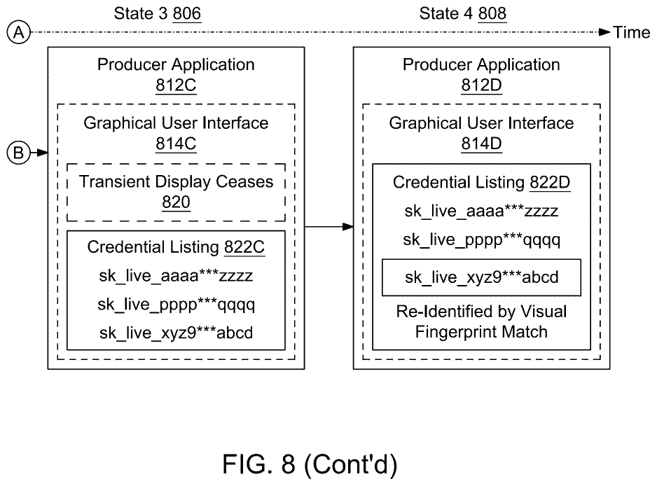

FIG. 8 illustrates a four-state ephemeral capture sequence 800 of the credential lifecycle system 400. The four-state ephemeral capture sequence 800 depicts a temporal progression of states of a producer application during a generation transaction, including a first state 802, a second state 804, a third state 806, and a fourth state 808. The four-state ephemeral capture sequence 800 is configured to enable an artificial intelligence agent system 824 to capture a complete value of a newly generated API credential from a transient display rendered for an ephemeral interval, to store the complete value in encrypted records 832 of a centralized credential vault 830, to store an obfuscated representation of the newly generated API credential as one of visual fingerprints 834, and to re-identify the newly generated API credential within a credential listing of the producer application during a subsequent operation.

The producer application 812A, the producer application 812B, the producer application 812C, and the producer application 812D represent temporally distinct states of the same producer application during the four-state ephemeral capture sequence 800. Similarly, the graphical user interfaces 814A, 814B, 814C, 814D represent temporally distinct rendered states of the graphical user interface of the producer application, and the credential listings 822A, 822B, 822C, 822D represent temporally distinct states of a credential listing rendered by the producer application.

In the first state 802, the producer application 812A renders, on a graphical user interface 814A, a credential listing 822A and a generate new credential element 816. The credential listing 822A renders one or more obfuscated representations of API credentials previously issued by the producer application 812A, including, by way of example and not limitation, the obfuscated representation sk_live_aaaazzzz** and the obfuscated representation sk_live_ppppqqqq**. The generate new credential element 816 is an interactive element of the graphical user interface 814A through which a new API credential is generated at the producer application 812A upon actuation. In the first state 802, the generate new credential element 816 is rendered but has not yet been actuated, and the newly generated API credential has not yet been generated.

The transition from the first state 802 to the second state 804 occurs when the artificial intelligence agent system 824 actuates the generate new credential element 816. In one or more implementations, the artificial intelligence agent system 824 actuates the generate new credential element 816 in accordance with an actuation instruction generated by a multi-modal large language model 828 from rendered content of the graphical user interface 814A. Upon actuation of the generate new credential element 816, the producer application generates the new API credential.

In the second state 804, the producer application 812B renders, on a graphical user interface 814B, a transient display 818 and a credential listing 822B. The transient display 818 renders a complete value of the newly generated API credential in unobfuscated form for an ephemeral interval. By way of example and not limitation, the complete value rendered within the transient display 818 in the second state 804 is sk_live_xyz9m3kabcd. The credential listing 822B is updated to render an obfuscated representation of the newly generated API credential alongside the obfuscated representations of the API credentials previously issued by the producer application 812B. The obfuscated representations rendered within the credential listing 822B comprise sk_live_aaaazzzz**, sk_live_ppppqqqq**, and sk_live_xyz9*abcd**.

During the ephemeral interval of the second state 804, the artificial intelligence agent system 824 captures the complete value of the newly generated API credential from the transient display 818. A computer vision component 826 captures an image or other visual representation of the graphical user interface 814B, including the transient display 818, and the multi-modal large language model 828 extracts the complete value of the newly generated API credential from the captured visual representation by identifying the transient display 818 and reading the complete credential string rendered therein. The artificial intelligence agent system 824 stores the extracted complete value in the centralized credential vault 830 as one of the encrypted records 832. The artificial intelligence agent system 824 further stores the obfuscated representation of the newly generated API credential, together with associated visual features, as one of the visual fingerprints 834 in association with the corresponding encrypted record of the encrypted records 832. By way of example and not limitation, the encrypted records 832 store the complete value sk_live_xyz9m3kabcd in encrypted form, and the visual fingerprints 834 store the obfuscated representation sk_live_xyz9*abcd**.

The transition from the second state 804 to the third state 806 occurs upon expiration of the ephemeral interval. Upon expiration of the ephemeral interval, the producer application 812C no longer renders the complete value of the newly generated API credential within the transient display 818. The transient display ceases 820 identifies cessation of rendering of the complete value of the newly generated API credential.

In the third state 806, the producer application 812C renders, on a graphical user interface 814C, a credential listing 822C after the transient display 818 has ceased rendering the complete credential value. The credential listing 822C renders obfuscated representations of the API credentials previously issued by the producer application 812C together with the obfuscated representation of the newly generated API credential. The obfuscated representations rendered within the credential listing 822C comprise sk_live_aaaazzzz**, sk_live_ppppqqqq**, and sk_live_xyz9*abcd**. The complete value of the newly generated API credential is no longer rendered within the graphical user interface 814C, and the artificial intelligence agent system 824 may retrieve the complete value from the encrypted records 832 stored in the centralized credential vault 830 during the second state 804.

In the fourth state 808, the artificial intelligence agent system 824 re-identifies the newly generated API credential within a credential listing 822D rendered on a graphical user interface 814D of the producer application 812D during a subsequent operation. The subsequent operation may comprise a propagation verification operation, a rollback operation, a revocation operation, or a subsequent discovery operation. To re-identify the newly generated API credential, the computer vision component 826 captures an image or other visual representation of the graphical user interface 814D, including the credential listing 822D, and the multi-modal large language model 828 reads the obfuscated representations rendered within the credential listing 822D and compares the rendered obfuscated representations against the visual fingerprints 834 stored in the centralized credential vault 830. The newly generated API credential is re-identified upon a match between an obfuscated representation rendered within the credential listing 822D and a corresponding visual fingerprint of the visual fingerprints 834. By way of example and not limitation, in the fourth state 808, the obfuscated representation sk_live_xyz9*abcd** rendered within the credential listing 822D is matched against the corresponding visual fingerprint of the visual fingerprints 834, thereby re-identifying the newly generated API credential within the credential listing 822D for performance of a subsequent credential lifecycle operation.

The four-state ephemeral capture sequence 800 enables the credential lifecycle system 400 to operate with producer applications that render newly generated API credentials in complete form for an ephemeral interval and thereafter render obfuscated representations within a credential listing. The complete value of the newly generated API credential is captured during the ephemeral interval and persisted in the centralized credential vault 830 in encrypted form, and the obfuscated representation is persisted as one of the visual fingerprints 834 to enable re-identification of the newly generated API credential during a subsequent operation even when the complete value of the newly generated API credential is no longer rendered within the graphical user interface of the producer application.

### Four-State Stateful Rollback Sequence

FIG. 9 illustrates a four-state stateful rollback sequence 900 of the credential lifecycle system 400. The four-state stateful rollback sequence 900 depicts a temporal progression through which an artificial intelligence agent system 916 reverts a credential rotation transaction upon receipt of a verification status indicating unsuccessful integration of a new API credential at one or more consumer applications of a set of consumer applications. The four-state stateful rollback sequence 900 comprises a first state 902 corresponding to a propagation phase 910, a second state 904 corresponding to a rollback initiation 914, a third state 906 corresponding to actuation of a revocation control at a producer application 926A, and a fourth state 908 corresponding to visual confirmation of the rollback at a producer application 926B.

The producer application 926A and the producer application 926B represent temporally distinct states of the same producer application during the four-state stateful rollback sequence 900. Similarly, the graphical user interfaces 928A and 928B represent temporally distinct rendered states of the graphical user interface of the producer application, and the credential listings 930A and 930B represent temporally distinct states of a credential listing rendered by the producer application. In one or more implementations, the producer-side revocation and confirmation operations of the four-state stateful rollback sequence 900 are performed through simulated graphical user interface interactions without requiring invocation of a programmatic credential management interface of the producer application.

In the first state 902, a new API credential previously generated at a producer application is propagated to a plurality of consumer applications during the propagation phase 910. The plurality of consumer applications comprises a first consumer application 912A, a second consumer application 912B, and a third consumer application 912C. Each consumer application of the plurality of consumer applications authenticates to or otherwise consumes services of the producer application using an API credential issued by the producer application. The artificial intelligence agent system 916 propagates the new API credential to the first consumer application 912A, the second consumer application 912B, and the third consumer application 912C through one of a programmatic application programming interface call directed to the consumer application or a simulated graphical user interface interaction performed against a graphical user interface of the consumer application. Upon completion of propagation, a verification operation is performed for each consumer application of the plurality of consumer applications, and a verification status is emitted in respect of each consumer application. The verification status indicates whether the new API credential is successfully integrated at the corresponding consumer application.

Upon receipt of a verification status indicating unsuccessful integration of the new API credential at one or more consumer applications of the plurality of consumer applications 912A, 912B, 912C, the four-state stateful rollback sequence 900 proceeds to the second state 904.

In the second state 904, the artificial intelligence agent system 916 commences the rollback initiation 914. The artificial intelligence agent system 916 comprises the computer vision component 918, the multi-modal large language model 920, and the interface automation component 922. The artificial intelligence agent system 916 accesses rollback information from the centralized credential vault 924. The rollback information may include a prior API credential that was previously issued by the producer application and superseded by the new API credential during the attempted rotation transaction, and may further include an obfuscated representation or visual fingerprint of the new API credential subject to rollback. By way of example and not limitation, the centralized credential vault 924 stores rollback information associated with the obfuscated representation sk_live_xyz9*abcd**, which corresponds to the new API credential to be revoked during the rollback sequence.

The artificial intelligence agent system 916 propagates the prior API credential to each consumer application of the plurality of consumer applications 912A, 912B, 912C previously updated with the new API credential. In this manner, the consumer applications are returned to a credential state corresponding to the credential state preceding the attempted rotation transaction. Propagation of the prior API credential may be performed through a programmatic application programming interface call, a simulated graphical user interface interaction, or a combination thereof, depending on the credential ingestion capabilities of each consumer application.

Upon completion of propagation of the prior API credential to the plurality of consumer applications, the four-state stateful rollback sequence 900 proceeds to the third state 906.

In the third state 906, the producer application 926A renders, on a graphical user interface 928A, a credential listing 930A. The credential listing 930A renders obfuscated representations of API credentials issued by the producer application 926A, including the new API credential subject to rollback. By way of example and not limitation, the obfuscated representations rendered within the credential listing 930A comprise sk_live_aaaazzzz** sk_live_ppppqqqq**, and sk_live_xyz9*abcd**. Each obfuscated representation rendered within the credential listing 930A is associated with a revocation control rendered within the credential listing 930A. The revocation control is an interactive element through which the corresponding API credential is revoked at the producer application 926A upon actuation.

The artificial intelligence agent system 916 identifies the obfuscated representation corresponding to the new API credential subject to rollback within the credential listing 930A. The computer vision component 918 captures rendered content of the graphical user interface 928A, and the multi-modal large language model 920 compares the rendered obfuscated representations against rollback information stored in the centralized credential vault 924. Upon identifying the obfuscated representation corresponding to the new API credential subject to rollback, the interface automation component 922 actuates the revocation control associated with the identified obfuscated representation. By way of example and not limitation, in the third state 906, the artificial intelligence agent system 916 actuates the revocation control associated with sk_live_xyz9*abcd** to revoke the new API credential at the producer application 926A.

Upon completion of revocation of the new API credential at the producer application 926A, the four-state stateful rollback sequence 900 proceeds to the fourth state 908.

In the fourth state 908, the producer application 926B renders, on a graphical user interface 928B, a credential listing 930B. The credential listing 930B renders obfuscated representations of API credentials that remain active or listed at the producer application 926B after revocation of the new API credential subject to rollback. By way of example and not limitation, the obfuscated representations rendered within the credential listing 930B comprise sk_live_aaaazzzz** and sk_live_ppppqqqq**. The obfuscated representation sk_live_xyz9*abcd** of the new API credential subject to rollback is no longer rendered within the credential listing 930B, indicating that the revocation actuated in the third state 906 has been processed by the producer application 926B.

The artificial intelligence agent system 916 visually confirms the rollback by inspecting the credential listing 930B in the fourth state 908. The computer vision component 918 captures rendered content of the graphical user interface 928B, including the credential listing 930B, and the multi-modal large language model 920 reads the obfuscated representations rendered within the credential listing 930B. The multi-modal large language model 920 compares the rendered obfuscated representations against the rollback information stored in the centralized credential vault 924. Upon determining that the obfuscated representation of the new API credential subject to rollback is absent from the credential listing 930B, the artificial intelligence agent system 916 confirms that the producer-side revocation portion of the rollback has been completed. In one or more implementations, the artificial intelligence agent system 916 writes a tamper-evident audit record of the rollback transaction to the centralized credential vault 924. Where the obfuscated representation of the new API credential remains rendered within the credential listing 930B, the artificial intelligence agent system 916 may re-actuate the corresponding revocation control through the interface automation component 922 and repeat the visual confirmation operation.

The four-state stateful rollback sequence 900 enables the credential lifecycle system 400 to revert a failed credential rotation transaction. The retrieval of the prior API credential from the centralized credential vault 924 and propagation of the prior API credential back to the plurality of consumer applications 912A, 912B, 912C restores the consumer applications to a credential state corresponding to the state preceding the attempted rotation transaction. The actuation of the revocation control at the producer application 926A and visual confirmation using the credential listing 930B restore the producer application to a credential state in which the new API credential subject to rollback is no longer active or listed. In one or more implementations, the four-state stateful rollback sequence 900 is performed by the artificial intelligence agent system 916 in response to a verification status indicating unsuccessful integration of the new API credential at one or more consumer applications, without requiring intervention by a human administrator.

### Synthesized Programmatic Interface Generation Pipeline

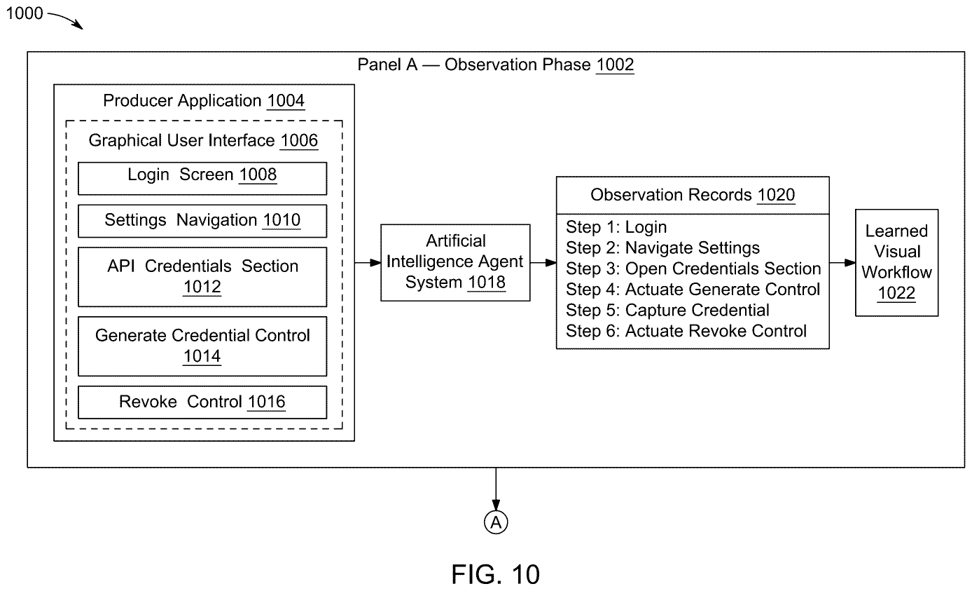

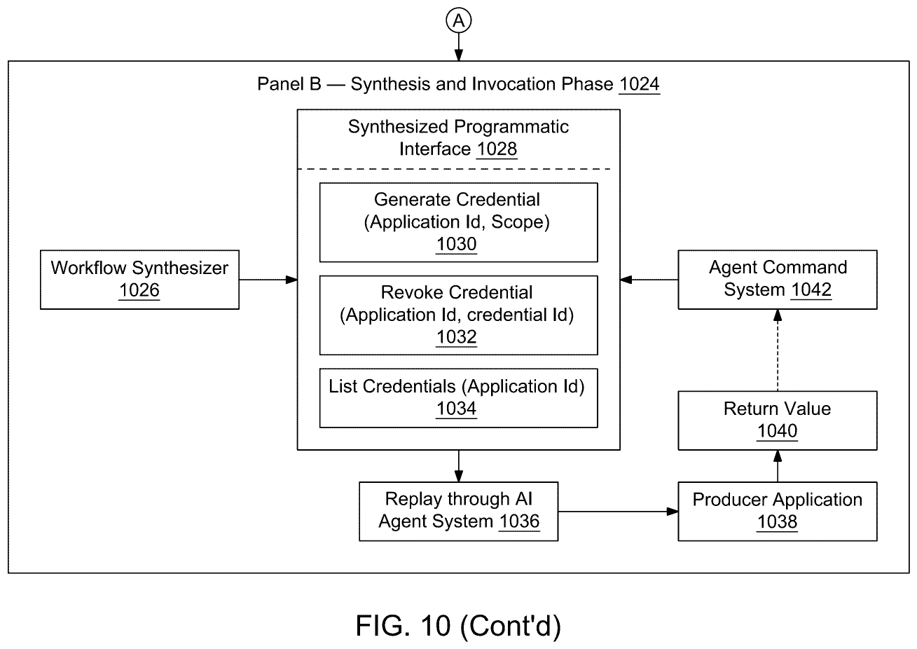

FIG. 10 illustrates a synthesized programmatic interface generation pipeline 1000 of the credential lifecycle system 400. The synthesized programmatic interface generation pipeline 1000 is configured to construct, from observation of a sequence of graphical user interface interactions performed at a producer application that does not natively expose a programmatic credential management interface, a synthesized programmatic interface 1028 comprising one or more callable programmatic methods for credential management. Upon invocation of a callable programmatic method by an agent command system 1042, the synthesized programmatic interface 1028 causes a corresponding sequence of graphical user interface interactions to be replayed through an artificial intelligence agent system against the producer application. The synthesized programmatic interface generation pipeline 1000 comprises an observation phase 1002 and a synthesis and invocation phase 1024.

In the observation phase 1002, a producer application 1004 renders, on a graphical user interface 1006, a plurality of interface elements through which an API credential is generated, listed, or revoked at the producer application 1004. The plurality of interface elements comprises a login screen 1008 through which an authenticated session is established at the producer application 1004, a settings navigation 1010 through which a settings view of the producer application 1004 is reached, an API credentials section 1012 through which API credentials previously issued by the producer application 1004 are listed or managed, a generate credential control 1014 through which a new API credential is generated at the producer application 1004 upon actuation, and a revoke control 1016 through which an API credential previously issued by the producer application 1004 is revoked upon actuation.

The artificial intelligence agent system 1018 observes a sequence of graphical user interface interactions performed at the producer application 1004 through the plurality of interface elements (1008, 1010, 1012, 1014, 1016), and records the observed interactions as observation records 1020. The sequence of graphical user interface interactions may comprise, by way of example and not limitation, a step 1 of logging in through the login screen 1008, a step 2 of navigating through the settings navigation 1010, a step 3 of opening the API credentials section 1012, a step 4 of actuating the generate credential control 1014, a step 5 of capturing a newly generated API credential rendered within the graphical user interface 1006 following actuation of the generate credential control 1014, and a step 6 of actuating the revoke control 1016. Each step of the sequence is recorded within the observation records 1020 in association with one or more interface elements of the plurality of interface elements (1008, 1010, 1012, 1014, 1016) and one or more actuation parameters of the corresponding graphical user interface interaction.

The artificial intelligence agent system 1018 derives a learned visual workflow 1022 from the observation records 1020. The learned visual workflow 1022 is a structured representation of the sequence of graphical user interface interactions. In the learned visual workflow 1022, each step of the sequence is associated with at least one visual locator of a corresponding interface element and with an actuation procedure executable by the artificial intelligence agent system 1018. The visual locator may comprise a bounding-box coordinate, a textual label, a structural identifier extracted from a document object model of the graphical user interface 1006, a relative position of an interface element, a visual appearance signature of an interface element, or a combination thereof. The actuation procedure may comprise a mouse event simulation, a keyboard event simulation, a form-field population, a copy-paste primitive, a navigation command, a credential capture operation, or a combination thereof.

In the synthesis and invocation phase 1024, a workflow synthesizer 1026 receives the learned visual workflow 1022 and constructs the synthesized programmatic interface 1028. The synthesized programmatic interface 1028 comprises one or more callable programmatic methods, including a generate credential method 1030, a revoke credential method 1032, and a list credentials method 1034. The generate credential method 1030 receives an application identifier and a scope as parameters and returns a newly generated API credential, metadata associated with the newly generated API credential, or both. The revoke credential method 1032 receives an application identifier and a credential identifier as parameters and returns a revocation status. The list credentials method 1034 receives an application identifier as a parameter and returns a list of API credentials associated with the producer application identified by the application identifier, metadata associated with the listed API credentials, or both.

Each callable programmatic method of the synthesized programmatic interface 1028 is bound to a corresponding subsequence of the learned visual workflow 1022. The corresponding subsequence comprises those steps of the observed graphical user interface interaction sequence that perform the credential management operation represented by the callable programmatic method. For example, the generate credential method 1030 may be bound to a subsequence including navigation to the API credentials section 1012, actuation of the generate credential control 1014, and capture of the newly generated API credential. The revoke credential method 1032 may be bound to a subsequence including navigation to the API credentials section 1012, identification of a credential corresponding to a credential identifier, and actuation of the revoke control 1016. The list credentials method 1034 may be bound to a subsequence including navigation to the API credentials section 1012 and extraction of credential identifiers or credential metadata rendered therein.

The agent command system 1042 invokes a callable programmatic method of the synthesized programmatic interface 1028 with one or more parameters. Upon invocation, the synthesized programmatic interface 1028 translates the invocation into the corresponding subsequence of the learned visual workflow 1022 and initiates a replay through AI agent system 1036. During the replay through AI agent system 1036, the artificial intelligence agent system performs the corresponding subsequence of graphical user interface interactions against a producer application 1038. In one or more implementations, the producer application 1038 represents the same producer application as the producer application 1004, but during an invocation phase rather than during the observation phase 1002. In other implementations, the producer application 1038 represents another producer application having a corresponding learned visual workflow and a corresponding synthesized programmatic interface.

During the replay through AI agent system 1036, the artificial intelligence agent system actuates interface elements of the producer application 1038 according to the learned visual workflow 1022 and the parameters supplied by the agent command system 1042. Where the callable programmatic method requires generation of a new API credential, the replay through AI agent system 1036 causes actuation of a credential generation control and capture of a resulting credential value or credential metadata. Where the callable programmatic method requires revocation of an API credential, the replay through AI agent system 1036 causes identification of the credential corresponding to the supplied credential identifier and actuation of a corresponding revocation control. Where the callable programmatic method requires listing of credentials, the replay through AI agent system 1036 causes navigation to a credential listing view and extraction of credential identifiers, obfuscated credential representations, or associated metadata.

Upon completion of the replay through AI agent system 1036, the artificial intelligence agent system captures a result produced by the producer application 1038 in response to the replayed subsequence of graphical user interface interactions. The result may comprise a newly generated API credential, a revocation status, a list of API credentials, a plurality of API credential metadata attributes, an error message, a completion status, or a combination thereof. The result is communicated as a return value 1040 to the synthesized programmatic interface 1028, and the synthesized programmatic interface 1028 provides the return value 1040 to the agent command system 1042 as the return value of the callable programmatic method invoked by the agent command system 1042.

The synthesized programmatic interface generation pipeline 1000 enables the credential lifecycle system 400 to expose a programmatic credential management surface for a producer application that does not natively expose a programmatic credential management interface. The agent command system 1042 can therefore invoke credential management operations through the synthesized programmatic interface 1028, while the underlying operation is executed by replaying learned graphical user interface interactions through the artificial intelligence agent system. In this manner, the credential lifecycle system 400 provides a uniform invocation mechanism for credential generation, credential revocation, and credential listing operations across producer applications having different graphical user interface structures.

In one or more implementations, the synthesized programmatic interface 1028 may be exposed as a representational state transfer interface, a remote procedure call interface, a software development kit interface, a command-line callable interface, or a combination thereof. In one or more implementations, different producer applications are associated with different learned visual workflows and corresponding synthesized programmatic interfaces of the type represented by the synthesized programmatic interface 1028. The synthesized programmatic interface 1028 thereby permits the agent command system 1042 to invoke credential lifecycle operations using a consistent programmatic form while preserving the ability of the artificial intelligence agent system to interact with the rendered graphical user interface of each producer application.

### Multi-Factor Authentication Handling Pipeline

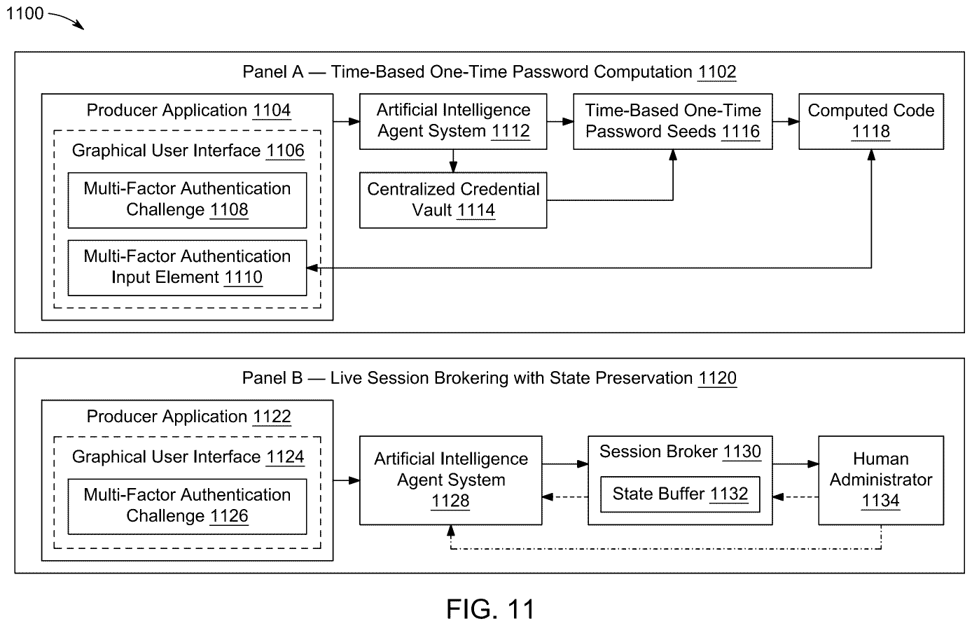

FIG. 11 illustrates a multi-factor authentication handling pipeline 1100 of the credential lifecycle system 400. The multi-factor authentication handling pipeline 1100 is configured to handle a multi-factor authentication challenge presented by a producer application during a credential lifecycle operation. The multi-factor authentication challenge requires a second authentication factor before the credential lifecycle operation may continue at the producer application. The multi-factor authentication handling pipeline 1100 comprises a time-based one-time password computation pathway 1102 and a live session brokering with state preservation pathway 1120. Each pathway is operable to satisfy, complete, or facilitate satisfaction of a multi-factor authentication challenge according to the type of second authentication factor required and according to authentication information available to the credential lifecycle system 400.

In the time-based one-time password computation pathway 1102, a producer application 1104 renders, on a graphical user interface 1106, a multi-factor authentication challenge 1108 that includes a multi-factor authentication input element 1110. The multi-factor authentication challenge 1108 is rendered during a credential lifecycle operation after a primary authentication operation has been completed or after the producer application 1104 otherwise requires additional authentication. The multi-factor authentication input element 1110 is an interactive element of the graphical user interface 1106 through which a time-based one-time password is entered. The multi-factor authentication input element 1110 may comprise a text input field, a numeric input field, a code entry interface, or an analogous graphical user interface element.

An artificial intelligence agent system 1112 is operably coupled to a centralized credential vault 1114. The centralized credential vault 1114 stores time-based one-time password seeds 1116 in association with one or more producer applications, user accounts, service accounts, administrative accounts, or credential lifecycle sessions. The artificial intelligence agent system 1112 retrieves, from the time-based one-time password seeds 1116, a time-based one-time password seed associated with the producer application 1104 or with an account used by the artificial intelligence agent system 1112 to access the producer application 1104.

The artificial intelligence agent system 1112 computes a computed code 1118 from the retrieved time-based one-time password seed and a current time value according to a time-based one-time password algorithm. In one or more implementations, the time-based one-time password algorithm generates the computed code 1118 using a shared secret corresponding to the time-based one-time password seed and a time counter derived from the current time value. The computed code 1118 may comprise a numeric code, an alphanumeric code, or another one-time authentication value accepted by the producer application 1104.

The artificial intelligence agent system 1112 enters the computed code 1118 into the multi-factor authentication input element 1110 of the graphical user interface 1106. Entry of the computed code 1118 may be performed through a simulated keyboard event, form-field population, a copy-paste primitive, an interface automation operation, or a combination thereof. Upon receipt of the computed code 1118, the producer application 1104 evaluates the computed code 1118 according to its authentication procedure. When the computed code 1118 satisfies the multi-factor authentication challenge 1108, the producer application 1104 permits the credential lifecycle operation to continue.

In one or more implementations, the computed code 1118 is computed in volatile memory of the credential lifecycle system 400 and is not persisted to non-volatile storage after the computed code 1118 is entered into the multi-factor authentication input element 1110. In one or more implementations, the time-based one-time password seeds 1116 are stored in encrypted form in the centralized credential vault 1114 and are accessed in connection with computation of a computed code 1118 for an authorized credential lifecycle operation.

In the live session brokering with state preservation pathway 1120, a producer application 1122 renders, on a graphical user interface 1124, a multi-factor authentication challenge 1126. The multi-factor authentication challenge 1126 may require a second authentication factor that is not computable from the time-based one-time password seeds 1116 or that is designated for human approval under one or more administrative policies. By way of example and not limitation, the multi-factor authentication challenge 1126 may require a hardware security key interaction, biometric authentication, push notification approval, administrator approval, knowledge-based authentication, or another authentication action requiring human participation.

An artificial intelligence agent system 1128 invokes a session broker 1130 upon detecting that the multi-factor authentication challenge 1126 cannot be completed autonomously or should not be completed autonomously under an applicable policy. The session broker 1130 maintains a state buffer 1132 characterizing a current session between the artificial intelligence agent system 1128 and the producer application 1122. The state buffer 1132 may include a sequence of completed operations, a current rendered view of the graphical user interface 1124, values entered into one or more form fields of the graphical user interface 1124, navigation state, session state, authentication state, a session token, a timestamp associated with the handoff, or any combination thereof.

The session broker 1130 provides a human administrator 1134 with access to the current session in a state-preserving manner. The human administrator 1134 supplies or approves the second authentication factor required by the multi-factor authentication challenge 1126 through interaction with the producer application 1122. During or after the human administrator's interaction, the session broker 1130 captures one or more state changes resulting from the interaction and updates the state buffer 1132 to reflect the state of the session after the multi-factor authentication challenge 1126 has been satisfied.

After completion of the second authentication factor by the human administrator 1134, the session broker 1130 returns control of the current session to the artificial intelligence agent system 1128 together with the updated state buffer 1132. The artificial intelligence agent system 1128 then resumes the credential lifecycle operation from the preserved session state, without requiring the credential lifecycle operation to restart from an initial login state.

The time-based one-time password computation pathway 1102 and the live session brokering with state preservation pathway 1120 may be selected according to one or more selection conditions. The time-based one-time password computation pathway 1102 may be selected when a time-based one-time password seed associated with the producer application 1104 is available in the centralized credential vault 1114 and when the multi-factor authentication challenge 1108 requires a time-based one-time password. The live session brokering with state preservation pathway 1120 may be selected when a time-based one-time password seed is unavailable, when the multi-factor authentication challenge 1126 requires a second authentication factor other than a time-based one-time password, when autonomous completion of the challenge is not permitted by policy, or when human authorization is required for the credential lifecycle operation.

In one or more implementations, the producer application 1104 and the producer application 1122 represent different authentication scenarios for the same producer application. In other implementations, the producer application 1104 and the producer application 1122 represent different producer applications having different multi-factor authentication requirements. Similarly, the artificial intelligence agent system 1112 and the artificial intelligence agent system 1128 may represent different operating states or instances of an artificial intelligence agent system configured to handle multi-factor authentication challenges during credential lifecycle operations.

The multi-factor authentication handling pipeline 1100 enables the credential lifecycle system 400 to continue a credential lifecycle operation across a multi-factor authentication checkpoint using either an autonomous time-based one-time password computation pathway or a human-assisted live session brokering pathway with state preservation. By maintaining the state buffer 1132 during live session brokering and by computing the computed code 1118 from time-based one-time password seeds 1116 when available, the credential lifecycle system 400 supports credential lifecycle operations across producer applications having different multi-factor authentication requirements.

### Rotation Transaction Initiation Pipeline

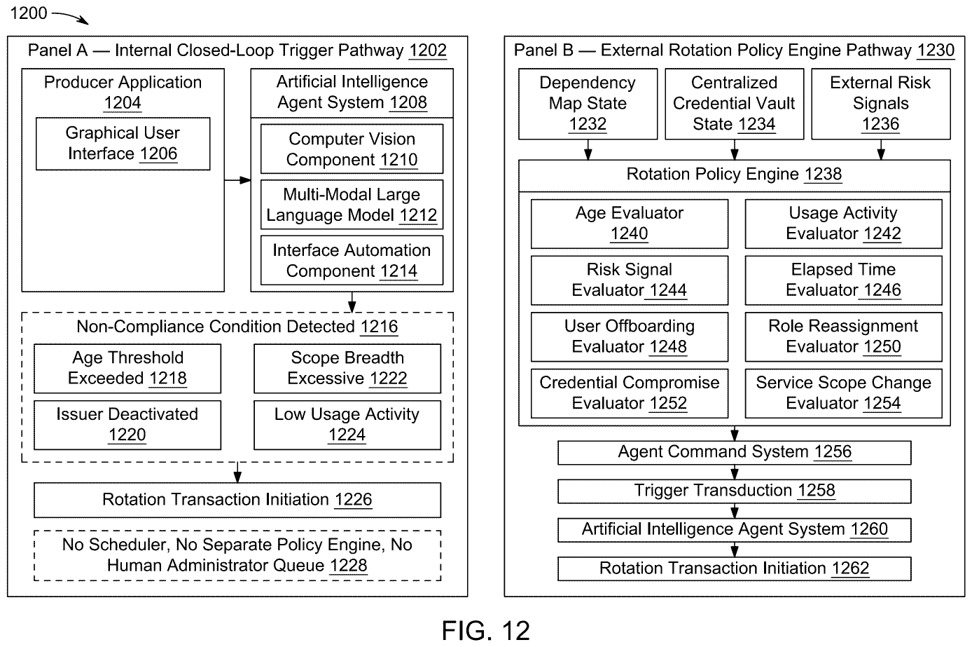

FIG. 12 illustrates a rotation transaction initiation pipeline 1200 of the credential lifecycle system 400. The rotation transaction initiation pipeline 1200 is configured to initiate a rotation transaction in respect of an API credential previously issued by a producer application. The rotation transaction initiation pipeline 1200 comprises an internal closed-loop trigger pathway 1202 and an external rotation policy engine pathway 1230. The internal closed-loop trigger pathway 1202 is configured to initiate a rotation transaction based on non-compliance detected from content rendered by a producer application, without requiring an external scheduler, a separate policy engine, or a human administrator queue. The external rotation policy engine pathway 1230 is configured to initiate a rotation transaction based on state inputs evaluated by a rotation policy engine 1238 and routed to an artificial intelligence agent system 1260 through an agent command system 1256 and a trigger transduction 1258.

In the internal closed-loop trigger pathway 1202, a producer application 1204 renders, on a graphical user interface 1206, credential information associated with one or more API credentials previously issued by the producer application 1204. The credential information may include one or more obfuscated representations of API credentials, credential identifiers, creation timestamps, issuer identifiers, issuer status values, scope values, usage information, last-used timestamps, or other metadata fields associated with the API credentials.

An artificial intelligence agent system 1208 processes the content rendered in the graphical user interface 1206. The artificial intelligence agent system 1208 comprises a computer vision component 1210, a multi-modal large language model 1212, and an interface automation component 1214. The computer vision component 1210 captures an image or other visual representation of the content rendered in the graphical user interface 1206 and detects credential-displaying regions or other interface elements associated with API credentials. The multi-modal large language model 1212 derives, from the captured visual representation and detected interface elements, a plurality of API credential metadata attributes specific to each API credential represented in the graphical user interface 1206. The interface automation component 1214 is available to execute one or more graphical user interface interactions during a subsequent credential lifecycle operation initiated as a result of the detected non-compliance condition.

The multi-modal large language model 1212 evaluates the plurality of API credential metadata attributes against non-compliance criteria. The non-compliance criteria include an age threshold exceeded condition 1218, an issuer deactivated condition 1220, a scope breadth excessive condition 1222, and a low usage activity condition 1224. The age threshold exceeded condition 1218 is detected when a difference between a current time value and a creation timestamp of an API credential exceeds an age threshold associated with the producer application 1204 or with a credential category to which the API credential belongs. The issuer deactivated condition 1220 is detected when an issuer status of the API credential is rendered as deactivated within the graphical user interface 1206 or is otherwise inferable as deactivated from contextual content associated with the API credential. The scope breadth excessive condition 1222 is detected when a scope of the API credential exceeds a permitted scope under a scope policy associated with the producer application 1204, an issuing user, or a credential category. The low usage activity condition 1224 is detected when a difference between a current time value and a last-used timestamp of the API credential exceeds a usage activity threshold, or when usage information associated with the API credential indicates usage below a threshold associated with the producer application 1204 or with the credential category.

Upon detection of a non-compliance condition detected 1216 for an API credential, the artificial intelligence agent system 1208 initiates a rotation transaction initiation 1226 in respect of the API credential. The rotation transaction initiation 1226 may be initiated by generating a closed-loop trigger based on the non-compliance condition detected 1216 and supplying the closed-loop trigger to the credential lifecycle system 400 for execution of a credential rotation transaction. In one or more implementations, the closed-loop trigger is routed to a trigger transduction component of the credential lifecycle system 400 to generate an execution instruction characterizing the producer application 1204, the API credential, the credential operation type, and one or more operational parameters.

The internal closed-loop trigger pathway 1202 performs the rotation transaction initiation 1226 without requiring a scheduler, a separate policy engine, or a human administrator queue 1228. In this manner, the non-compliance condition detected 1216 by the artificial intelligence agent system 1208 is used to initiate the rotation transaction without requiring a separate periodic scheduling process, an independently executed rotation policy engine, or manual placement of the credential operation into a human administrator queue.

In the external rotation policy engine pathway 1230, the rotation policy engine 1238 receives a plurality of state inputs. The plurality of state inputs includes a dependency map state 1232, a centralized credential vault state 1234, and external risk signals 1236. The dependency map state 1232 comprises a current state of a dependency mapping component of the credential lifecycle system 400, including mappings between credential identifiers and corresponding consumer application sets, and may include rotation events, propagation events, or revocation events associated with one or more API credentials. The centralized credential vault state 1234 comprises a current state of a centralized credential vault of the credential lifecycle system 400, including encrypted credential records, visual fingerprints, time-based one-time password seeds, tamper-evident audit records, credential metadata attributes, or other credential-related records. The external risk signals 1236 comprise signals received from sources external to the credential lifecycle system 400, including, by way of example and not limitation, threat intelligence feeds, security information and event management systems, identity and access management platforms, identity governance platforms, human resources platforms, service management systems, or security monitoring systems.

The rotation policy engine 1238 evaluates the plurality of state inputs through a plurality of evaluators. The plurality of evaluators includes an age evaluator 1240, a usage activity evaluator 1242, a risk signal evaluator 1244, an elapsed time evaluator 1246, a user offboarding evaluator 1248, a role reassignment evaluator 1250, a credential compromise evaluator 1252, and a service scope change evaluator 1254. The age evaluator 1240 evaluates the centralized credential vault state 1234 to detect an API credential having an age that exceeds an applicable age threshold. The usage activity evaluator 1242 evaluates the centralized credential vault state 1234, the dependency map state 1232, or both, to detect an API credential having usage activity below an applicable usage activity threshold. The risk signal evaluator 1244 evaluates the external risk signals 1236 to detect a risk signal associated with an API credential, a producer application, an issuing user, or a consumer application. The elapsed time evaluator 1246 evaluates the centralized credential vault state 1234 to detect an API credential for which an elapsed time since a prior rotation exceeds an applicable elapsed time threshold.

The user offboarding evaluator 1248 evaluates the external risk signals 1236 to detect an offboarding event associated with an issuing user or other user associated with an API credential. The role reassignment evaluator 1250 evaluates the external risk signals 1236 to detect a role reassignment event associated with an issuing user or other user associated with an API credential. The credential compromise evaluator 1252 evaluates the external risk signals 1236 to detect an actual or suspected compromise event associated with an API credential. The service scope change evaluator 1254 evaluates the dependency map state 1232, the external risk signals 1236, or both, to detect a service scope change event associated with a producer application, a consumer application, or a credential-dependent service.

Upon determining that a rotation transaction should be initiated in respect of an API credential, the rotation policy engine 1238 emits a rotation transaction trigger to the agent command system 1256. The agent command system 1256 routes the rotation transaction trigger to the trigger transduction 1258. The trigger transduction 1258 transforms the rotation transaction trigger into an execution instruction characterizing a producer application, a credential operation type, an API credential or credential identifier, and one or more operational parameters. The trigger transduction 1258 communicates the execution instruction to the artificial intelligence agent system 1260. The artificial intelligence agent system 1260 then effects a rotation transaction initiation 1262 in respect of the API credential, thereby commencing a credential lifecycle operation for rotating the API credential.

The internal closed-loop trigger pathway 1202 and the external rotation policy engine pathway 1230 may operate independently, alternatively, or concurrently within a deployment of the credential lifecycle system 400. The internal closed-loop trigger pathway 1202 may initiate rotation transactions in response to non-compliance conditions detected from rendered graphical user interface content by the artificial intelligence agent system 1208. The external rotation policy engine pathway 1230 may initiate rotation transactions in response to policy evaluations performed by the rotation policy engine 1238 using the dependency map state 1232, the centralized credential vault state 1234, and the external risk signals 1236. In one or more implementations, use of the internal closed-loop trigger pathway 1202, the external rotation policy engine pathway 1230, or both is configured on a per-producer-application basis, a per-credential-category basis, a per-risk-condition basis, a per-tenant basis, or a per-deployment basis.

### Artificial Intelligence Agent System Architecture

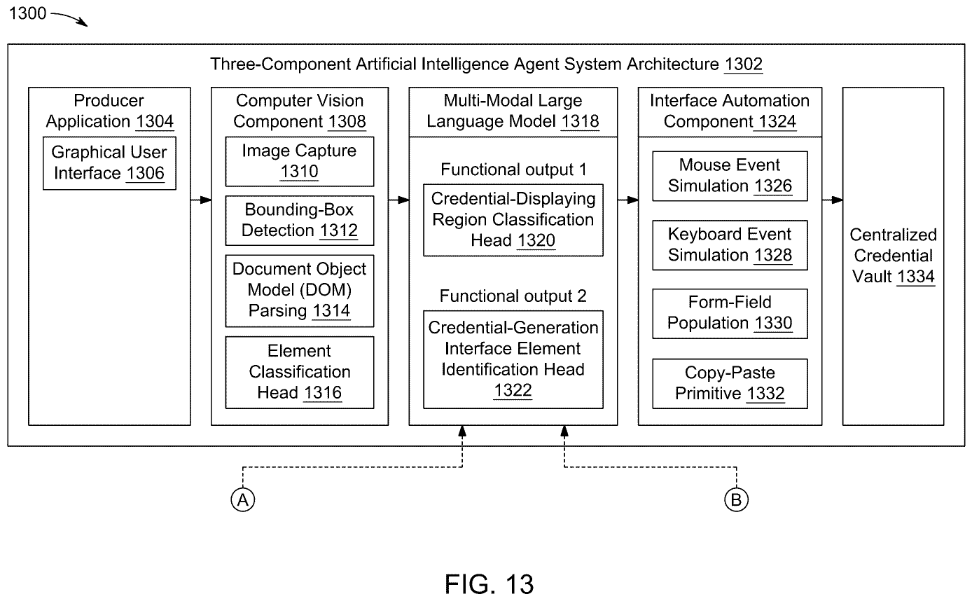

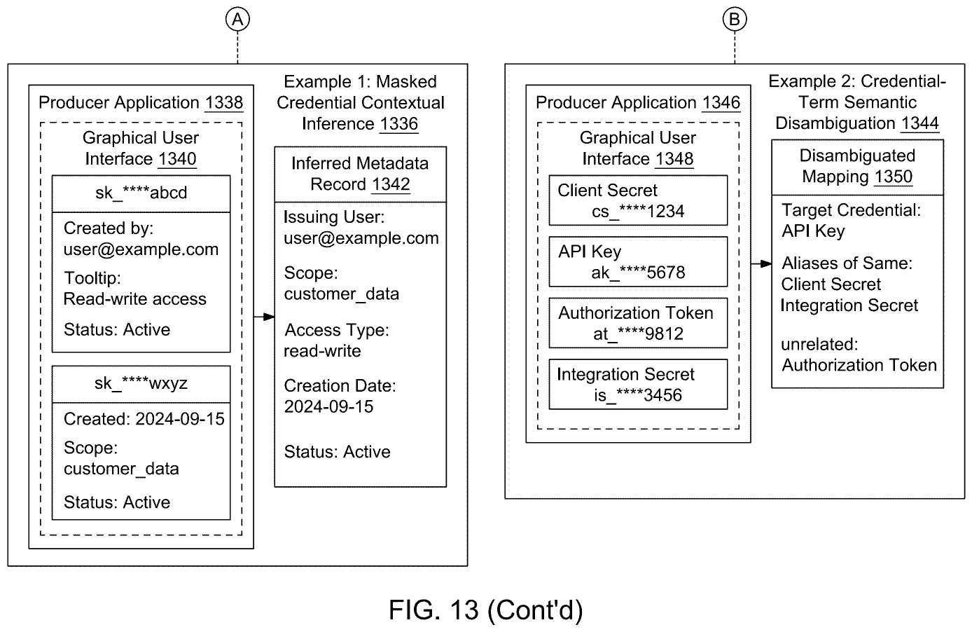

FIG. 13 illustrates an artificial intelligence agent system architecture 1300 including a three-component artificial intelligence agent system architecture 1302 of the credential lifecycle system 400, together with two worked examples of operation of a multi-modal large language model 1318 on rendered content of producer application graphical user interfaces. The three-component artificial intelligence agent system architecture 1302 is configured to receive, as input, content rendered in a graphical user interface 1306 of a producer application 1304, to process the input through operations performed by a computer vision component 1308, the multi-modal large language model 1318, and an interface automation component 1324, and to write, update, or retrieve credential-related records in a centralized credential vault 1334.

The producer application 1304 renders, on the graphical user interface 1306, content comprising one or more interface elements through which an API credential is generated, listed, inspected, or revoked at the producer application 1304. The content rendered in the graphical user interface 1306 may comprise a credential listing, a transient display, a generate new credential element, a revocation control, a multi-factor authentication input element, a settings navigation, an API credentials section, a login screen, or a combination thereof.

The computer vision component 1308 receives or captures content rendered in the graphical user interface 1306 of the producer application 1304 and processes the content through one or more operations comprising image capture 1310, bounding-box detection 1312, document object model parsing 1314, and an element classification head 1316. The image capture 1310 acquires a pixel-level representation or other visual representation of the content rendered in the graphical user interface 1306. The bounding-box detection 1312 localizes one or more interface elements within the visual representation by computing regions enclosing the interface elements. The document object model parsing 1314 extracts a hierarchical representation of structured interface elements from a document object model associated with the graphical user interface 1306, where the document object model is exposed by the producer application 1304. The element classification head 1316 assigns detected interface elements to element categories, including, by way of example and not limitation, a credential-displaying element category, a credential-generation interface element category, a revocation control element category, a multi-factor authentication input element category, a navigational element category, and an inert element category.

The multi-modal large language model 1318 receives one or more outputs of the computer vision component 1308, including the visual representation, bounding-box information, document object model information, element category assignments, or any combination thereof. The multi-modal large language model 1318 produces functional outputs that include a credential-displaying region classification head 1320 and a credential-generation interface element identification head 1322. The credential-displaying region classification head 1320 classifies a region of the graphical user interface 1306 as a credential-displaying region by evaluating visual features of the region together with textual features of content rendered within or adjacent to the region. The credential-displaying region classification head 1320 may also output a plurality of API credential metadata attributes derived from content rendered within or associated with the region. The credential-generation interface element identification head 1322 identifies an interface element of the graphical user interface 1306 as a credential-generation interface element by evaluating visual features, textual labels, structural information, and contextual content associated with the interface element. The credential-generation interface element identification head 1322 may emit an interface element identification and an actuation instruction executable by the interface automation component 1324.

The interface automation component 1324 receives an actuation instruction from the multi-modal large language model 1318 and effects a simulated graphical user interface interaction at the producer application 1304 in accordance with the actuation instruction. The interface automation component 1324 may execute one or more of a mouse event simulation 1326, a keyboard event simulation 1328, form-field population 1330, and a copy-paste primitive 1332. The mouse event simulation 1326 generates a simulated mouse event at a coordinate or region of the graphical user interface 1306 corresponding to an interface element identified by the multi-modal large language model 1318. The keyboard event simulation 1328 generates a simulated keyboard event at an interface element identified by the multi-modal large language model 1318. The form-field population 1330 populates a form field of the graphical user interface 1306 with textual content, credential content, authentication content, or metadata content received as an input parameter. The copy-paste primitive 1332 transfers textual content from a source interface element to a destination interface element, including a destination interface element in a graphical user interface of the producer application 1304 or in a graphical user interface of a consumer application.

The centralized credential vault 1334 receives, stores, updates, or provides credential-related records used by the three-component artificial intelligence agent system architecture 1302. The credential-related records may include encrypted credential records, visual fingerprints, time-based one-time password seeds, and tamper-evident audit records. The encrypted credential records may comprise complete values of API credentials captured from transient displays of the producer application 1304 in encrypted form. The visual fingerprints may comprise obfuscated representations of API credentials rendered within credential listings of the producer application 1304 together with associated visual features. The time-based one-time password seeds may comprise shared secrets associated with producer applications, accounts, sessions, or credential lifecycle operations. The tamper-evident audit records may comprise chronological logs of credential operations performed at the producer application 1304 by the artificial intelligence agent system, in which entries of the logs are cryptographically linked to detect modification or removal of prior entries.

In a first worked example of operation of the multi-modal large language model 1318, designated as masked credential contextual inference 1336, a producer application 1338 renders, on a graphical user interface 1340, credential-related content including obfuscated credential representations and metadata fields. The graphical user interface 1340 includes an obfuscated representation of a first API credential in the form sk_**** abcd in association with rendered metadata including Created by: user@example.com, Tooltip: Read-write access, and Status: Active. The graphical user interface 1340 also includes an obfuscated representation of a second API credential in the form sk****wxyz in association with rendered metadata including Created: 2024-09-15, Scope: customer_data, and Status: Active.

The multi-modal large language model 1318 produces an inferred metadata record 1342 from the rendered content of the graphical user interface 1340 by evaluating the obfuscated credential representations, contextually adjacent metadata fields, visual proximity of rendered elements, textual labels, and structural relationships among the rendered elements. The inferred metadata record 1342 comprises an issuing user of user@example.com, a scope of customer_data, an access type of read-write, a creation date of 2024 Sep. 15, and a status of Active. The inferred metadata record 1342 may therefore combine information rendered in different locations of the graphical user interface 1340 into a single structured record associated with an API credential or credential class, based on visual and textual context.

In a second worked example of operation of the multi-modal large language model 1318, designated as credential-term semantic disambiguation 1344, a producer application 1346 renders, on a graphical user interface 1348, a plurality of credential-related terms each in association with a corresponding obfuscated representation. The plurality of credential-related terms comprises Client Secret rendered in association with cs****1234, API Key rendered in association with ak_****5678, Authorization Token rendered in association with at_****9812, and Integration Secret rendered in association with is_****3456.

The multi-modal large language model 1318 produces a disambiguated mapping 1350 from the rendered content of the graphical user interface 1348 by classifying each rendered credential-related term as an alias of a target credential class or as unrelated to the target credential class. The disambiguated mapping 1350 comprises a target credential of API Key, aliases of the target credential comprising Client Secret and Integration Secret, and a credential-related term unrelated to the target credential comprising Authorization Token. The disambiguated mapping 1350 enables the artificial intelligence agent system to operate against producer applications that render non-uniform credential-related terminology by mapping rendered terms to a target credential class using visual context, textual context, and semantic relationships among the rendered terms.

The three-component artificial intelligence agent system architecture 1302 supports both discovery and generation operations of the credential lifecycle method 500. In a discovery operation, the computer vision component 1308 and the multi-modal large language model 1318 derive API credential metadata attributes from credential-related content rendered in the graphical user interface of a producer application, and the credential-displaying region classification head 1320 produces region classifications and metadata outputs. In a generation operation, the multi-modal large language model 1318 identifies a generate new credential element of the producer application graphical user interface, and the credential-generation interface element identification head 1322 produces an interface element identification and an actuation instruction for the interface automation component 1324. The worked examples (1336 and 1344) illustrate operation of the multi-modal large language model 1318 on credential-related rendered content encountered across heterogeneous producer applications, including masked credential content with contextually adjacent metadata fields and non-uniform credential terminology.

### Dependency Mapping Architecture

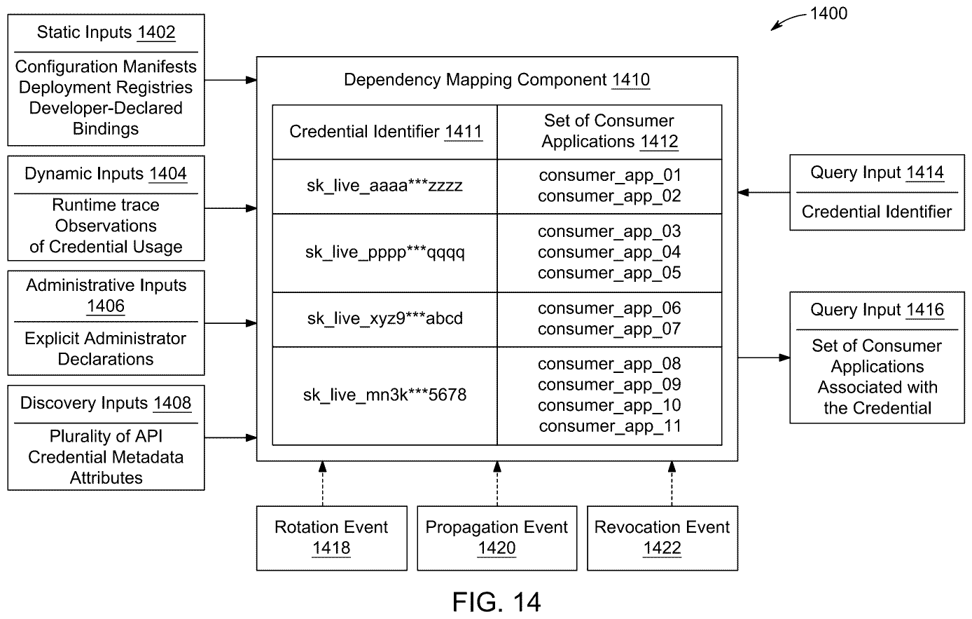

FIG. 14 illustrates a dependency mapping architecture 1400 including a dependency mapping component 1410 of the credential lifecycle system 400. The dependency mapping component 1410 is configured to maintain a mapping that associates API credentials issued by a producer application with a set of consumer applications 1412 that authenticate to or otherwise consume services of the producer application using the API credentials. The dependency mapping component 1410 is further configured to construct the mapping from a plurality of input sources, update the mapping in response to credential lifecycle events, and expose a query interface through which an artificial intelligence agent system identifies consumer applications associated with a credential identifier 1411.

The dependency mapping component 1410 maintains a mapping table comprising one or more entries. Each entry of the mapping table associates a credential identifier 1411 with the set of consumer applications 1412 associated with an API credential corresponding to the credential identifier 1411. By way of example and not limitation, the mapping table maintained by the dependency mapping component 1410 comprises an entry associating a credential identifier “sk_live_aaaazzzz**” with a set of consumer applications comprising “consumer_app_01” and “consumer_app_02”, an entry associating a credential identifier “sk_live_ppppqqqq**” with a set of consumer applications comprising “consumer_app_03”, “consumer_app_04”, and “consumer_app_05”, an entry associating a credential identifier “sk_live_xyz9abcd**” with a set of consumer applications comprising “consumer_app_06” and “consumer_app_07”, and an entry associating a credential identifier “sk_live_mn3k5678**” with a set of consumer applications comprising “consumer_app_08”, “consumer_app_09”, “consumer_app_10”, and “consumer_app_11”. The credential identifier 1411 within each entry of the mapping table may comprise an obfuscated representation of the API credential, a unique identifier assigned to the API credential by the producer application, a hash value computed from the API credential or a portion thereof, or another credential reference usable by the credential lifecycle system 400. The set of consumer applications 1412 within each entry of the mapping table may comprise one or more consumer application identifiers, each consumer application identifier comprising a name, a unique identifier, a network address, a service descriptor, or a combination thereof.

The dependency mapping component 1410 constructs the mapping table from a plurality of input sources comprising static inputs 1402, dynamic inputs 1404, administrative inputs 1406, and discovery inputs 1408. The static inputs 1402 comprise configuration manifests of one or more producer applications and consumer applications, deployment registries of an enterprise computing environment in which the producer applications and consumer applications are deployed, and developer-declared bindings between API credentials issued by the producer applications and consumer applications configured to authenticate using the API credentials. The configuration manifests may be implemented in formats including, by way of example and not limitation, JavaScript Object Notation, YAML, Extensible Markup Language, TOML, or another structured configuration format. The deployment registries may comprise container orchestration registries, cloud computing service catalogs, enterprise application registries, infrastructure inventories, or analogous deployment records. The developer-declared bindings may comprise source code annotations, configuration files, infrastructure-as-code definitions, deployment descriptors, or analogous declarative artifacts.

The dynamic inputs 1404 comprise runtime trace observations of credential usage captured during operation of one or more consumer applications. The runtime trace observations may be obtained through one or more of network traffic observation, application performance monitoring instrumentation, distributed tracing systems, log aggregation systems, proxy-mediated observation of network traffic between consumer applications and producer applications, or other runtime telemetry sources. The administrative inputs 1406 comprise explicit administrator declarations of associations between API credentials and consumer applications. In one or more implementations, an administrator of the credential lifecycle system 400 declares, through an administrative interface, that one or more consumer applications authenticate to or otherwise consume services of a producer application using a specified API credential. The discovery inputs 1408 comprise a plurality of API credential metadata attributes derived by a multi-modal large language model from rendered content of producer application graphical user interfaces during a discovery phase of the credential lifecycle method 500.

The dependency mapping component 1410 exposes a query interface through which the artificial intelligence agent system obtains the set of consumer applications associated with a given credential identifier 1411. The query interface receives, as a query input 1414, a credential identifier 1411 associated with an API credential being discovered, rotated, replaced, propagated, revoked, or otherwise managed. The dependency mapping component 1410 returns, as a query output 1416, the set of consumer applications associated with the credential identifier 1411. In one or more implementations, during a rotation transaction, the query input 1414 corresponds to a prior API credential, a credential class, a producer-application credential reference, or a credential identifier 1411 derived during a discovery phase, and the query output 1416 identifies the consumer applications to which a newly generated replacement API credential is to be propagated.

The query interface is invoked by the artificial intelligence agent system during the propagation phase of the credential lifecycle method 500 to identify the set of consumer applications to which a newly generated API credential is to be propagated. The query interface may also be invoked during a rollback transaction to identify the set of consumer applications that were previously updated with a new API credential subject to rollback, and to identify the consumer applications to which a prior API credential is to be restored.

The dependency mapping component 1410 updates the mapping table in response to events emitted during the credential lifecycle method 500. The events comprise a rotation event 1418, a propagation event 1420, and a revocation event 1422. The rotation event 1418 is emitted upon completion of a rotation transaction in which a prior API credential is replaced with a new API credential at the producer application. In response to the rotation event 1418, the dependency mapping component 1410 may update the mapping table by replacing, supplementing, or linking the credential identifier 1411 of the prior API credential with the credential identifier 1411 of the new API credential while preserving the set of consumer applications associated with the corresponding entry.

The propagation event 1420 is emitted upon completion of propagation of a new API credential to a consumer application. In response to the propagation event 1420, the dependency mapping component 1410 may update the mapping table to indicate that the consumer application has been updated to authenticate to the producer application using the new API credential. Where the consumer application is not already associated with the corresponding entry, the dependency mapping component 1410 may add a consumer application identifier for the consumer application to the set of consumer applications associated with the credential identifier 1411. The dependency mapping component 1410 may also update propagation metadata indicating a propagation state, timestamp, operation identifier, or verification status associated with the propagation event 1420.

The revocation event 1422 is emitted upon revocation of an API credential at the producer application. In response to the revocation event 1422, the dependency mapping component 1410 may update the mapping table by marking the entry corresponding to the revoked API credential as inactive, removing an active association between the revoked API credential and one or more consumer applications, or preserving the entry in an inactive state for audit or rollback analysis. In one or more implementations, the dependency mapping component 1410 preserves historical associations between revoked API credentials and consumer applications to support audit records, compliance review, forensic analysis, or subsequent rollback verification.

The dependency mapping component 1410 may be implemented as a relational database, a key-value store, a graph database, a distributed data store, an in-memory data structure backed by persistent storage, or a combination thereof. The mapping maintained by the dependency mapping component 1410 may be persisted to non-volatile storage of the credential lifecycle system 400 and may be replicated across multiple storage nodes. In one or more implementations, the dependency mapping component 1410 exposes, in addition to the query interface receiving the credential identifier 1411, an inverse query interface receiving a consumer application identifier and returning a set of API credentials with which the consumer application is associated, an enumeration interface returning a plurality of mapping entries, and an analytics interface returning aggregate statistics computed from the mapping entries.

### Trigger-Source-to-Dashboard Pipeline

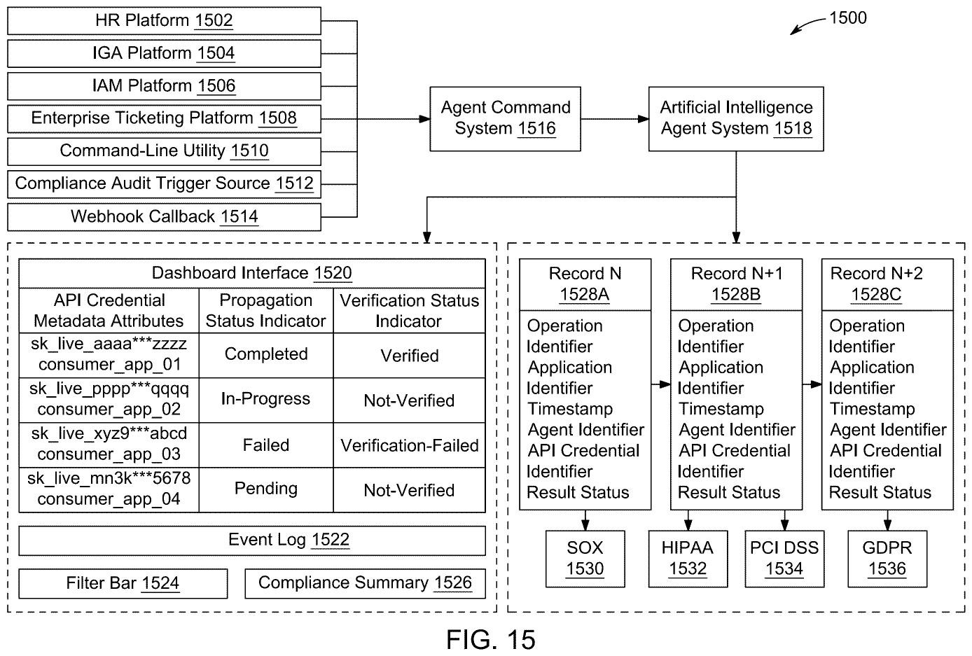

FIG. 15 illustrates a trigger-source-to-dashboard pipeline 1500 of the credential lifecycle system 400. The trigger-source-to-dashboard pipeline 1500 is configured to receive trigger events from a plurality of trigger sources, route the trigger events to an artificial intelligence agent system 1518 through an agent command system 1516, aggregate credential lifecycle state in a dashboard interface 1520, and generate a sequence of tamper-evident audit records, including a record N 1528A, a record N+1 1528B, and a record N+2 1528C, in respect of credential operations performed by the artificial intelligence agent system 1518. The dashboard interface 1520 is further configured to present credential metadata, propagation status, verification status, event log information, filtering controls, and compliance summary information associated with one or more compliance frameworks.

The plurality of trigger sources operably coupled to the agent command system 1516 comprises a human resources platform 1502, an identity governance and administration platform 1504, an identity and access management platform 1506, an enterprise ticketing platform 1508, a command-line utility 1510, a compliance audit trigger source 1512, and a webhook callback 1514. The human resources platform 1502 may emit a trigger event upon onboarding, role reassignment, or offboarding of an enterprise user, the trigger event comprising an enterprise user identifier and a corresponding lifecycle event type. The identity governance and administration platform 1504 may emit a trigger event upon a periodic access certification cycle or upon detection of an entitlement non-conformity, the trigger event comprising an enterprise user identifier, a credential identifier, and a corresponding governance event type. The identity and access management platform 1506 may emit a trigger event upon a privileged session change, a permission grant, a permission revocation, or a multi-factor authentication enrollment event, the trigger event comprising an enterprise user identifier and a corresponding access event type.

The enterprise ticketing platform 1508 may emit a trigger event upon submission of a credential request ticket by an enterprise user or by an enterprise system, the trigger event comprising a ticket identifier and a corresponding ticket request type. The command-line utility 1510 may emit a trigger event upon manual invocation of a credential operation by an administrator of the credential lifecycle system 400, the trigger event comprising a manually entered command and one or more command parameters. The compliance audit trigger source 1512 may emit a trigger event upon discovery of a non-compliant credential during a compliance audit cycle, the trigger event comprising a credential identifier and a corresponding compliance violation type. The webhook callback 1514 may emit a trigger event upon programmatic invocation by a third-party system through a hypertext transfer protocol callback, the trigger event comprising a callback payload and a corresponding webhook event type.

The agent command system 1516 receives trigger events from the plurality of trigger sources (1502, 1504, 1506, 1508, 1510, 1512, 1514) and routes the trigger events to the artificial intelligence agent system 1518. In one or more implementations, the agent command system 1516 transforms the trigger events into a uniform internal format, deduplicates duplicate or redundant trigger events, prioritizes trigger events in accordance with one or more administrative policies, and rate-limits trigger events to control throughput of credential operations performed by the artificial intelligence agent system 1518. The artificial intelligence agent system 1518 receives the routed trigger events and performs credential lifecycle operations in respect of the trigger events in accordance with the credential lifecycle method 500.

The dashboard interface 1520 aggregates state of the credential lifecycle system 400 in a view accessible to an enterprise governance user. The dashboard interface 1520 comprises API credential metadata attributes, a propagation status indicator, a verification status indicator, an event log 1522, a filter bar 1524, and a compliance summary 1526. The API credential metadata attributes are rendered within the dashboard interface 1520 in association with each API credential or each credential-consumer application association represented in the credential lifecycle system 400. The API credential metadata attributes may comprise a credential identifier, a consumer application identifier, an issuing user, a creation timestamp, a scope, an issuer status, a last-used timestamp, an access type, a status, or any combination thereof.

The propagation status indicator characterizes a state of propagation of a new API credential to one or more consumer applications associated with the new API credential, and may take values including completed, in-progress, failed, and pending. The verification status indicator characterizes an outcome of a verification operation performed for one or more consumer applications, and may take values including verified, not-verified, and verification-failed. The event log 1522 renders a chronological sequence of credential operations performed by the credential lifecycle system 400. The filter bar 1524 receives a filter input from the enterprise governance user, the filter input comprising one or more of a credential identifier, a producer application identifier, a consumer application identifier, a propagation status value, a verification status value, a compliance framework identifier, and a date range, and filters the rendered content of the dashboard interface 1520 in accordance with the filter input. The compliance summary 1526 renders an aggregate compliance-related view of credential lifecycle operations across one or more compliance frameworks.

By way of example and not limitation, the dashboard interface 1520 may render an entry comprising the credential identifier sk_live_aaaazzzz** associated with a consumer application identifier consumer_app_01, a propagation status value of completed, and a verification status value of verified. The dashboard interface 1520 may further render an entry comprising the credential identifier sk_live_ppppqqqq** associated with a consumer application identifier consumer_app_02, a propagation status value of in-progress, and a verification status value of not-verified. The dashboard interface 1520 may further render an entry comprising the credential identifier sk_live_xyz9abcd** associated with a consumer application identifier consumer_app_03, a propagation status value of failed, and a verification status value of verification-failed. The dashboard interface 1520 may further render an entry comprising the credential identifier sk_live_mn3k5678** associated with a consumer application identifier consumer_app_04, a propagation status value of pending, and a verification status value of not-verified. The dashboard interface 1520 thereby enables the enterprise governance user to evaluate propagation status and verification status of API credentials across consumer applications associated with the API credentials.

The artificial intelligence agent system 1518 generates or causes storage of a sequence of tamper-evident audit records in respect of credential operations performed during the credential lifecycle method 500. The sequence of tamper-evident audit records comprises the record N 1528A, the record N+1 1528B, and the record N+2 1528C. Each record of the sequence comprises an operation identifier, an application identifier, a timestamp, an agent identifier, an API credential identifier, and a result status. The operation identifier identifies the credential operation performed by the artificial intelligence agent system 1518, including, by way of example and not limitation, a discovery operation, a generation operation, a propagation operation, a verification operation, a rotation operation, or a revocation operation. The application identifier identifies the producer application or consumer application against which the credential operation is performed. The timestamp identifies the time at which the credential operation is performed. The agent identifier identifies the artificial intelligence agent system 1518 or a component, instance, process, or session thereof through which the credential operation is performed. The API credential identifier identifies the API credential in respect of which the credential operation is performed. The result status identifies an outcome of the credential operation, including, by way of example and not limitation, a success outcome, a failure outcome, a partial success outcome, or a pending outcome.

Each tamper-evident audit record of the sequence may be cryptographically bound to a preceding tamper-evident audit record of the sequence through a cryptographic hash chain. In one or more implementations, a given tamper-evident audit record comprises a hash value computed from contents of a preceding tamper-evident audit record together with contents of the given tamper-evident audit record. Modification or removal of a tamper-evident audit record of the sequence is detectable through verification of the cryptographic hash chain. The cryptographic hash function used to compute the hash value may be implemented using SHA-256, SHA-3, BLAKE2, BLAKE3, or another cryptographic hash function.

Each tamper-evident audit record of the sequence may be tagged, formatted, mapped, or filtered in accordance with one or more compliance frameworks comprising the Sarbanes-Oxley Act 1530, the Health Insurance Portability and Accountability Act 1532, the Payment Card Industry Data Security Standard 1534, and the General Data Protection Regulation 1536. In one or more implementations, a tamper-evident audit record includes compliance-related fields that enable the record to be associated with one or more control activities, access events, credential lifecycle operations, data handling events, security configuration changes, or retention categories. The compliance summary 1526 may aggregate the tamper-evident audit records by compliance framework, credential operation type, result status, application identifier, date range, or other governance attribute.

The dashboard interface 1520 and the sequence of tamper-evident audit records collectively provide a governance and audit surface of the credential lifecycle system 400. The dashboard interface 1520 enables review of credential lifecycle state by an enterprise governance user, and the sequence of tamper-evident audit records enables reconstruction and audit review of credential operations performed by the credential lifecycle system 400. The plurality of trigger sources (1502, 1504, 1506, 1508, 1510, 1512, 1514) provide operational entry points through which credential lifecycle operations are initiated, thereby enabling the credential lifecycle system 400 to operate in coordination with heterogeneous identity, governance, ticketing, audit, command-line, and webhook-based infrastructure of an enterprise computing environment.

### Credential Lifecycle Coverage and Closed-Loop Operation Architecture

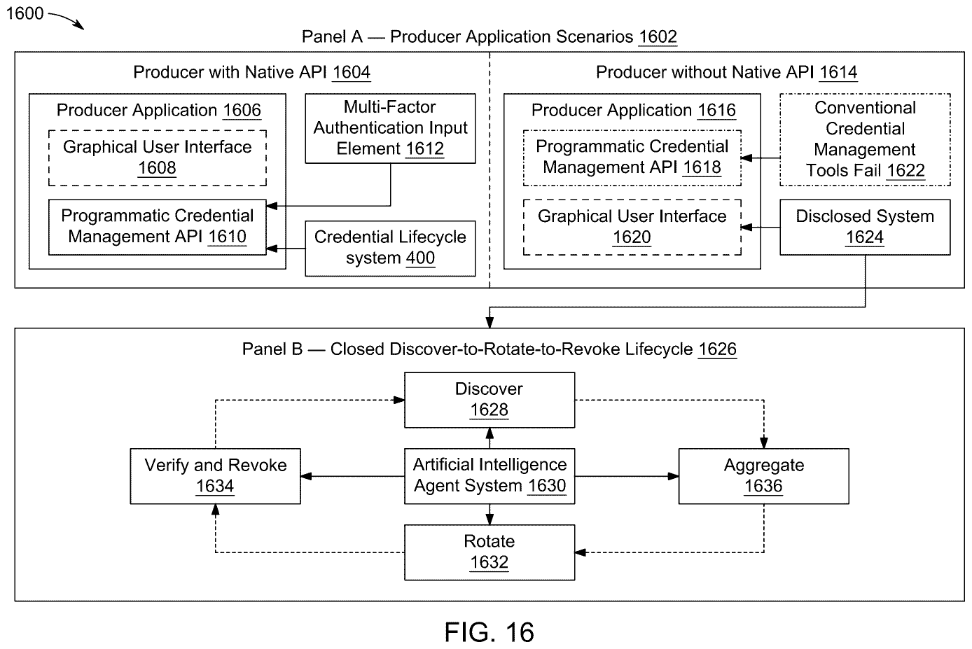

FIG. 16 illustrates a credential lifecycle coverage and closed-loop operation architecture 1600 of the credential lifecycle system 400. The architecture 1600 comprises a set of producer application scenarios 1602 and a closed discover-to-rotate-to-revoke lifecycle 1626. The producer application scenarios 1602 illustrate operation of the credential lifecycle system 400 with producer applications that expose a native programmatic credential management interface and with producer applications that do not expose such an interface. The closed discover-to-rotate-to-revoke lifecycle 1626 illustrates an operational loop in which discovery, rotation, verification and revocation, and aggregation are coordinated by an artificial intelligence agent system 1630.

In a producer with native API scenario 1604, a producer application 1606 exposes a graphical user interface 1608 and a programmatic credential management API 1610. The graphical user interface 1608 may render credential management surfaces through which API credentials are generated, listed, inspected, or revoked. The graphical user interface 1608 may further render a multi-factor authentication input element 1612 through which a multi-factor authentication challenge is presented during a credential lifecycle operation. The multi-factor authentication input element 1612 may be handled by the credential lifecycle system 400 in accordance with the multi-factor authentication handling pipeline 1100.

In the producer with native API scenario 1604, the credential lifecycle system 400 may perform credential lifecycle operations through the programmatic credential management API 1610, through actuation of the graphical user interface 1608 by an artificial intelligence agent system, or through a combination thereof. In one or more implementations, the credential lifecycle system 400 selects between use of the programmatic credential management API 1610 and use of graphical user interface actuation based on availability of the programmatic credential management API 1610, coverage of the programmatic credential management API 1610 for a requested credential operation, administrative policy, authentication requirements, verification requirements, or operational state of the producer application 1606.

In a producer without native API scenario 1614, a producer application 1616 exposes a graphical user interface 1620 for credential lifecycle operations. A programmatic credential management API 1618 may be absent, unavailable, incomplete, or not exposed for one or more credential lifecycle operations. Conventional credential management tools fail 1622 represents the condition in which conventional tools that depend on a native programmatic credential management API are unable to complete, or are limited in completing, credential lifecycle operations against the producer application 1616. A disclosed system 1624, which may be implemented as the credential lifecycle system 400, performs credential lifecycle operations against the producer application 1616 through the graphical user interface 1620.

In the producer without native API scenario 1614, the disclosed system 1624 may apply a multi-modal large language model to content rendered in the graphical user interface 1620 to derive API credential metadata attributes, identify a credential-displaying region, identify a credential-generation interface element, identify a revocation control, or identify another credential lifecycle interface element. The disclosed system 1624 may then generate an actuation instruction and cause an interface automation component to perform a simulated graphical user interface interaction at the graphical user interface 1620. In this manner, the disclosed system 1624 performs credential lifecycle operations even when the producer application 1616 does not expose a programmatic credential management API usable for those operations.

The producer application scenarios 1602 illustrate that the credential lifecycle system 400 is operable across heterogeneous producer applications. For producer applications that expose a programmatic credential management API, the credential lifecycle system 400 may use the programmatic credential management API, graphical user interface actuation, or both. For producer applications that lack a usable programmatic credential management API, the credential lifecycle system 400 may perform credential lifecycle operations through graphical user interface perception and actuation.

The closed discover-to-rotate-to-revoke lifecycle 1626 comprises a discover stage 1628, a rotate stage 1632, a verify and revoke stage 1634, an aggregate stage 1636, and the artificial intelligence agent system 1630. The artificial intelligence agent system 1630 is operably associated with each of the discover stage 1628, the rotate stage 1632, the verify and revoke stage 1634, and the aggregate stage 1636, and coordinates performance of credential lifecycle operations across the stages.

In the discover stage 1628, the artificial intelligence agent system 1630 processes content rendered in a graphical user interface of a producer application to discover one or more API credentials and to derive API credential metadata attributes associated with the one or more API credentials. The discover stage 1628 may include capture of rendered graphical user interface content, detection of credential-displaying regions, classification of credential-related interface elements, extraction of credential identifiers or obfuscated representations, and derivation of metadata such as creation timestamp, issuer, issuer status, scope, last-used timestamp, access type, or credential status.

In the rotate stage 1632, the artificial intelligence agent system 1630 initiates or performs rotation of an API credential. The rotate stage 1632 may include generating a new API credential at a producer application, capturing the new API credential from a transient display, storing the new API credential in encrypted form, identifying a set of consumer applications associated with the credential through a dependency mapping component, and propagating the new API credential to one or more consumer applications.

In the verify and revoke stage 1634, the artificial intelligence agent system 1630 verifies integration of the new API credential at the consumer applications to which the new API credential has been propagated. Verification may be performed through a test request, inspection of a rendered graphical user interface state, reading of a programmatic status indicator, or another verification operation. Upon successful verification, the artificial intelligence agent system 1630 may revoke a prior API credential at the producer application. Upon unsuccessful verification, the artificial intelligence agent system 1630 may initiate a rollback sequence to restore a prior credential state.

In the aggregate stage 1636, the artificial intelligence agent system 1630 aggregates credential lifecycle information generated during the discover stage 1628, the rotate stage 1632, and the verify and revoke stage 1634. The aggregated credential lifecycle information may include API credential metadata attributes, propagation status, verification status, event log data, audit records, dependency mapping updates, or dashboard information. The aggregate stage 1636 may further support governance review, compliance filtering, audit record generation, and initiation of subsequent discovery or rotation operations based on updated credential lifecycle state.

The closed discover-to-rotate-to-revoke lifecycle 1626 may operate as a closed operational loop. In one or more implementations, the discover stage 1628 supplies discovered credential metadata to the rotate stage 1632 when a rotation condition is detected. The rotate stage 1632 supplies propagation and credential replacement information to the verify and revoke stage 1634. The verify and revoke stage 1634 supplies verification, revocation, and rollback results to the aggregate stage 1636. The aggregate stage 1636 stores, summarizes, or reports the resulting credential lifecycle state and may provide updated state for a subsequent discover stage 1628.

In one or more implementations, the closed discover-to-rotate-to-revoke lifecycle 1626 is performed without requiring an external scheduler, a separate policy engine, or a human administrator queue between adjacent lifecycle stages. In such implementations, the artificial intelligence agent system 1630 detects credential lifecycle conditions from rendered graphical user interface content, initiates rotation of an API credential, verifies propagation to consumer applications, revokes a prior API credential when verification succeeds, performs rollback when verification fails, and aggregates resulting credential lifecycle state for governance and audit purposes.

The producer application scenarios 1602 and the closed discover-to-rotate-to-revoke lifecycle 1626 together illustrate that the credential lifecycle system 400 is configured to perform credential lifecycle operations across producer applications having different interface capabilities. The credential lifecycle system 400 may operate with producer applications that expose a native programmatic credential management API and with producer applications that rely on graphical user interface-based credential management, while coordinating discovery, rotation, verification and revocation, and aggregation through the artificial intelligence agent system 1630.

### Artificial Intelligence System Implementation

The foregoing description, with reference to FIG. 4 through FIG. 16, has set out the architectural components, the operational mechanisms, and the lifecycle stages of the credential lifecycle system 400. The credential lifecycle system 400 is implemented through an artificial intelligence architecture comprising a multi-modal large language model and a computer vision component cooperatively operating on rendered visual and textual content of graphical user interfaces of producer applications and consumer applications. The multi-modal large language model is implemented through one or more neural network architectures configured to receive multi-modal inputs comprising pixel-level representations of rendered content together with textual content extracted from the rendered content, and to produce a plurality of functional outputs comprising region classifications, interface element identifications, metadata attribute derivations, non-compliance condition detections, and actuation instructions executable by the interface automation component.

The artificial intelligence architecture through which the multi-modal large language model is implemented comprises an encoder-decoder framework operative on token sequences derived from the rendered content, an attention mechanism through which contextual relationships among tokens of the token sequences are evaluated, a self-attention computation through which a representation of each token of the token sequence is computed in dependence on a representation of every other token of the token sequence, a multi-head attention computation through which the self-attention computation is parallelized across a plurality of attention heads operating on a plurality of representation subspaces, a transformer encoder layer through which the multi-head attention computation is composed with a feed-forward computation and a layer normalization operation to produce a contextualized representation of the token sequence, a transformer model through which a plurality of transformer encoder layers and a plurality of transformer decoder layers are composed to produce the functional outputs of the multi-modal large language model, a vision transformer architecture through which pixel-level representations of rendered content are processed by patching the pixel-level representations into a sequence of flattened patches, projecting the sequence of flattened patches through a linear projection, augmenting the sequence with a positional embedding and a learnable class embedding, and propagating the augmented sequence through the transformer encoder layers to produce a class label representation operative as a region classification or an interface element identification, and an example software implementation through which the foregoing computations are realized in executable form.

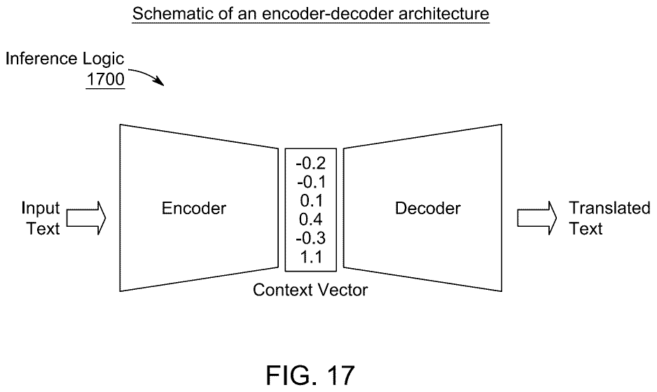

The inference logic 1700 operative within the multi-modal large language model of the credential lifecycle system 400, comprising the foregoing architectural elements, is described in further detail with reference to FIG. 17 through FIG. 26.

Some implementations of the technology disclosed relate to using a Transformer model to provide an AI system. In particular, the technology disclosed proposes a parallel input, parallel output (PIPO) AI system based on the Transformer architecture. The Transformer model relies on a self-attention mechanism to compute a series of context-informed vector-space representations of elements in the input sequence and the output sequence, which are then used to predict distributions over subsequent elements as the model predicts the output sequence element-by-element. Not only is this mechanism straightforward to parallelize, but as each input's representation is also directly informed by all other inputs' representations, this results in an effectively global receptive field across the whole input sequence. This stands in contrast to, e.g., convolutional architectures which typically have a limited receptive field.

In one implementation, the disclosed AI system is a multilayer perceptron (MLP). In another implementation, the disclosed AI system is a feedforward neural network. In yet another implementation, the disclosed AI system is a fully connected neural network. In a further implementation, the disclosed AI system is a fully convolution neural network. In a yet further implementation, the disclosed AI system is a semantic segmentation neural network. In a yet another further implementation, the disclosed AI system is a generative adversarial network (GAN) (e.g., CycleGAN, StyleGAN, pixelRNN, text-2-image, DiscoGAN, IsGAN). In a yet another implementation, the disclosed AI system includes self-attention mechanisms like Transformer, Vision Transformer (ViT), Bidirectional Transformer (BERT), Detection Transformer (DETR), Deformable DETR, UP-DETR, DeiT, Swin, GPT, iGPT, GPT-2, GPT-3, various ChatGPT versions, various LLAMA versions, BERT, SpanBERT, ROBERTa, XLNet, ELECTRA, UniLM, BART, T5, ERNIE (THU), KnowBERT, DeiT-Ti, DeiT-S, DeiT-B, T2T-ViT-14, T2T-ViT-19, T2T-ViT-24, PVT-Small, PVT-Medium, PVT-Large, TNT-S, TNT-B, CPVT-S, CPVT-S-GAP, CPVT-B, Swin-T, Swin-S, Swin-B, Twins-SVT-S, Twins-SVT-B, Twins-SVT-L, Shuffle-T, Shuffle-S, Shuffle-B, XCiT-S12/16, CMT-S, CMT-B, VOLO-D1, VOLO-D2, VOLO-D3, VOLO-D4, MoCo v3, ACT, TSP, Max-DeepLab, VisTR, SETR, Hand-Transformer, HOT-Net, METRO, Image Transformer, Taming transformer, TransGAN, IPT, TTSR, STTN, Masked Transformer, CLIP, DALL-E, Cogview, UniT, ASH, TinyBert, FullyQT, ConvBert, FCOS, Faster R-CNN+FPN, DETR-DC5, TSP-FCOS, TSP-RCNN, ACT+MKDD (L=32), ACT+MKDD (L=16), SMCA, Efficient DETR, UP-DETR, UP-DETR, ViTB/16-FRCNN, ViT-B/16-FRCNN, PVT-Small+RetinaNet, Swin-T+RetinaNet, Swin-T+ATSS, PVT-Small+DETR, TNT-S+DETR, YOLOS-Ti, YOLOS-S, and YOLOS-B.

In one implementation, the disclosed AI system is a convolution neural network (CNN) with a plurality of convolution layers. In another implementation, the disclosed AI system is a recurrent neural network (RNN) such as a long short-term memory network (LSTM), bi-directional LSTM (Bi-LSTM), or a gated recurrent unit (GRU). In yet another implementation, the disclosed AI system includes both a CNN and an RNN.

In yet other implementations, the disclosed AI system can use 1D convolutions, 2D convolutions, 3D convolutions, 4D convolutions, 5D convolutions, dilated or atrous convolutions, transpose convolutions, depthwise separable convolutions, pointwise convolutions, 1×1 convolutions, group convolutions, flattened convolutions, spatial and cross-channel convolutions, shuffled grouped convolutions, spatial separable convolutions, and deconvolutions. The disclosed AI system can use one or more loss functions such as logistic regression/log loss, multi-class cross-entropy/softmax loss, binary cross-entropy loss, mean-squared error loss, L1 loss, L2 loss, smooth L1 loss, and Huber loss. The disclosed AI system can use any parallelism, efficiency, and compression schemes such TFRecords, compressed encoding (e.g., PNG), sharding, parallel calls for map transformation, batching, prefetching, model parallelism, data parallelism, and synchronous/asynchronous stochastic gradient descent (SGD). The disclosed AI system can include upsampling layers, downsampling layers, recurrent connections, gates and gated memory units (like an LSTM or GRU), residual blocks, residual connections, highway connections, skip connections, peephole connections, activation functions (e.g., non-linear transformation functions like rectifying linear unit (ReLU), leaky ReLU, exponential liner unit (ELU), sigmoid and hyperbolic tangent (tanh)), batch normalization layers, regularization layers, dropout, pooling layers (e.g., max or average pooling), global average pooling layers, and attention mechanisms.

The disclosed AI system can be a linear regression model, a logistic regression model, an Elastic Net model, a support vector machine (SVM), a random forest (RF), a decision tree, and a boosted decision tree (e.g., XGBoost), or some other tree-based logic (e.g., metric trees, kd-trees, R-trees, universal B-trees, X-trees, ball trees, locality sensitive hashes, and inverted indexes). The disclosed AI system can be an ensemble of multiple models, in some implementations.

In some implementations, the disclosed AI system can be trained using backpropagation-based gradient update techniques. Example gradient descent techniques that can be used for training the disclosed AI system include stochastic gradient descent, batch gradient descent, and mini-batch gradient descent. Some examples of gradient descent optimization algorithms that can be used to train the disclosed AI system are Momentum, Nesterov accelerated gradient, Adagrad, Adadelta, RMSprop, Adam, AdaMax, Nadam, and AMSGrad.

### Transformer Logic

Machine learning is the use and development of computer systems that can learn and adapt without following explicit instructions, by using algorithms and statistical models to analyze and draw inferences from patterns in data. Some of the state-of-the-art models use Transformers, a more powerful and faster model than neural networks alone. Transformers originate from the field of natural language processing (NLP), but can be used in computer vision and many other fields. Neural networks process input in series and weight relationships by distance in the series. Transformers can process input in parallel and do not necessarily weigh by distance. For example, in natural language processing, neural networks process a sentence from beginning to end with the weights of words close to each other being higher than those further apart. This leaves the end of the sentence very disconnected from the beginning causing an effect called the vanishing gradient problem. Transformers look at each word in parallel and determine weights for the relationships to each of the other words in the sentence. These relationships are called hidden states because they are later condensed for use into one vector called the context vector. Transformers can be used in addition to neural networks. This architecture is described here.

### Encoder-Decoder Architecture

FIG. 17 is a schematic representation of an encoder-decoder architecture. This architecture is often used for NLP and has two main building blocks. The first building block is the encoder that encodes an input into a fixed-size vector. In the system we describe here, the encoder is based on a recurrent neural network (RNN). At each time step, t, a hidden state of time step, t−1, is combined with the input value at time step t to compute the hidden state at timestep t. The hidden state at the last time step, encoded in a context vector, contains relationships encoded at all previous time steps. For NLP, each step corresponds to a word. Then the context vector contains information about the grammar and the sentence structure. The context vector can be considered a low-dimensional representation of the entire input space. For NLP, the input space is a sentence, and a training set consists of many sentences.

The context vector is then passed to the second building block, the decoder. For translation, the decoder has been trained on a second language. Conditioned on the input context vector, the decoder generates an output sequence. At each time step, t, the decoder is fed the hidden state of time step, t−1, and the output generated at time step, t−1. The first hidden state in the decoder is the context vector, generated by the encoder. The context vector is used by the decoder to perform the translation.

The whole model is optimized end-to-end by using backpropagation, a method of training a neural network in which the initial system output is compared to the desired output and the system is adjusted until the difference is minimized. In backpropagation, the encoder is trained to extract the right information from the input sequence, the decoder is trained to capture the grammar and vocabulary of the output language. This results in a fluent model that uses context and generalizes well. When training an encoder-decoder model, the real output sequence is used to train the model to prevent mistakes from stacking. When testing the model, the previously predicted output value is used to predict the next one.

When performing a translation task using the encoder-decoder architecture, all information about the input sequence is forced into one vector, the context vector. Information connecting the beginning of the sentence with the end is lost, the vanishing gradient problem. Also, different parts of the input sequence are important for different parts of the output sequence, information that cannot be learned using RNNs in an encoder-decoder architecture.

### Attention Mechanism

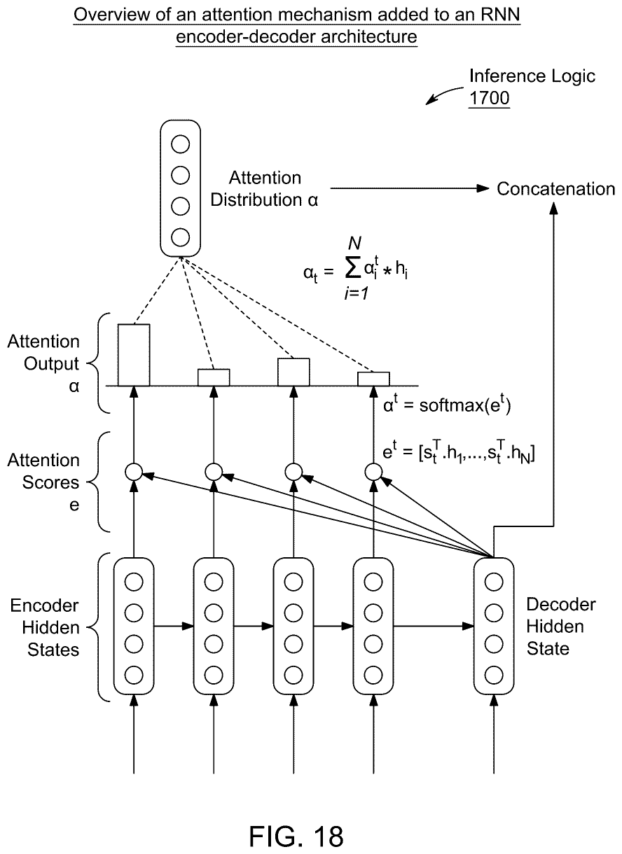

Attention mechanisms distinguish Transformers from other machine learning models. The attention mechanism provides a solution for the vanishing gradient problem. FIG. 18 shows an overview of an attention mechanism added onto an RNN encoder-decoder architecture. At every step, the decoder is given an attention score, e, for each encoder hidden state. In other words, the decoder is given weights for each relationship between words in a sentence. The decoder uses the attention score concatenated with the context vector during decoding. The output of the decoder at time step t is based on all encoder hidden states and the attention outputs. The attention output captures the relevant context for time step t from the original sentence. Thus, words at the end of a sentence may now have a strong relationship with words at the beginning of the sentence. In the sentence “The quick brown fox, upon arriving at the doghouse, jumped over the lazy dog,” fox and dog can be closely related despite being far apart in this complex sentence.

To weight encoder hidden states, a dot product between the decoder hidden state of the current time step, and all encoder hidden states, is calculated. This results in an attention score for every encoder hidden state. The attention scores are higher for those encoder hidden states that are similar to the decoder hidden state of the current time step. Higher values for the dot product indicate the vectors are pointing more closely in the same direction. The attention scores are converted to fractions that sum to one using the SoftMax function.

The SoftMax scores provide an attention distribution. The x-axis of the distribution is position in a sentence. The y-axis is attention weight. The scores show which encoder hidden states are most closely related. The SoftMax scores specify which encoder hidden states are the most relevant for the decoder hidden state of the current time step.

The elements of the attention distribution are used as weights to calculate a weighted sum over the different encoder hidden states. The outcome of the weighted sum is called the attention output. The attention output is used to predict the output, often in combination (concatenation) with the decoder hidden states. Thus, both information about the inputs, as well as the already generated outputs, can be used to predict the next outputs.

By making it possible to focus on specific parts of the input in every decoder step, the attention mechanism solves the vanishing gradient problem. By using attention, information flows more directly to the decoder. It does not pass through many hidden states. Interpreting the attention step can give insights into the data. Attention can be thought of as a soft alignment. The words in the input sequence with a high attention score align with the current target word. Attention describes long-range dependencies better than RNN alone. This enables analysis of longer, more complex sentences.

The attention mechanism can be generalized as: given a set of vector values and a vector query, attention is a technique to compute a weighted sum of the vector values, dependent on the vector query. The vector values are the encoder hidden states, and the vector query is the decoder hidden state at the current time step.

The weighted sum can be considered a selective summary of the information present in the vector values. The vector query determines on which of the vector values to focus. Thus, a fixed-size representation of the vector values can be created, in dependence upon the vector query.

The attention scores can be calculated by the dot product, or by weighing the different values (multiplicative attention).

### Embeddings

For most machine learning models, the input to the model needs to be numerical. The input to a translation model is a sentence, and words are not numerical. multiple methods exist for the conversion of words into numerical vectors. These numerical vectors are called the embeddings of the words. Embeddings can be used to convert any type of symbolic representation into a numerical one.

Embeddings can be created by using one-hot encoding. The one-hot vector representing the symbols has the same length as the total number of possible different symbols. Each position in the one-hot vector corresponds to a specific symbol. For example, when converting colors to a numerical vector, the length of the one-hot vector would be the total number of different colors present in the dataset. For each input, the location corresponding to the color of that value is one, whereas all the other locations are valued at zero. This works well for working with images. For NLP, this becomes problematic, because the number of words in a language is very large. This results in enormous models and the need for a lot of computational power. Furthermore, no specific information is captured with one-hot encoding. From the numerical representation, it is not clear that orange and red are more similar than orange and green. For this reason, other methods exist.

A second way of creating embeddings is by creating feature vectors. Every symbol has its specific vector representation, based on features. With colors, a vector of three elements could be used, where the elements represent the amount of yellow, red, and/or blue needed to create the color. Thus, all colors can be represented by using a vector of three elements. Also, similar colors have similar representation vectors.

For NLP, embeddings based on context, as opposed to words, are small and can be trained. The reasoning behind this concept is that words with similar meanings occur in similar contexts. Different methods take the context of words into account. Some methods, like GloVe, base their context embedding on co-occurrence statistics from corpora (large texts) such as Wikipedia. Words with similar co-occurrence statistics have similar word embeddings. Other methods use neural networks to train the embeddings. For example, they train their embeddings to predict the word based on the context (Common Bag of Words), and/or to predict the context based on the word (Skip-Gram). Training these contextual embeddings is time intensive. For this reason, pre-trained libraries exist. Other deep learning methods can be used to create embeddings. For example, the latent space of a variational autoencoder (VAE) can be used as the embedding of the input. Another method is to use 1D convolutions to create embeddings. This causes a sparse, high-dimensional input space to be converted to a denser, low-dimensional feature space.

### Self-Attention: Queries (Q), Keys (K), Values (V)

Transformer models are based on the principle of self-attention. Self-attention allows each element of the input sequence to look at all other elements in the input sequence and search for clues that can help it to create a more meaningful encoding. It is a way to look at which other sequence elements are relevant for the current element. The Transformer can grab context from both before and after the currently processed element.

When performing self-attention, three vectors need to be created for each element of the encoder input: the query vector (Q), the key vector (K), and the value vector (V). These vectors are created by performing matrix multiplications between the input embedding vectors using three unique weight matrices.

After this, self-attention scores are calculated. When calculating self-attention scores for a given element, the dot products between the query vector of this element and the key vectors of all other input elements are calculated. To make the model mathematically more stable, these self-attention scores are divided by the root of the size of the vectors. This has the effect of reducing the importance of the scalar thus emphasizing the importance of the direction of the vector. Just as before, these scores are normalized with a SoftMax layer. This attention distribution is then used to calculate a weighted sum of the value vectors, resulting in a vector z for every input element. In the attention principle explained above, the vector to calculate attention scores and to perform the weighted sum was the same, in self-attention two different vectors are created and used. As the self-attention needs to be calculated for all elements (thus a query for every element), one formula can be created to calculate a Z matrix. The rows of this Z matrix are the z vectors for every sequence input element, giving the matrix a size length sequence dimension QKV.

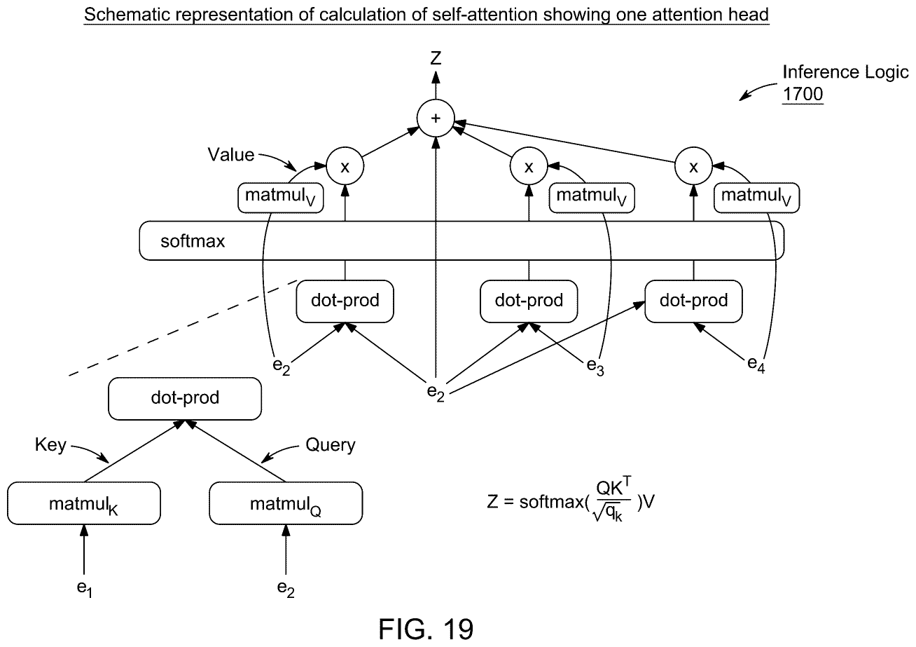

Multi-headed attention is executed in the Transformer. FIG. 19 is a schematic representation of the calculation of self-attention showing one attention head. For every attention head, different weight matrices are trained to calculate Q, K, and V. Every attention head outputs a matrix Z. Different attention heads can capture different types of information. The different Z matrices of the different attention heads are concatenated. This matrix can become large when multiple attention heads are used. To reduce dimensionality, an extra weight matrix W is trained to condense the different attention heads into a matrix with the same size as one Z matrix. This way, the amount of data given to the next step does not enlarge every time self-attention is performed.

When performing self-attention, information about the order of the different elements within the sequence is lost. To address this problem, positional encodings are added to the embedding vectors. Every position has its unique positional encoding vector. These vectors follow a specific pattern, which the Transformer model can learn to recognize. This way, the model can consider distances between the different elements.

As discussed above, in the core of self-attention are three objects: queries (Q), keys (K), and values (V). Each of these objects has an inner semantic meaning of their purpose. One can think of these as analogous to databases. We have a user-defined query of what the user wants to know. Then we have the relations in the database, i.e., the values which are the weights. More advanced database management systems create some apt representation of its relations to retrieve values more efficiently from the relations. This can be achieved by using indexes, which represent information about what is stored in the database. In the context of attention, indexes can be thought of as keys. So instead of running the query against values directly, the query is first executed on the indexes to retrieve where the relevant values or weights are stored. Lastly, these weights are run against the original values to retrieve data that is most relevant to the initial query.

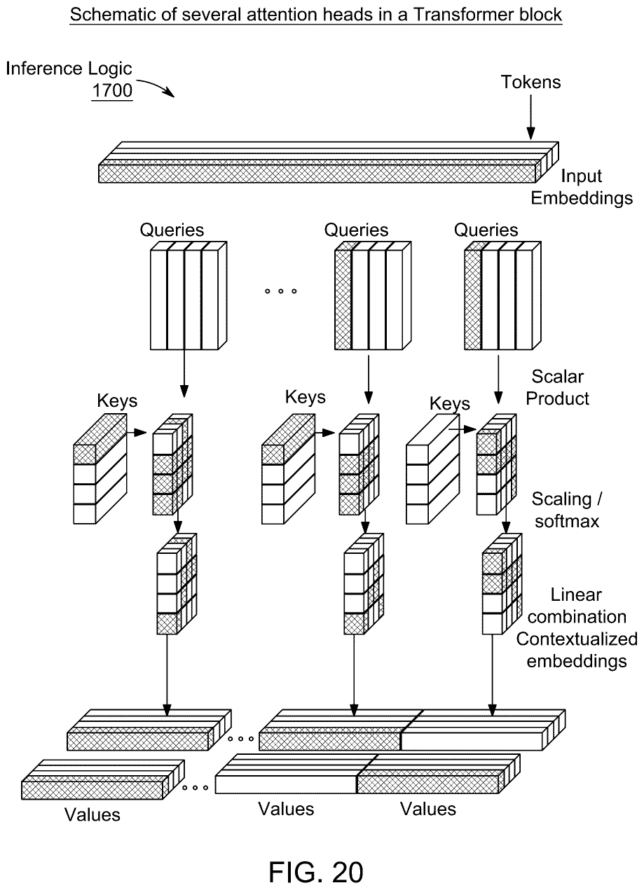

FIG. 20 depicts several attention heads in a Transformer block. We can see that the outputs of queries and keys dot products in different attention heads are differently colored. This depicts the capability of the multi-head attention to focus on different aspects of the input and aggregate the obtained information by multiplying the input with different attention weights.

Examples of attention calculation include scaled dot-product attention and additive attention. There are several reasons why scaled dot-product attention is used in the Transformers. Firstly, the scaled dot-product attention is relatively fast to compute, since its main parts are matrix operations that can be run on modern hardware accelerators. Secondly, it performs similarly well for smaller dimensions of the K matrix, dk, as the additive attention. For larger dk, the scaled dot-product attention performs a bit worse because dot products can cause the vanishing gradient problem. This is compensated via the scaling factor, which is defined as \sqrt{dk}.

As discussed above, the attention function takes as input three objects: key, value, and query. In the context of Transformers, these objects are matrices of shapes (n, d), where n is the number of elements in the input sequence and d is the hidden representation of each element (also called the hidden vector). Attention is then computed as:

$$Attention ( Q , K , V ) = Soft Max ( \frac{{QK}^{T}}{\sqrt{dk}} ) V$$

where Q, K, V are computed as:

X·W_{Q},X·W_{K},X·W_{V}

X is the input matrix and W_{Q}, W_{K}, W_{V} are learned weights to project the input matrix into the representations. The dot products appearing in the attention function are exploited for their geometrical interpretation where higher values of their results mean that the inputs are more similar, i.e., pointing in the geometrical space in the same direction. Since the attention function now works with matrices, the dot product becomes matrix multiplication. The SoftMax function is used to normalize the attention weights into the value of 1 prior to being multiplied by the values matrix. The resulting matrix is used either as input into another layer of attention or becomes the output of the Transformer.

### Multi-Head Attention

Transformers become even more powerful when multi-head attention is used. Queries, keys, and values are computed the same way as above, though they are now projected into h different representations of smaller dimensions using a set of h learned weights. Each representation is passed into a different scaled dot-product attention block called a head. The head then computes its output using the same procedure as described above.

Formally, the multi-head attention is defined as:

$$MultiHeadAttention ( Q , K , V ) = [ {head}_{1} , … , {head}_{h} ] {W}_{0} where {head}_{i} = Attention ( {QW}_{i}^{Q} , {KW}_{i}^{K} , {VW}_{i}^{V} )$$

The outputs of all heads are concatenated together and projected again using the learned weights matrix W₀ to match the dimensions expected by the next block of heads or the output of the Transformer. Using the multi-head attention instead of the simpler scaled dot-product attention enables Transformers to jointly attend to information from different representation subspaces at different positions.

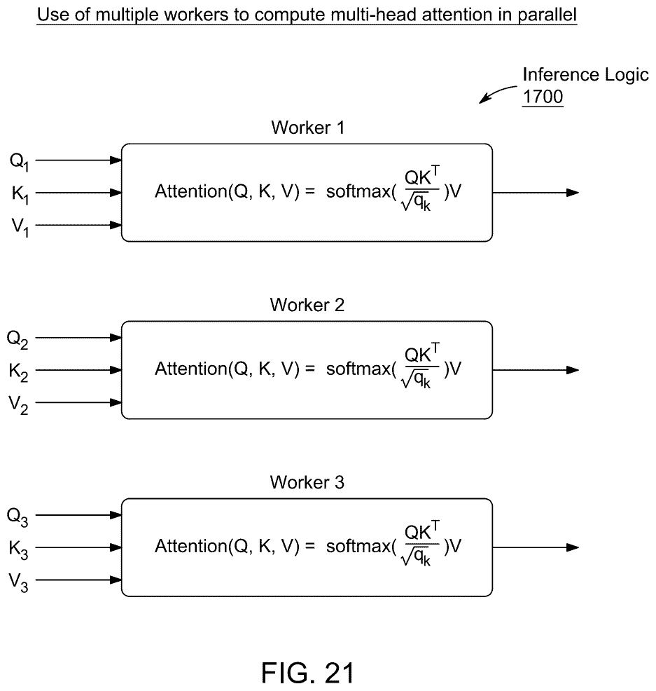

As shown in FIG. 21, one can use multiple workers to compute the multi-head attention in parallel, as the respective heads compute their outputs independently of one another. Parallel processing is one of the advantages of Transformers over RNNs.

Assuming the naive matrix multiplication algorithm which has a complexity of:

a·b·c

For matrices of shape (a, b) and (c, d), to obtain values Q, K, V, we need to compute the operations:

X·W_{Q},X·W_{K},X·WV

The matrix X is of shape (n, d) where n is the number of patches and dis the hidden vector dimension. The weights W_{Q}, W_{K}, W_{V} are all of shape (d, d). Omitting the constant factor 3, the resulting complexity is:

n·d²

We can proceed to the estimation of the complexity of the attention function itself, i.e., of

$$Soft Max ( \frac{{QK}^{T}}{\sqrt{dk}} ) V .$$

The matrices Q and K are both of shape (n, d). The transposition operation does not influence the asymptotic complexity of computing the dot product of matrices of shapes (n, d)·(d, n), therefore its complexity is:

n²·d

Scaling by a constant factor of \sqrt{dk}, where dk is the dimension of the keys vector, as well as applying the SoftMax function, both have the complexity of a·b for a matrix of shape (a, b), hence they do not influence the asymptotic complexity. Lastly the dot product

$$Soft Max ( \frac{{QK}^{T}}{\sqrt{dk}} ) \cdot V$$

is between matrices of shapes (n, n) and (n, d) and so its complexity is:

n²·d

The final asymptotic complexity of scaled dot-product attention is obtained by summing the complexities of computing Q, K, V, and of the following attention function:

n·d²+n²·d.

The asymptotic complexity of multi-head attention is the same since the original input matrix X is projected into h matrices of shapes

$$( n , \frac{d}{h} ) ,$$

where n is the number of heads. From the point of view of asymptotic complexity, h is constant, therefore we would arrive at the same estimate of asymptotic complexity using a similar approach as for the scaled dot-product attention.

Transformer models often have the encoder-decoder architecture, although this is not necessarily the case. The encoder is built out of different encoder layers which are all constructed in the same way. The positional encodings are added to the embedding vectors. Afterward, self-attention is performed.

### Encoder Block of Transformer

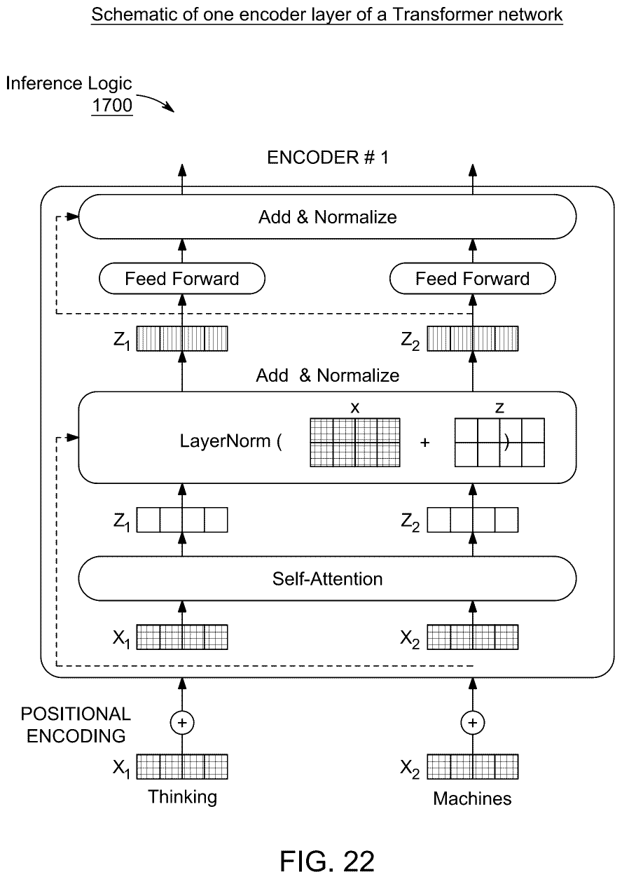

FIG. 22 portrays one encoder layer of a Transformer network. Every self-attention layer is surrounded by a residual connection, summing up the output and input of the self-attention. This sum is normalized, and the normalized vectors are fed to a feed-forward layer. Every z vector is fed separately to this feed-forward layer. The feed-forward layer is wrapped in a residual connection and the outcome is normalized too. Often, numerous encoder layers are piled to form the encoder. The output of the encoder is a fixed-size vector for every element of the input sequence.

Just like the encoder, the decoder is built from different decoder layers. In the decoder, a modified version of self-attention takes place. The query vector is compared to the keys of previous output sequence elements. The elements further in the sequence are not known yet, as they still must be predicted. No information about these output elements may be used.

### Encoder-Decoder Blocks of Transformer

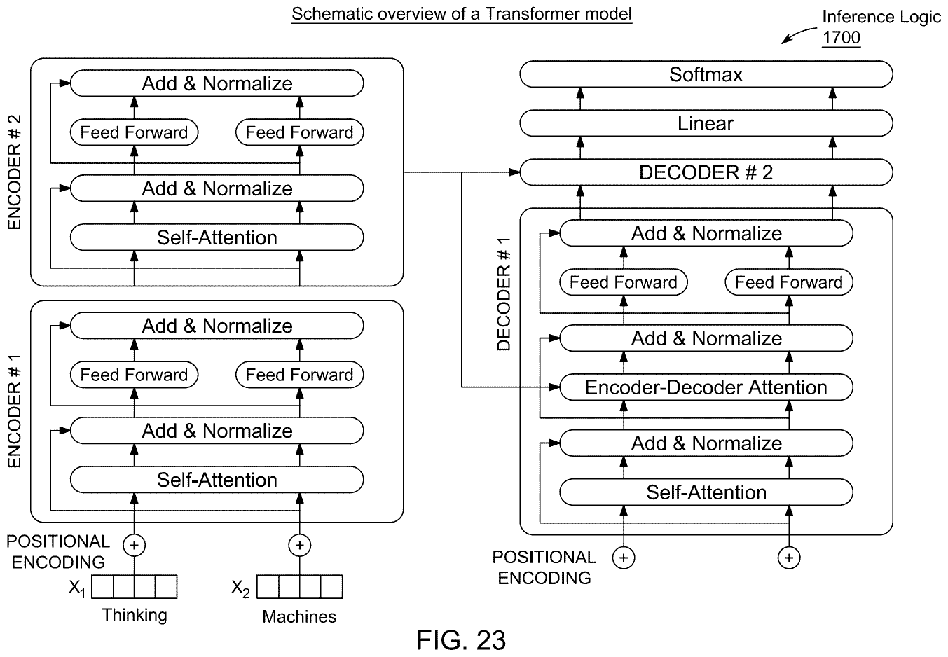

FIG. 23 shows a schematic overview of a Transformer model. Next to a self-attention layer, a layer of encoder-decoder attention is present in the decoder, in which the decoder can examine the last Z vectors of the encoder, providing fluent information transmission. The ultimate decoder layer is a feed-forward layer. All layers are packed in a residual connection. This allows the decoder to examine all previously predicted outputs and all encoded input vectors to predict the next output. Thus, information from the encoder is provided to the decoder, which could improve the predictive capacity. The output vectors of the last decoder layer need to be processed to form the output of the entire system. This is done by a combination of a feed-forward layer and a SoftMax function. The output corresponding to the highest probability is the predicted output value for a subject time step.

For some tasks other than translation, an encoder is needed. This is true for both document classification and name entity recognition. In these cases, the encoded input vectors are the input of the feed-forward layer and the SoftMax layer. Transformer models have been extensively applied in different NLP fields, such as translation, document summarization, speech recognition, and named entity recognition. These models have applications in the field of biology as well for predicting protein structure and function and labeling DNA sequences.

### Vision Transformer

There are extensive applications of transformers in vision including popular recognition tasks (e.g., image classification, object detection, action recognition, and segmentation), generative modeling, multi-modal tasks (e.g., visual-question answering, visual reasoning, and visual grounding), video processing (e.g., activity recognition, video forecasting), low-level vision (e.g., image super-resolution, image enhancement, and colorization) and 3D analysis (e.g., point cloud classification and segmentation).

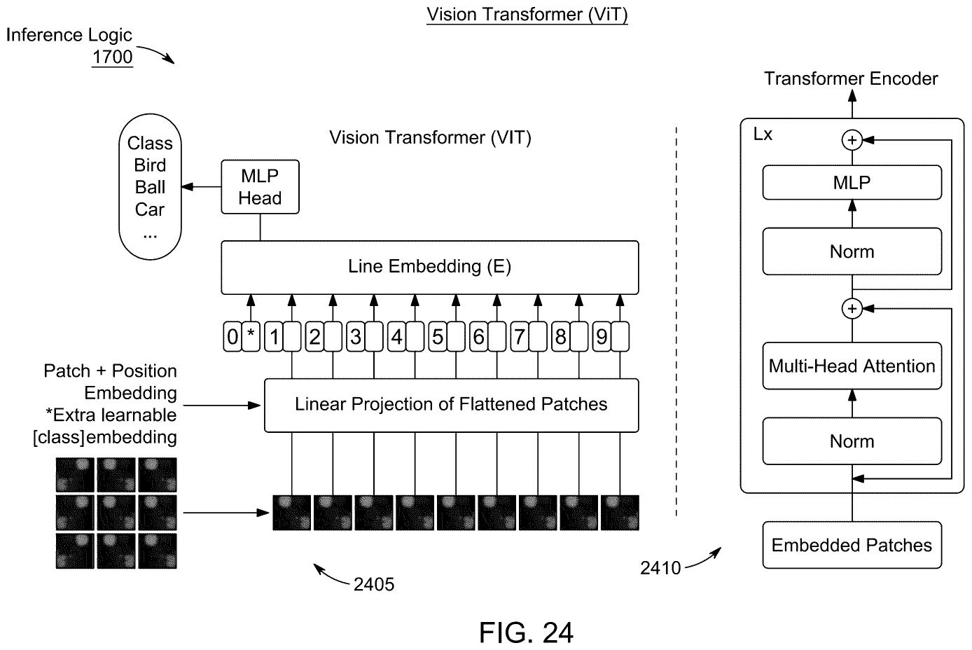

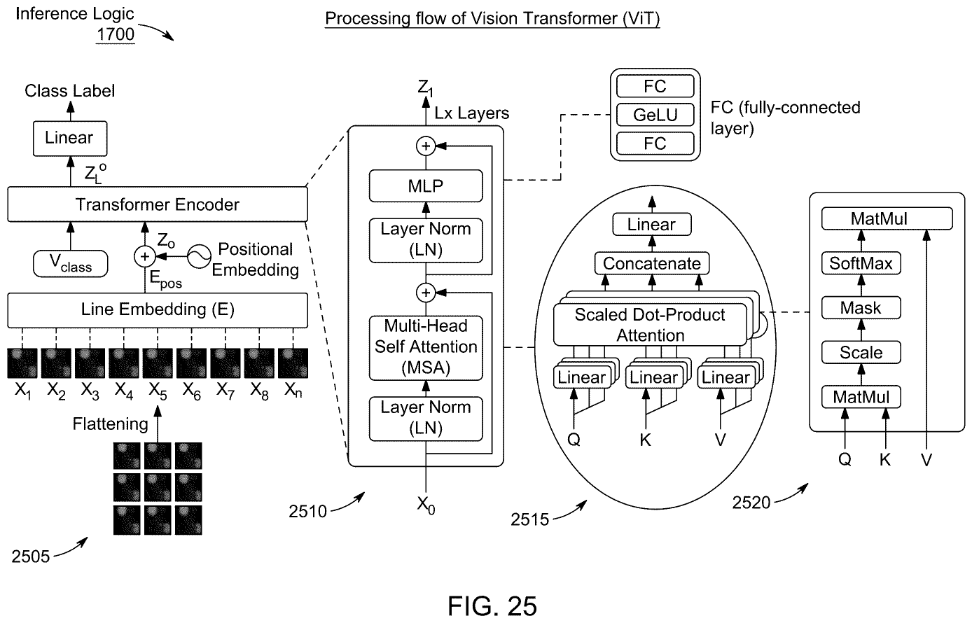

Transformers were originally developed for NLP and worked with sequences of words. In image classification, we often have a single input image in which the pixels are in a sequence. To reduce the computation required, Vision Transformers (ViTs) cut the input image into a set of fixed-sized patches of pixels. The patches are often 16×16 pixels. They are treated much like words in NLP Transformers. ViTs are depicted in FIG. 24 (2405, 2410), and FIG. 25 (2505, 2510, 2515, 2520). Unfortunately, important positional information is lost because image sets are position-invariant. This problem is solved by adding a learned positional encoding into the image patches.

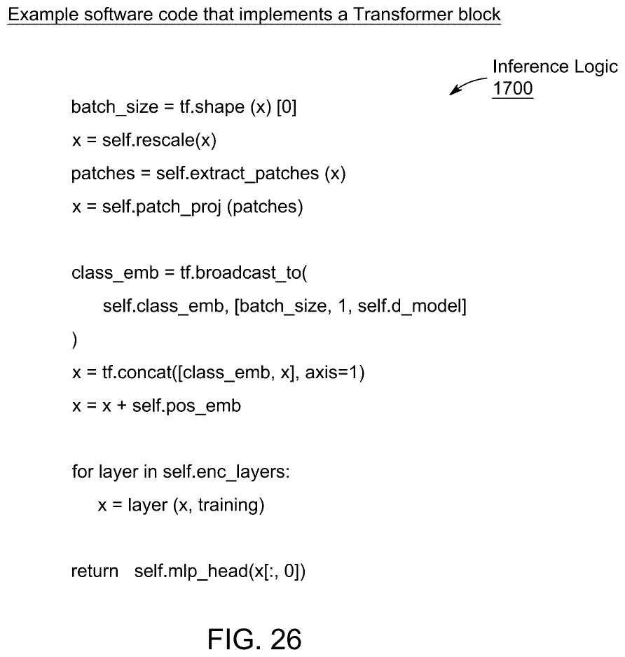

The computations of the ViT architecture can be summarized as follows. The first layer of a ViT extracts a fixed number of patches from an input image (2505). The patches are then projected to linear embeddings. A special class token vector is added to the sequence of embedding vectors to include all representative information of all tokens through the multi-layer encoding procedure. The class vector is unique to each image. Vectors containing positional information are combined with the embeddings and the class token. The sequence of embedding vectors is passed into the Transformer blocks. The class token vector is extracted from the output of the last Transformer block and is passed into a multilayer perceptron (MLP) head whose output is the final classification. The perceptron takes the normalized input and places the output in categories. It classifies the images. This procedure directly translates into the Python Keras code shown in FIG. 26.

When the input image is split into patches, a fixed patch size is specified before instantiating a ViT. Given the quadratic complexity of attention, patch size has a large effect on the length of training and inference time. A single Transformer block comprises several layers. The first layer implements Layer Normalization, followed by the multi-head attention that is responsible for the performance of ViTs. In the depiction of a Transformer block 2510, we can see two arrows. These are residual skip connections. Including skip connection data can simplify the output and improve the results. The output of the multi-head attention is followed again by Layer Normalization. And finally, the output layer is an MLP (Multi-Layer Perceptron) with the GELU (Gaussian Error Linear Unit) activation function.

ViTs can be pretrained and fine-tuned. Pretraining is generally done on a large dataset. Fine-tuning is done on a domain specific dataset.

Domain-specific architectures, like convolutional neural networks (CNNs) or long short-term memory networks (LSTMs), have been derived from the usual architecture of MLPs and suffer from so-called inductive biases that predispose the networks towards a certain output. ViTs stepped in the opposite direction of CNNs and LSTMs and became more general architectures by eliminating inductive biases. A ViT can be seen as a generalization of MLPs because MLPs, after being trained, do not change their weights for different inputs. On the other hand, ViTs compute their attention weights at runtime based on the particular input.

### Computer System

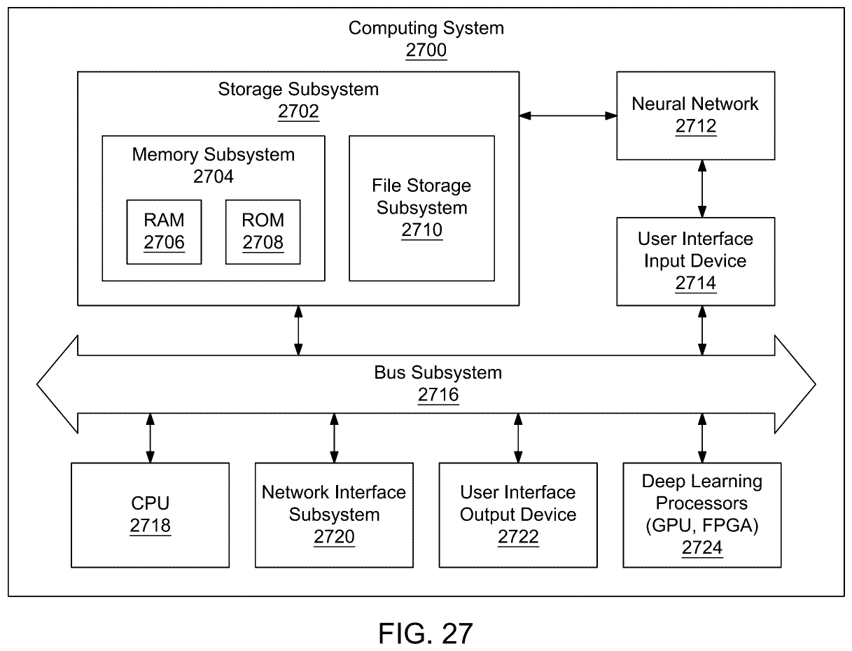

FIG. 27 shows an example computer system 2700 that can be used to implement the technology disclosed. The computer system 2700 is a representation of the system, as described in FIG. 4. The computer system 2700 includes at least one central processing unit (CPU) 2718 that communicates with a number of peripheral devices via bus subsystem 2716. These peripheral devices can include a storage subsystem 2702 including, for example, memory devices and a file storage subsystem 2710, user interface input devices 2714, user interface output devices 2722, and a network interface subsystem 2720. The input and output devices allow user interaction with computer system 2700. Network interface subsystem 2720 provides an interface to outside networks, including an interface to corresponding interface devices in other computer systems.

In one implementation, a neural network 2712 is communicably linked to the storage subsystem 2702 and the user interface input devices 2714.

User interface input devices 2714 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 2700.

User interface output devices 2722 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 2700 to the user or to another machine or computer system.

Storage subsystem 2702 stores programming and data constructs that provide the functionality of some or all of the modules and methods described herein. These software modules are generally executed by deep learning processors 2724.

Deep learning processors 2724 can be graphics processing units (GPUs), field-programmable gate arrays (FPGAs), application-specific integrated circuits (ASICs), and/or coarse-grained reconfigurable architectures (CGRAs). Processors 2724 can be hosted by a deep learning cloud platform such as Google Cloud Platform™, Xilinx™, and Cirrascale™ Examples of processors 2724 include Google's Tensor Processing Unit (TPU)™, rackmount solutions like GX4 Rackmount Series™, GX6 Rackmount Series™, NVIDIA DGX-1™, Microsoft's Stratix V FPGA™, Graphcore's Intelligent Processor Unit (IPU)™, Qualcomm's Zeroth Platform™ with Snapdragon Processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100S™, and others.

Memory subsystem 2704 used in the storage subsystem 2702 can include a number of memories including a main random-access memory (RAM) 2706 for storage of instructions and data during program execution and a read only memory (ROM) 2708 in which fixed instructions are stored. A file storage subsystem 2710 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 2710 in the storage subsystem 2702, or in other machines accessible by the processor.

Bus subsystem 2716 provides a mechanism for letting the various components and subsystems of computer system 2700 communicate with each other as intended. Although bus subsystem 2716 is shown schematically as a single bus, alternative implementations of the bus subsystem can use multiple buses.

Computer system 2700 itself can be of varying types including a personal computer, a portable computer, a workstation, a computer terminal, a network computer, a television, a mainframe, a server farm, a widely distributed set of loosely networked computers, or any other data processing system or user device. Due to the ever-changing nature of computers and networks, the description of computer system 2700 depicted in FIG. 27 is intended only as a specific example for the purpose of illustrating the preferred implementations of the present technology disclosed. Many other configurations of computer system 2700 are possible having more or fewer components than the computer system depicted in FIG. 27.

In various implementations, a learning system is provided. In some implementations, a feature vector is provided to a learning system. Based on the input features, the learning system generates one or more outputs. In some implementations, the output of the learning system is a feature vector. In some implementations, the learning system comprises an SVM. In other implementations, the learning system comprises an artificial neural network. In some implementations, the learning system is pre-trained using training data. In some implementations training data is retrospective data. In some implementations, the retrospective data is stored in a data store. In some implementations, the learning system may be additionally trained through manual curation of previously generated outputs.

In some implementations, an object detection pipeline is a trained classifier. In some implementations, the trained classifier is a random decision forest. However, it will be appreciated that a variety of other classifiers are suitable for use according to the present disclosure, including linear classifiers, support vector machines (SVM), or neural networks such as recurrent neural networks (RNN).

Suitable artificial neural networks include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer system/server may be described in the general context of computer system-executable instructions, such as program modules, being executed by a computer system. Generally, program modules may include routines, programs, objects, components, logic, data structures, and so on that perform particular tasks or implement particular abstract data types. Computer system/server may be practiced in distributed computing environments where tasks are performed by remote processing devices that are linked through a communications network. In a distributed computing environment, program modules may be located in both local and remote computer system storage media including memory storage devices.

As shown in FIG. 27, computer system/server in computing node is shown in the form of a general-purpose computing device. The components of computer system/server may include, but are not limited to, one or more processors or processing units, a system memory, and a bus that couples various system components including system memory to processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server typically includes a variety of computer system readable media. Such media may be any available media that is accessible by computer system/server, and it includes both volatile and non-volatile media, removable and non-removable media.

System memory can include computer system readable media in the form of volatile memory, such as random access memory (RAM) and/or cache memory. Algorithm Computer system/server may further include other removable/non-removable, volatile/non-volatile computer system storage media. By way of example only, storage system can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory may include at least one program product having a set (e.g., at least one) of program modules that are configured to carry out the functions of embodiments of the disclosure.

Program/utility, having a set (at least one) of program modules, may be stored in memory by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments as described herein.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The following detailed description is made with reference to the figures. Example implementations are described to illustrate the technology disclosed, not to limit its scope, which is defined by the claims. Those of ordinary skill in the art will recognize a variety of equivalent variations on the description that follows. Reference will now be made in detail to the exemplary implementations of the present disclosure, examples of which are illustrated in the accompanying drawings. Wherever possible, the same reference numbers will be used throughout the drawings to refer to the same or like parts.

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

The following detailed description is made with reference to the figures. Example implementations are described to illustrate the technology disclosed, not to limit its scope, which is defined by the claims. Those of ordinary skill in the art will recognize a variety of equivalent variations on the description that follows. Reference will now be made in detail to the exemplary implementations of the present disclosure, examples of which are illustrated in the accompanying drawings. Wherever possible, the same reference numbers will be used throughout the drawings to refer to the same or like parts.

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

The systems, devices, and methods disclosed herein are described in detail by way of examples and with reference to the figures. The examples discussed herein are examples and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The detailed description of various implementations will be better understood when read in conjunction with the appended drawings. To the extent that the figures illustrate diagrams of the functional blocks of the various implementations, the functional blocks are not necessarily indicative of the division between hardware circuitry. Thus, for example, one or more of the functional blocks (e.g., modules, processors, or memories) may be implemented in a single piece of hardware (e.g., a general-purpose signal processor or a block of random-access memory, hard disk, or the like) or multiple pieces of hardware. Similarly, the programs may be stand-alone programs, may be incorporated as subroutines in an operating system, may be functions in an installed software package, and the like. It should be understood that the various implementations are not limited to the arrangements and instrumentality shown in the drawings.

The processing engines and databases of the figures, designated as modules, can be implemented in hardware or software, and need not be divided up in precisely the same blocks as shown in the figures. Some of the modules can also be implemented on different processors, computers, or servers, or spread among a number of different processors, computers, or servers. In addition, it will be appreciated that some of the modules can be combined, operated in parallel or in a different sequence than that shown in the figures without affecting the functions achieved. The modules in the figures can also be thought of as flowchart steps in a method. A module also need not necessarily have all its code disposed contiguously in memory; some parts of the code can be separated from other parts of the code with code from other modules or other functions disposed in between.

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

One or more implementations and clauses of the technology disclosed, or elements thereof can be implemented in the form of a computer product, including a non-transitory computer readable storage medium with computer usable program code for performing the method steps indicated. Furthermore, one or more implementations and clauses of the technology disclosed, or elements thereof can be implemented in the form of an apparatus including a memory and at least one processor that is coupled to the memory and operative to perform exemplary method steps. Yet further, in another aspect, one or more implementations and clauses of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

The clauses described in this section can be combined as features. In the interest of conciseness, the combinations of features are not individually enumerated and are not repeated with each base set of features. The reader will understand how features identified in the clauses described in this section can readily be combined with sets of base features identified as implementations in other sections of this application. These clauses are not meant to be mutually exclusive, exhaustive, or restrictive; and the technology disclosed is not limited to these clauses but rather encompasses all possible combinations, modifications, and variations within the scope of the claimed technology and its equivalents.

Other implementations of the clauses described in this section can include a non-transitory computer readable storage medium storing instructions executable by a processor to perform any of the clauses described in this section. Yet another implementation of the clauses described in this section can include a system including memory and one or more processors operable to execute instructions, stored in the memory, to perform any of the clauses described in this section.

### CLAUSES

1. A system for autonomous lifecycle management of application programming interface (API) credentials across a plurality of applications, the system comprising:
   a processor;
   a memory storing computer-executable instructions which, when executed by the processor, configure the system to:
      access a user interface of at least one application using a set of credentials upon receiving a trigger from an agent command system;
      identify, by an Artificial Intelligence agent system applying a multi-modal large language model to content rendered in a graphical user interface of the at least one application, one or more API credential containers within the user interface, the Artificial Intelligence agent system being configured to classify a region of the user interface as a credential-displaying region and to derive therefrom a plurality of API credential metadata attributes;
      store the plurality of API credential metadata attributes and at least one API credential in a centralized credential vault;
      identify, based on the plurality of API credential metadata attributes, a set of consumer applications associated with the at least one API credential using a dependency mapping component;
      generate a new API credential from a producer application using the Artificial Intelligence agent system, the Artificial Intelligence agent system being configured to interact with a graphical user interface of the producer application using a computer vision component and the multi-modal large language model;
      propagate the new API credential to the set of consumer applications by performing, for each consumer application, at least one of: an application programming interface (API) call to the consumer application, or a simulated graphical user interface interaction with a user interface of the consumer application;
      verify successful integration of the new API credential with the set of consumer applications;
      revoke, at the producer application, a prior API credential associated with the set of consumer applications based on the verification; and
      aggregate the plurality of API credential metadata attributes and a propagation status of the new API credential in a dashboard interface.
2. The system of clause 1, wherein the Artificial Intelligence agent system captures the new API credential from a transient display rendered in the graphical user interface of the producer application in response to an actuation performed by the Artificial Intelligence agent system, the new API credential being unavailable for retrieval through a subsequent programmatic query of the producer application after the transient display ceases.
3. The system of clause 1, wherein the centralized credential vault stores, in association with each captured API credential, an obfuscated representation of the API credential, the obfuscated representation being usable by the Artificial Intelligence agent system as a visual fingerprint to re-identify the API credential in the graphical user interface of the producer application on a subsequent navigation.
4. The system of clause 3, wherein, responsive to a propagation failure to at least one consumer application of the set of consumer applications, the Artificial Intelligence agent system uses the obfuscated representation of the new API credential to identify the new API credential in the graphical user interface of the producer application, performs user-interface interactions to revoke the new API credential at the producer application, and confirms by visual inspection of the graphical user interface that the prior API credential remains active at the producer application.
5. The system of clause 1, wherein the Artificial Intelligence agent system synthesizes, from a visual workflow learned by observation of the user interface of the at least one application, a programmatic interface, the programmatic interface being callable by the agent command system to invoke a credential lifecycle operation on the at least one application.
6. The system of clause 1, wherein the Artificial Intelligence agent system initiates a rotation transaction for an API credential responsive to detection, during analysis of contextual text and metadata associated with the one or more API credential containers, of a non-compliance condition for the API credential.
7. The system of clause 1, wherein, upon encountering an interactive challenge in the user interface, the Artificial Intelligence agent system pauses an autonomous workflow, brokers a session to a human administrator with preservation of session state, navigation context, and credential context, and resumes the autonomous workflow at a point at which the autonomous workflow was paused upon clearance of the interactive challenge.
8. The system of clause 1, wherein, when the producer application presents a multi-factor authentication challenge, the Artificial Intelligence agent system reads a time-based one-time password seed from the centralized credential vault, computes a current time-based one-time password in memory, and inputs the computed time-based one-time password into a multi-factor authentication input element of the user interface.
9. The system of clause 1, wherein the producer application does not expose a native programmatic credential-management application programming interface configured to generate or revoke the API credential, and generation of the new API credential by the Artificial Intelligence agent system is performed via interactions with the graphical user interface of the producer application.
10. The system of clause 1, wherein each API credential container comprises a graphical user interface region displaying an API credential, a masked representation of an API credential, a creation timestamp of an API credential, or a scope of an API credential, and the multi-modal large language model is applied to contextual text rendered proximate to the graphical user interface region to classify each of the plurality of API credential metadata attributes by semantic type.
11. The system of clause 1, wherein the Artificial Intelligence agent system comprises:
   the computer vision component configured to detect interface elements of the at least one application using bounding-box identification and document object model segmentation;
   the multi-modal large language model configured to interpret contextual text, field labels, tooltips, and annotations associated with the detected interface elements; and
   an interface automation component configured to simulate user interactions with the graphical user interface, the user interactions comprising mouse clicks, keyboard inputs, and form-field population.
12. The system of clause 11, wherein, responsive to detection that an API credential is partially masked or obscured in the user interface, the multi-modal large language model infers a plurality of API credential metadata attributes from contextual labels, tooltips, access scopes, and timestamps rendered proximate to the partially masked or obscured API credential, and the inferred plurality of API credential metadata attributes is stored in the centralized credential vault in association with a partial representation of the API credential.
13. The system of clause 11, wherein the multi-modal large language model distinguishes among interface elements associated with different credential types, including distinguishing among labels indicating client secret, API key, authorization token, or integration secret, and selects an interface element corresponding to the API credential.
14. The system of clause 1, wherein the dashboard interface aggregates, for each consumer application of the set of consumer applications, the plurality of API credential metadata attributes, the propagation status of the new API credential, and a verification status of the new API credential, and the dashboard interface displays an event log comprising a timestamp and an outcome for each operation performed by the Artificial Intelligence agent system.
15. The system of clause 1, wherein the agent command system comprises at least one of: a human resources platform, an identity governance platform, an identity and access management platform, an enterprise ticketing platform, a command-line utility, a compliance audit trigger source, or a webhook callback from a partner-hosted integration gateway.
16. The system of clause 1, wherein the trigger from the agent command system is generated by a rotation policy engine that evaluates at least one of: an age of an API credential, a usage activity of an API credential, a risk signal associated with an API credential, or an elapsed time since a last rotation of an API credential.
17. The system of clause 1, wherein the centralized credential vault stores, in association with each operation performed by the Artificial Intelligence agent system, a tamper-evident audit record comprising an operation identifier, an application identifier, a timestamp, an agent identifier, an API credential identifier, and a result status.
18. A computer-implemented method for autonomous lifecycle management of application programming interface (API) credentials across a plurality of applications, the method comprising:
   accessing, by a system comprising a processor, a user interface of at least one application using a set of credentials upon receiving a trigger from an agent command system;
   identifying, by an Artificial Intelligence agent system of the system applying a multi-modal large language model to content rendered in a graphical user interface of the at least one application, one or more API credential containers within the user interface, the identifying comprising classifying a region of the user interface as a credential-displaying region and deriving therefrom a plurality of API credential metadata attributes;
   storing the plurality of API credential metadata attributes and at least one API credential in a centralized credential vault;
   identifying, based on the plurality of API credential metadata attributes, a set of consumer applications associated with the at least one API credential using a dependency mapping component;
   generating a new API credential from a producer application using the Artificial Intelligence agent system interacting with a graphical user interface of the producer application using a computer vision component and the same multi-modal large language model applied at the identifying step;
   propagating the new API credential to the set of consumer applications by performing, for each consumer application, at least one of: an application programming interface (API) call to the consumer application, or a simulated graphical user interface interaction with a user interface of the consumer application;
   verifying successful integration of the new API credential with the set of consumer applications;
   revoking, at the producer application, a prior API credential associated with the set of consumer applications based on the verifying; and
   aggregating the plurality of API credential metadata attributes and a propagation status of the new API credential in a dashboard interface.
19. The computer-implemented method of clause 18, further comprising capturing, by the Artificial Intelligence agent system, the new API credential from a transient display rendered in the graphical user interface of the producer application in response to an actuation performed by the Artificial Intelligence agent system, the new API credential being unavailable for retrieval through a subsequent programmatic query of the producer application after the transient display ceases.
20. The computer-implemented method of clause 18, further comprising:
   storing, in the centralized credential vault, an obfuscated representation of the new API credential, the obfuscated representation being usable as a visual fingerprint to re-identify the new API credential in the graphical user interface of the producer application; and
   responsive to a propagation failure to at least one consumer application of the set of consumer applications, identifying, by the Artificial Intelligence agent system, the new API credential in the graphical user interface of the producer application using the obfuscated representation, performing user-interface interactions to revoke the new API credential at the producer application, and confirming by visual inspection of the graphical user interface that the prior API credential remains active at the producer application.
21. The computer-implemented method of clause 18, further comprising synthesizing, by the Artificial Intelligence agent system, from a visual workflow learned by observation of the user interface of the at least one application, a programmatic interface, the programmatic interface being callable by the agent command system to invoke a credential lifecycle operation on the at least one application.
22. The computer-implemented method of clause 18, further comprising initiating, by the Artificial Intelligence agent system, a rotation transaction for an API credential responsive to detection, during analysis of contextual text and metadata associated with the one or more API credential containers, of a non-compliance condition for the API credential.
23. A non-transitory computer-readable medium storing instructions which, when executed by one or more processors, cause the one or more processors to perform operations comprising:
   accessing a user interface of at least one application using a set of credentials upon receiving a trigger from an agent command system;
   identifying, by an Artificial Intelligence agent system applying a multi-modal large language model to content rendered in a graphical user interface of the at least one application, one or more API credential containers within the user interface, the identifying comprising classifying a region of the user interface as a credential-displaying region and deriving therefrom a plurality of API credential metadata attributes;
   storing the plurality of API credential metadata attributes and at least one API credential in a centralized credential vault;
   identifying, based on the plurality of API credential metadata attributes, a set of consumer applications associated with the at least one API credential using a dependency mapping component;
   generating a new API credential from a producer application using the Artificial Intelligence agent system interacting with a graphical user interface of the producer application using a computer vision component and the same multi-modal large language model applied at the identifying step;
   propagating the new API credential to the set of consumer applications by performing, for each consumer application, at least one of: an application programming interface (API) call to the consumer application, or a simulated graphical user interface interaction with a user interface of the consumer application;
   verifying successful integration of the new API credential with the set of consumer applications;
   revoking, at the producer application, a prior API credential associated with the set of consumer applications based on the verifying; and
   aggregating the plurality of API credential metadata attributes and a propagation status of the new API credential in a dashboard interface.
24. The non-transitory computer-readable medium of clause 23, the operations further comprising capturing the new API credential from a transient display rendered in the graphical user interface of the producer application in response to an actuation performed by the Artificial Intelligence agent system, and storing, in the centralized credential vault, an obfuscated representation of the new API credential, the obfuscated representation being usable as a visual fingerprint to re-identify the new API credential in the graphical user interface of the producer application on a subsequent navigation.
25. The non-transitory computer-readable medium of clause 23, the operations further comprising initiating, by the Artificial Intelligence agent system, a rotation transaction for an API credential responsive to detection, during analysis of contextual text and metadata associated with the one or more API credential containers, of a non-compliance condition for the API credential.
26. A system for autonomous lifecycle management of application programming interface (API) credentials across a plurality of applications, the system comprising:
   a processor;
   a memory storing computer-executable instructions which, when executed by the processor, configure the system to:
      access a user interface of at least one application using a set of credentials upon receiving a trigger from an agent command system;
      identify, by an Artificial Intelligence agent system applying a multi-modal large language model to content rendered in a graphical user interface of the at least one application, one or more API credential containers within the user interface, the Artificial Intelligence agent system being configured to classify a region of the user interface as a credential-displaying region and to derive therefrom a plurality of API credential metadata attributes;
      store the plurality of API credential metadata attributes and at least one API credential in a centralized credential vault;
      identify, based on the plurality of API credential metadata attributes, a set of consumer applications associated with the at least one API credential using a dependency mapping component;
      generate a new API credential from a producer application using the Artificial Intelligence agent system, the Artificial Intelligence agent system being configured to interact with a graphical user interface of the producer application using a computer vision component and the multi-modal large language model, and to capture the new API credential from a transient display rendered in the graphical user interface of the producer application in response to an actuation performed by the Artificial Intelligence agent system, the new API credential being unavailable for retrieval through a subsequent programmatic query of the producer application after the transient display ceases;
      propagate the new API credential to the set of consumer applications by performing, for each consumer application, at least one of: an application programming interface (API) call to the consumer application, or a simulated graphical user interface interaction with a user interface of the consumer application;
      verify successful integration of the new API credential with the set of consumer applications;
      revoke, at the producer application, a prior API credential associated with the set of consumer applications based on the verification; and
      aggregate the plurality of API credential metadata attributes and a propagation status of the new API credential in a dashboard interface.
27. The system of clause 26, wherein the centralized credential vault stores, in association with each captured API credential, an obfuscated representation of the API credential, the obfuscated representation being usable by the Artificial Intelligence agent system as a visual fingerprint to re-identify the API credential in the graphical user interface of the producer application on a subsequent navigation.
28. The system of clause 27, wherein, responsive to a propagation failure to at least one consumer application of the set of consumer applications, the Artificial Intelligence agent system uses the obfuscated representation of the new API credential to identify the new API credential in the graphical user interface of the producer application, performs user-interface interactions to revoke the new API credential at the producer application, and confirms by visual inspection of the graphical user interface that the prior API credential remains active at the producer application.
29. The system of clause 26, wherein the Artificial Intelligence agent system synthesizes, from a visual workflow learned by observation of the user interface of the at least one application, a programmatic interface, the programmatic interface being callable by the agent command system to invoke a credential lifecycle operation on the at least one application.
30. The system of clause 26, wherein the Artificial Intelligence agent system initiates a rotation transaction for an API credential responsive to detection, during analysis of contextual text and metadata associated with the one or more API credential containers, of a non-compliance condition for the API credential.
31. The system of clause 26, wherein, upon encountering an interactive challenge in the user interface, the Artificial Intelligence agent system pauses an autonomous workflow, brokers a session to a human administrator with preservation of session state, navigation context, and credential context, and resumes the autonomous workflow at a point at which the autonomous workflow was paused upon clearance of the interactive challenge.
32. The system of clause 26, wherein, when the producer application presents a multi-factor authentication challenge, the Artificial Intelligence agent system reads a time-based one-time password seed from the centralized credential vault, computes a current time-based one-time password in memory, and inputs the computed time-based one-time password into a multi-factor authentication input element of the user interface.
33. The system of clause 26, wherein the producer application does not expose a native programmatic credential-management application programming interface configured to generate or revoke the API credential, and generation of the new API credential by the Artificial Intelligence agent system is performed via interactions with the graphical user interface of the producer application.
34. The system of clause 26, wherein each API credential container comprises a graphical user interface region displaying an API credential, a masked representation of an API credential, a creation timestamp of an API credential, or a scope of an API credential, and the multi-modal large language model is applied to contextual text rendered proximate to the graphical user interface region to classify each of the plurality of API credential metadata attributes by semantic type.
35. The system of clause 26, wherein the Artificial Intelligence agent system comprises:
   the computer vision component configured to detect interface elements of the at least one application using bounding-box identification and document object model segmentation;
   the multi-modal large language model configured to interpret contextual text, field labels, tooltips, and annotations associated with the detected interface elements; and
   an interface automation component configured to simulate user interactions with the graphical user interface, the user interactions comprising mouse clicks, keyboard inputs, and form-field population.
36. The system of clause 35, wherein, responsive to detection that an API credential is partially masked or obscured in the user interface, the multi-modal large language model infers a plurality of API credential metadata attributes from contextual labels, tooltips, access scopes, and timestamps rendered proximate to the partially masked or obscured API credential, and the inferred plurality of API credential metadata attributes is stored in the centralized credential vault in association with a partial representation of the API credential.
37. The system of clause 35, wherein the multi-modal large language model distinguishes among interface elements associated with different credential types, including distinguishing among labels indicating client secret, API key, authorization token, or integration secret, and selects an interface element corresponding to the API credential.
38. The system of clause 26, wherein the dashboard interface aggregates, for each consumer application of the set of consumer applications, the plurality of API credential metadata attributes, the propagation status of the new API credential, and a verification status of the new API credential, and the dashboard interface displays an event log comprising a timestamp and an outcome for each operation performed by the Artificial Intelligence agent system.
39. The system of clause 26, wherein the agent command system comprises at least one of: a human resources platform, an identity governance platform, an identity and access management platform, an enterprise ticketing platform, a command-line utility, a compliance audit trigger source, or a webhook callback from a partner-hosted integration gateway.
40. The system of clause 26, wherein the trigger from the agent command system is generated by a rotation policy engine that evaluates at least one of: an age of an API credential, a usage activity of an API credential, a risk signal associated with an API credential, or an elapsed time since a last rotation of an API credential.
41. The system of clause 26, wherein the centralized credential vault stores, in association with each operation performed by the Artificial Intelligence agent system, a tamper-evident audit record comprising an operation identifier, an application identifier, a timestamp, an agent identifier, an API credential identifier, and a result status.
42. A computer-implemented method for autonomous lifecycle management of application programming interface (API) credentials across a plurality of applications, the method comprising:
   accessing, by a system comprising a processor, a user interface of at least one application using a set of credentials upon receiving a trigger from an agent command system;
   identifying, by an Artificial Intelligence agent system of the system applying a multi-modal large language model to content rendered in a graphical user interface of the at least one application, one or more API credential containers within the user interface, the identifying comprising classifying a region of the user interface as a credential-displaying region and deriving therefrom a plurality of API credential metadata attributes;
   storing the plurality of API credential metadata attributes and at least one API credential in a centralized credential vault;
   identifying, based on the plurality of API credential metadata attributes, a set of consumer applications associated with the at least one API credential using a dependency mapping component;
   generating a new API credential from a producer application using the Artificial Intelligence agent system interacting with a graphical user interface of the producer application using a computer vision component and the same multi-modal large language model applied at the identifying step, and capturing the new API credential from a transient display rendered in the graphical user interface of the producer application in response to an actuation performed by the Artificial Intelligence agent system, the new API credential being unavailable for retrieval through a subsequent programmatic query of the producer application after the transient display ceases;
   propagating the new API credential to the set of consumer applications by performing, for each consumer application, at least one of: an application programming interface (API) call to the consumer application, or a simulated graphical user interface interaction with a user interface of the consumer application;
   verifying successful integration of the new API credential with the set of consumer applications;
   revoking, at the producer application, a prior API credential associated with the set of consumer applications based on the verifying; and
   aggregating the plurality of API credential metadata attributes and a propagation status of the new API credential in a dashboard interface.
43. The computer-implemented method of clause 42, further comprising:
   storing, in the centralized credential vault, an obfuscated representation of the new API credential, the obfuscated representation being usable as a visual fingerprint to re-identify the new API credential in the graphical user interface of the producer application; and
   responsive to a propagation failure to at least one consumer application of the set of consumer applications, identifying, by the Artificial Intelligence agent system, the new API credential in the graphical user interface of the producer application using the obfuscated representation, performing user-interface interactions to revoke the new API credential at the producer application, and confirming by visual inspection of the graphical user interface that the prior API credential remains active at the producer application.
44. The computer-implemented method of clause 42, further comprising synthesizing, by the Artificial Intelligence agent system, from a visual workflow learned by observation of the user interface of the at least one application, a programmatic interface, the programmatic interface being callable by the agent command system to invoke a credential lifecycle operation on the at least one application.
45. The computer-implemented method of clause 42, further comprising initiating, by the Artificial Intelligence agent system, a rotation transaction for an API credential responsive to detection, during analysis of contextual text and metadata associated with the one or more API credential containers, of a non-compliance condition for the API credential.
46. The computer-implemented method of clause 42, further comprising, upon encountering an interactive challenge in the user interface, pausing, by the Artificial Intelligence agent system, an autonomous workflow, brokering a session to a human administrator with preservation of session state, navigation context, and credential context, and resuming the autonomous workflow at a point at which the autonomous workflow was paused upon clearance of the interactive challenge.
47. The computer-implemented method of clause 42, further comprising, when the producer application presents a multi-factor authentication challenge, reading, by the Artificial Intelligence agent system, a time-based one-time password seed from the centralized credential vault, computing a current time-based one-time password in memory, and inputting the computed time-based one-time password into a multi-factor authentication input element of the user interface.
48. A non-transitory computer-readable medium storing instructions which, when executed by one or more processors, cause the one or more processors to perform operations comprising:
   accessing a user interface of at least one application using a set of credentials upon receiving a trigger from an agent command system;
   identifying, by an Artificial Intelligence agent system applying a multi-modal large language model to content rendered in a graphical user interface of the at least one application, one or more API credential containers within the user interface, the identifying comprising classifying a region of the user interface as a credential-displaying region and deriving therefrom a plurality of API credential metadata attributes;
   storing the plurality of API credential metadata attributes and at least one API credential in a centralized credential vault;
   identifying, based on the plurality of API credential metadata attributes, a set of consumer applications associated with the at least one API credential using a dependency mapping component;
   generating a new API credential from a producer application using the Artificial Intelligence agent system interacting with a graphical user interface of the producer application using a computer vision component and the same multi-modal large language model applied at the identifying step, and capturing the new API credential from a transient display rendered in the graphical user interface of the producer application in response to an actuation performed by the Artificial Intelligence agent system, the new API credential being unavailable for retrieval through a subsequent programmatic query of the producer application after the transient display ceases;
   propagating the new API credential to the set of consumer applications by performing, for each consumer application, at least one of: an application programming interface (API) call to the consumer application, or a simulated graphical user interface interaction with a user interface of the consumer application;
   verifying successful integration of the new API credential with the set of consumer applications;
   revoking, at the producer application, a prior API credential associated with the set of consumer applications based on the verifying; and
   aggregating the plurality of API credential metadata attributes and a propagation status of the new API credential in a dashboard interface.
49. The non-transitory computer-readable medium of clause 48, the operations further comprising storing, in the centralized credential vault, an obfuscated representation of the new API credential, the obfuscated representation being usable as a visual fingerprint to re-identify the new API credential in the graphical user interface of the producer application, and, responsive to a propagation failure to at least one consumer application of the set of consumer applications, identifying, by the Artificial Intelligence agent system, the new API credential in the graphical user interface of the producer application using the obfuscated representation, performing user-interface interactions to revoke the new API credential at the producer application, and confirming by visual inspection of the graphical user interface that the prior API credential remains active at the producer application.
50. The non-transitory computer-readable medium of clause 48, the operations further comprising initiating, by the Artificial Intelligence agent system, a rotation transaction for an API credential responsive to detection, during analysis of contextual text and metadata associated with the one or more API credential containers, of a non-compliance condition for the API credential.
51. A system for autonomous lifecycle management of application programming interface (API) credentials across a plurality of applications, the system comprising:
   a processor;
   a memory storing computer-executable instructions which, when executed by the processor, configure the system to:
      access a user interface of at least one application using a set of credentials upon receiving a trigger from an agent command system;
      identify, by an Artificial Intelligence agent system applying a multi-modal large language model to content rendered in a graphical user interface of the at least one application, one or more API credential containers within the user interface, the Artificial Intelligence agent system being configured to classify a region of the user interface as a credential-displaying region and to derive therefrom a plurality of API credential metadata attributes;
      store the plurality of API credential metadata attributes and at least one API credential in a centralized credential vault;
      identify, based on the plurality of API credential metadata attributes, a set of consumer applications associated with the at least one API credential using a dependency mapping component;
      generate a new API credential from a producer application that does not expose a native programmatic credential-management application programming interface configured to generate or revoke an API credential, using the Artificial Intelligence agent system, the Artificial Intelligence agent system being configured to interact with a graphical user interface of the producer application using a computer vision component and the multi-modal large language model, to capture the new API credential from a transient display rendered in the graphical user interface of the producer application in response to an actuation performed by the Artificial Intelligence agent system, the new API credential being unavailable for retrieval through a subsequent programmatic query of the producer application after the transient display ceases, and to store, in the centralized credential vault in association with the new API credential, an obfuscated representation of the new API credential, the obfuscated representation comprising a partial visible portion of the new API credential rendered in the graphical user interface of the producer application;
      propagate the new API credential to the set of consumer applications by performing, for each consumer application, at least one of: an application programming interface (API) call to the consumer application, or a simulated graphical user interface interaction with a user interface of the consumer application;
      verify successful integration of the new API credential with the set of consumer applications;
      revoke, at the producer application, a prior API credential associated with the set of consumer applications based on the verification, the revoking comprising using an obfuscated representation of the prior API credential to identify the prior API credential in the graphical user interface of the producer application; and
      aggregate the plurality of API credential metadata attributes, a propagation status of the new API credential, and a verification status of the new API credential, in a
52. The system of clause 51, wherein, responsive to a propagation failure to at least one consumer application of the set of consumer applications, the Artificial Intelligence agent system uses the obfuscated representation of the new API credential to identify the new API credential in the graphical user interface of the producer application, performs user-interface interactions to revoke the new API credential at the producer application, and confirms by visual inspection of the graphical user interface that the prior API credential remains active at the producer application.
53. The system of clause 51, wherein the Artificial Intelligence agent system synthesizes, from a visual workflow learned by observation of the user interface of the at least one application, a programmatic interface, the programmatic interface being callable by the agent command system to invoke a credential lifecycle operation on the at least one application.
54. The system of clause 51, wherein the Artificial Intelligence agent system initiates a rotation transaction for an API credential responsive to detection, during analysis of contextual text and metadata associated with the one or more API credential containers, of a non-compliance condition for the API credential.
55. The system of clause 51, wherein, upon encountering an interactive challenge in the user interface, the Artificial Intelligence agent system pauses an autonomous workflow, brokers a session to a human administrator with preservation of session state, navigation context, and credential context, and resumes the autonomous workflow at a point at which the autonomous workflow was paused upon clearance of the interactive challenge.
56. The system of clause 51, wherein, when the producer application presents a multi-factor authentication challenge, the Artificial Intelligence agent system reads a time-based one-time password seed from the centralized credential vault, computes a current time-based one-time password in memory, and inputs the computed time-based one-time password into a multi-factor authentication input element of the user interface.
57. The system of clause 51, wherein the Artificial Intelligence agent system comprises:
   the computer vision component configured to detect interface elements of the at least one application using bounding-box identification and document object model segmentation;
   the multi-modal large language model configured to interpret contextual text, field labels, tooltips, and annotations associated with the detected interface elements; and
   an interface automation component configured to simulate user interactions with the graphical user interface, the user interactions comprising mouse clicks, keyboard inputs, and form-field population.
58. The system of clause 57, wherein the computer vision component is configured to detect and classify interface elements comprising at least one of: input fields for API credential entry, masked credential strings, timestamp indicators associated with API credentials, permission or scope labels associated with API credentials, credential rotation controls, credential generation controls, and confirmation banners containing a partially visible new API credential.
59. The system of clause 57, wherein, responsive to detection that an API credential is partially masked or obscured in the user interface, the multi-modal large language model infers a plurality of API credential metadata attributes from contextual labels, tooltips, access scopes, and timestamps rendered proximate to the partially masked or obscured API credential, and the inferred plurality of API credential metadata attributes is stored in the centralized credential vault in association with a partial representation of the API credential.
60. The system of clause 57, wherein the multi-modal large language model distinguishes among interface elements associated with different credential types, including distinguishing among labels indicating client secret, API key, authorization token, or integration secret, and selects an interface element corresponding to the API credential.
61. The system of clause 57, wherein the interface automation component is configured to perform a copy operation that captures the new API credential from the graphical user interface of the producer application, and a paste operation that injects the new API credential into a graphical user interface of a consumer application of the set of consumer applications.
62. The system of clause 51, wherein each API credential container comprises a graphical user interface region displaying an API credential, a masked representation of an API credential, a creation timestamp of an API credential, or a scope of an API credential, and the multi-modal large language model is applied to contextual text rendered proximate to the graphical user interface region to classify each of the plurality of API credential metadata attributes by semantic type.
63. The system of clause 51, wherein the agent command system comprises at least one of: a human resources platform, an identity governance platform, an identity and access management platform, an enterprise ticketing platform, a command-line utility, a compliance audit trigger source, or a webhook callback from a partner-hosted integration gateway.
64. The system of clause 51, wherein the trigger from the agent command system is generated by a rotation policy engine that evaluates at least one of: an age of an API credential, a usage activity of an API credential, a risk signal associated with an API credential, an elapsed time since a last rotation of an API credential, a user offboarding event, a role reassignment event, a credential compromise event, or a service scope change event.
65. The system of clause 51, wherein the centralized credential vault stores, in association with each operation performed by the Artificial Intelligence agent system, a tamper-evident audit record comprising an operation identifier, an application identifier, a timestamp, an agent identifier, an API credential identifier, and a result status.
66. The system of clause 65, wherein the tamper-evident audit record is structured for compliance with at least one of: a Sarbanes-Oxley Act compliance reporting format, a Health Insurance Portability and Accountability Act compliance reporting format, a Payment Card Industry Data Security Standard compliance reporting format, or a General Data Protection Regulation compliance reporting format.
67. A computer-implemented method for autonomous lifecycle management of application programming interface (API) credentials across a plurality of applications, the method comprising:
   accessing, by a system comprising a processor, a user interface of at least one application using a set of credentials upon receiving a trigger from an agent command system;
   identifying, by an Artificial Intelligence agent system of the system applying a multi-modal large language model to content rendered in a graphical user interface of the at least one application, one or more API credential containers within the user interface, the identifying comprising classifying a region of the user interface as a credential-displaying region and deriving therefrom a plurality of API credential metadata attributes;
   storing the plurality of API credential metadata attributes and at least one API credential in a centralized credential vault;
   identifying, based on the plurality of API credential metadata attributes, a set of consumer applications associated with the at least one API credential using a dependency mapping component;
   generating a new API credential from a producer application that does not expose a native programmatic credential-management application programming interface configured to generate or revoke an API credential, using the Artificial Intelligence agent system interacting with a graphical user interface of the producer application using a computer vision component and the same multi-modal large language model applied at the identifying step, capturing the new API credential from a transient display rendered in the graphical user interface of the producer application in response to an actuation performed by the Artificial Intelligence agent system, the new API credential being unavailable for retrieval through a subsequent programmatic query of the producer application after the transient display ceases, and storing, in the centralized credential vault in association with the new API credential, an obfuscated representation of the new API credential, the obfuscated representation comprising a partial visible portion of the new API credential rendered in the graphical user interface of the producer application;
   propagating the new API credential to the set of consumer applications by performing, for each consumer application, at least one of: an application programming interface (API) call to the consumer application, or a simulated graphical user interface interaction with a user interface of the consumer application;
   verifying successful integration of the new API credential with the set of consumer applications;
   revoking, at the producer application, a prior API credential associated with the set of consumer applications based on the verifying, the revoking comprising using an obfuscated representation of the prior API credential to identify the prior API credential in the graphical user interface of the producer application; and
   aggregating the plurality of API credential metadata attributes, a propagation status of the new API credential, and a verification status of the new API credential, in a
68. The computer-implemented method of clause 67, further comprising, responsive to a propagation failure to at least one consumer application of the set of consumer applications, identifying, by the Artificial Intelligence agent system, the new API credential in the graphical user interface of the producer application using the obfuscated representation of the new API credential, performing user-interface interactions to revoke the new API credential at the producer application, and confirming by visual inspection of the graphical user interface that the prior API credential remains active at the producer application.
69. The computer-implemented method of clause 67, further comprising synthesizing, by the Artificial Intelligence agent system, from a visual workflow learned by observation of the user interface of the at least one application, a programmatic interface, the programmatic interface being callable by the agent command system to invoke a credential lifecycle operation on the at least one application.
70. The computer-implemented method of clause 67, further comprising initiating, by the Artificial Intelligence agent system, a rotation transaction for an API credential responsive to detection, during analysis of contextual text and metadata associated with the one or more API credential containers, of a non-compliance condition for the API credential.
71. The computer-implemented method of clause 67, further comprising, upon encountering an interactive challenge in the user interface, pausing, by the Artificial Intelligence agent system, an autonomous workflow, brokering a session to a human administrator with preservation of session state, navigation context, and credential context, and resuming the autonomous workflow at a point at which the autonomous workflow was paused upon clearance of the interactive challenge.
72. The computer-implemented method of clause 67, further comprising, when the producer application presents a multi-factor authentication challenge, reading, by the Artificial Intelligence agent system, a time-based one-time password seed from the centralized credential vault, computing a current time-based one-time password in memory, and inputting the computed time-based one-time password into a multi-factor authentication input element of the user interface.
73. A non-transitory computer-readable medium storing instructions which, when executed by one or more processors, cause the one or more processors to perform operations comprising:
   accessing a user interface of at least one application using a set of credentials upon receiving a trigger from an agent command system;
   identifying, by an Artificial Intelligence agent system applying a multi-modal large language model to content rendered in a graphical user interface of the at least one application, one or more API credential containers within the user interface, the identifying comprising classifying a region of the user interface as a credential-displaying region and deriving therefrom a plurality of API credential metadata attributes;
   storing the plurality of API credential metadata attributes and at least one API credential in a centralized credential vault;
   identifying, based on the plurality of API credential metadata attributes, a set of consumer applications associated with the at least one API credential using a dependency mapping component;
   generating a new API credential from a producer application that does not expose a native programmatic credential-management application programming interface configured to generate or revoke an API credential, using the Artificial Intelligence agent system interacting with a graphical user interface of the producer application using a computer vision component and the same multi-modal large language model applied at the identifying step, capturing the new API credential from a transient display rendered in the graphical user interface of the producer application in response to an actuation performed by the Artificial Intelligence agent system, the new API credential being unavailable for retrieval through a subsequent programmatic query of the producer application after the transient display ceases, and storing, in the centralized credential vault in association with the new API credential, an obfuscated representation of the new API credential, the obfuscated representation comprising a partial visible portion of the new API credential rendered in the graphical user interface of the producer application;
   propagating the new API credential to the set of consumer applications by performing, for each consumer application, at least one of: an application programming interface (API) call to the consumer application, or a simulated graphical user interface interaction with a user interface of the consumer application;
   verifying successful integration of the new API credential with the set of consumer applications;
   revoking, at the producer application, a prior API credential associated with the set of consumer applications based on the verifying, the revoking comprising using an obfuscated representation of the prior API credential to identify the prior API credential in the graphical user interface of the producer application; and
   aggregating the plurality of API credential metadata attributes, a propagation status of the new API credential, and a verification status of the new API credential, in a dashboard interface.
74. The non-transitory computer-readable medium of clause 73, the operations further comprising, responsive to a propagation failure to at least one consumer application of the set of consumer applications, identifying, by the Artificial Intelligence agent system, the new API credential in the graphical user interface of the producer application using the obfuscated representation of the new API credential, performing user-interface interactions to revoke the new API credential at the producer application, and confirming by visual inspection of the graphical user interface that the prior API credential remains active at the producer application.
75. The non-transitory computer-readable medium of clause 73, the operations further comprising initiating, by the Artificial Intelligence agent system, a rotation transaction for an API credential responsive to detection, during analysis of contextual text and metadata associated with the one or more API credential containers, of a non-compliance condition for the API credential.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A system for autonomous lifecycle management of application programming interface (API) credentials across a plurality of applications, the system comprising:
a processor;
a memory storing computer-executable instructions which, when executed by the processor, configure the system to:
access a user interface of at least one application using a set of credentials upon receiving a trigger from an agent command system;
identify, by an Artificial Intelligence agent system applying a multi-modal large language model to content rendered in a graphical user interface of the at least one application, one or more API credential containers within the user interface, the Artificial Intelligence agent system being configured to classify a region of the user interface as a credential-displaying region and to derive therefrom a plurality of API credential metadata attributes;
store the plurality of API credential metadata attributes and at least one API credential in a centralized credential vault;
identify, based on the plurality of API credential metadata attributes, a set of consumer applications associated with the at least one API credential using a dependency mapping component;
generate a new API credential from a producer application using the Artificial Intelligence agent system, the Artificial Intelligence agent system being configured to interact with a graphical user interface of the producer application using a computer vision component and the multi-modal large language model, and to capture the new API credential from a transient display rendered in the graphical user interface of the producer application in response to an actuation performed by the Artificial Intelligence agent system, the new API credential being unavailable for retrieval through a subsequent programmatic query of the producer application after the transient display ceases;
propagate the new API credential to the set of consumer applications by performing, for each consumer application, at least one of: an application programming interface (API) call to the consumer application, or a simulated graphical user interface interaction with a user interface of the consumer application;
verify successful integration of the new API credential with the set of consumer applications;
revoke, at the producer application, a prior API credential associated with the set of consumer applications based on the verification; and
aggregate the plurality of API credential metadata attributes and a propagation status of the new API credential in a dashboard interface.

2. The system of claim 1, wherein the centralized credential vault stores, in association with each captured API credential, an obfuscated representation of the API credential, the obfuscated representation being usable by the Artificial Intelligence agent system as a visual fingerprint to re-identify the API credential in the graphical user interface of the producer application on a subsequent navigation.

3. The system of claim 2, wherein, responsive to a propagation failure to at least one consumer application of the set of consumer applications, the Artificial Intelligence agent system uses the obfuscated representation of the new API credential to identify the new API credential in the graphical user interface of the producer application, performs user-interface interactions to revoke the new API credential at the producer application, and confirms by visual inspection of the graphical user interface that the prior API credential remains active at the producer application.

4. The system of claim 1, wherein the Artificial Intelligence agent system synthesizes, from a visual workflow learned by observation of the user interface of the at least one application, a programmatic interface, the programmatic interface being callable by the agent command system to invoke a credential lifecycle operation on the at least one application.

5. The system of claim 1, wherein the Artificial Intelligence agent system initiates a rotation transaction for an API credential responsive to detection, during analysis of contextual text and metadata associated with the one or more API credential containers, of a non-compliance condition for the API credential.

6. The system of claim 1, wherein, upon encountering an interactive challenge in the user interface, the Artificial Intelligence agent system pauses an autonomous workflow, brokers a session to a human administrator with preservation of session state, navigation context, and credential context, and resumes the autonomous workflow at a point at which the autonomous workflow was paused upon clearance of the interactive challenge.

7. The system of claim 1, wherein, when the producer application presents a multi-factor authentication challenge, the Artificial Intelligence agent system reads a time-based one-time password seed from the centralized credential vault, computes a current time-based one-time password in memory, and inputs the computed time-based one-time password into a multi-factor authentication input element of the user interface.

8. The system of claim 1, wherein the producer application does not expose a native programmatic credential-management application programming interface configured to generate or revoke the API credential, and generation of the new API credential by the Artificial Intelligence agent system is performed via interactions with the graphical user interface of the producer application.

9. The system of claim 1, wherein each API credential container comprises a graphical user interface region displaying an API credential, a masked representation of an API credential, a creation timestamp of an API credential, or a scope of an API credential, and the multi-modal large language model is applied to contextual text rendered proximate to the graphical user interface region to classify each of the plurality of API credential metadata attributes by semantic type.

10. The system of claim 1, wherein the Artificial Intelligence agent system comprises:
the computer vision component configured to detect interface elements of the at least one application using bounding-box identification and document object model segmentation;
the large language model configured to interpret contextual text, field labels, tooltips, and annotations associated with the detected interface elements; and
an interface automation component configured to simulate user interactions with the graphical user interface, the user interactions comprising mouse clicks, keyboard inputs, and form-field population.

11. The system of claim 10, wherein, responsive to detection that an API credential is partially masked or obscured in the user interface, the large language model infers a plurality of API credential metadata attributes from contextual labels, tooltips, access scopes, and timestamps rendered proximate to the partially masked or obscured API credential, and the inferred plurality of API credential metadata attributes is stored in the centralized credential vault in association with a partial representation of the API credential.

12. The system of claim 10, wherein the large language model distinguishes among interface elements associated with different credential types, including distinguishing among labels indicating client secret, API key, authorization token, or integration secret, and selects an interface element corresponding to the API credential.

13. The system of claim 1, wherein the dashboard interface aggregates, for each consumer application of the set of consumer applications, the plurality of API credential metadata attributes, the propagation status of the new API credential, and a verification status of the in new API credential, and the dashboard interface displays an event log comprising a timestamp and an outcome for each operation performed by the Artificial Intelligence agent system.

14. The system of claim 1, wherein the agent command system comprises at least one of: a human resources platform, an identity governance platform, an identity and access management platform, an enterprise ticketing platform, a command-line utility, a compliance audit trigger source, or a webhook callback from a partner-hosted integration gateway.

15. The system of claim 1, wherein the trigger from the agent command system is generated by a rotation policy engine that evaluates at least one of: an age of an API credential, a usage activity of an API credential, a risk signal associated with an API credential, or an elapsed time since a last rotation of an API credential.

16. The system of claim 1, wherein the centralized credential vault stores, in association with each operation performed by the Artificial Intelligence agent system, a tamper-evident audit record comprising an operation identifier, an application identifier, a timestamp, an agent identifier, an API credential identifier, and a result status.

17. A computer-implemented method for autonomous lifecycle management of application programming interface (API) credentials across a plurality of applications, the method comprising:
accessing, by a system comprising a processor, a user interface of at least one application using a set of credentials upon receiving a trigger from an agent command system;
identifying, by an Artificial Intelligence agent system of the system applying a large language model to content rendered in a graphical user interface of the at least one application, one or more API credential containers within the user interface, the identifying comprising classifying a region of the user interface as a credential-displaying region and deriving therefrom a plurality of API credential metadata attributes;
storing the plurality of API credential metadata attributes and at least one API credential in a centralized credential vault;
identifying, based on the plurality of API credential metadata attributes, a set of consumer applications associated with the at least one API credential using a dependency mapping component;
generating a new API credential from a producer application using the Artificial Intelligence agent system interacting with a graphical user interface of the producer application using a computer vision component and the large language model applied at the identifying step, and capturing the new API credential from a transient display rendered in the graphical user interface of the producer application in response to an actuation performed by the Artificial Intelligence agent system, the new API credential being unavailable for retrieval through a subsequent programmatic query of the producer application after the transient display ceases;
propagating the new API credential to the set of consumer applications by performing, for each consumer application, at least one of: an application programming interface (API) call to the consumer application, or a simulated graphical user interface interaction with a user interface of the consumer application;
verifying successful integration of the new API credential with the set of consumer applications;
revoking, at the producer application, a prior API credential associated with the set of consumer applications based on the verifying; and
aggregating the plurality of API credential metadata attributes and a propagation status of the new API credential in a dashboard interface.

18. The computer-implemented method of claim 17, further comprising:
storing, in the centralized credential vault, an obfuscated representation of the new API credential, the obfuscated representation being usable as a visual fingerprint to re-identify the new API credential in the graphical user interface of the producer application; and
responsive to a propagation failure to at least one consumer application of the set of consumer applications, identifying, by the Artificial Intelligence agent system, the new API credential in the graphical user interface of the producer application using the obfuscated representation, performing user-interface interactions to revoke the new API credential at the producer application, and confirming by visual inspection of the graphical user interface that the prior API credential remains active at the producer application.

19. The computer-implemented method of claim 17, further comprising synthesizing, by the Artificial Intelligence agent system, from a visual workflow learned by observation of the user interface of the at least one application, a programmatic interface, the programmatic interface being callable by the agent command system to invoke a credential lifecycle operation on the at least one application.

20. The computer-implemented method of claim 17, further comprising initiating, by the Artificial Intelligence agent system, a rotation transaction for an API credential responsive to detection, during analysis of contextual text and metadata associated with the one or more API credential containers, of a non-compliance condition for the API credential.
